(19) United States
(12) Patent Application Publication
(10) Pub. No.: US 2015/0104757 A1
(43) Pub. Date: Apr. 16, 2015

(54) DRIVING ASSESSMENT AND TRAINING METHOD AND APPARATUS

(71) Applicant: MBFARR, LLC, San Jose, CA (US)

(72) Inventors: RICK L. MONCRIEF, San Jose, CA (US); Max Larkin Behensky, Soquel, CA (US); Tomas G. Harkins, San Jose, CA (US); Brad Allen Fuller, San Jose, CA (US)

(73) Assignee: MBFARR, LLC, San Jose, CA (US)

(21) Appl. No.: 14/513,432

(22) Filed: Oct. 14, 2014

Related U.S. Application Data
(63) Continuation-in-part of application No. 61/891,372, filed on Oct. 15, 2013.

(51) Int. Cl. G09B 9/30; G09B 9/05

(52) U.S. Cl. CPC G09B 9/302; G09B 9/05
USPC 434/38; 434/30; 434/62; 434/69

(57) ABSTRACT

A system for driver assessment and training comprising a simulator which can be operated by a driver or pilot under test or in training, the simulator displaying scenarios the driver or pilot must drive through or fly through. The inputs of the driver or pilot in reaction to the displayed scenario are fed to a free body model which calculates the resulting movement of the simulated vehicle in the displayed world. Scoring can be by analysis of calculated Fonda curves comparing the driver performance to performances by one or more normative drivers plotted by standard deviation from norm on the vertical axis and sample point on the horizontal axis. Simulator sickness can be mitigated by calculation and display of a mitigation object which partially obscures the virtual scene being displayed. Signature curves give the driver or pilots' performance at a glance.

### PRIORITY CLAIM

This application claims priority to the provisional application Ser. No. 61/891,372 filed 15 Oct. 2013.

### FEDERALLY SPONSORED RESEARCH

This invention was made in part with Government support under W31P4Q-09-C-0414 awarded by DARPA. The Government has certain rights in the invention.

### BACKGROUND OF THE INVENTION

There has long existed a need to train and test drivers on simulators to avoid the danger and expense of training and testing drivers in real cars. With the rising cost of fuel, and the inexperience of young drivers and the flagging abilities of older drivers and incompetence of some experienced drivers, testing and training in real cars poses real hazards for DMV and driving school employees.

### BRIEF DESCRIPTION OF THE DRAWINGS

FIG. 1 is a diagram of components and systems that could be used while operating the Driver Guidance System (DGS).

FIG. 2 is a diagram of a registration process for the users of the Driver Guidance System.

FIG. 3 is a diagram of a process for selecting a driver, a scenario, a study, and other parameters during the start-up process of the Driver Guidance System.

FIG. 4 is an example of a dialog used to control the operation of the Driver Guidance System Simulation Terminal Operator Panel.

FIG. 5 is an example of a dialog used to select the driver, the scenario, and other aspects of the Driver Guidance System operation from the DGS Data Center.

FIG. 6 is a diagram of a process to run a scenario (assessment or training session) on the Driver Guidance System Simulation Terminal.

FIG. 7H, the ‘H’ designates HARDWARE and shows a perspective view of the Image Mitigation System identifying Hardware components of the Surround Simulation Terminal.

FIG. 7I, the ‘I’ designates IMAGE COMPONENTS and shows a perspective view of the Image Mitigation System identifying typical components of a dynamic spatial image for display in not only the Surround Simulation Terminal but also other versions of spatial display systems including various Simulation Terminal hardware configurations.

FIG. 7M, the ‘M’ designates MITIGATION COMPONENTS and shows a perspective view of one version of Image Mitigation components for use in not only the Surround Simulation Terminal but also other spatial image display systems including various Simulation Terminal hardware configurations and various forms of images from image generators and video streams.

FIG. 8 is a diagram of a process of adding a mitigation object to other visual or video objects to form the combined image of the Image Mitigation System.

FIG. 9 is a diagram of a process of creating a mitigation object.

FIG. 10 is a diagram of various interface process to collect information from various components able to determine the position and orientation of a users head/face to estimate the users direction of regard.

FIG. 11 is a diagram of input systems that dynamically control the shape and other parameters of the mitigation object in real-time.

FIG. 12 is an example of a dialog box used to control the mitigation object dynamically and interactively.

FIG. 13 is a rendering of a user operated control to dynamically adjust the mitigation object.

FIG. 14 is a diagram of the composition of a scenario

FIG. 15 is a diagram of a process to create normative drive data.

FIG. 16 is a screen grab of a tool that supports a process of normative drive data creation.

FIG. 17 is a diagram of a process to calculate a discrete instantaneous variance from normal and the running continuum of various driving variables.

FIG. 18 is a screen grab displaying normal variance continuums (NVC) for several driving variables across several events of a scenario.

FIG. 19 is a diagram of a process to create Virtual Driving Instructor Examiner (VDIE) profiles on an event-by-event basis to assess and train driving ability.

FIG. 20 is a screen grab of a tool that supports creating VDIE profiles.

FIG. 21 is a diagram of an example of a process to test compliance to rules-of-the-road in road stop zones.

FIG. 22 is a diagram of a process to run a scenario in the DGS against a VDIE profile appropriate to the skills of a driver.

FIG. 23 is a screen grab of a VDIE profile in use and the real-time NVC traces as the scenario is being driven

FIG. 24 is a graph describing components of “Signature” graphs for the study of a variables divergence from the Reference Drive.

FIG. 25 is a graph of the variance of the variance of variables by study of the distribution of the data for variables as the data is followed longitudinally along the DUT's path.

FIG. 27 is a flow chart of the process of extracting HOPE Parameters and characteristics from studied fixed courses and saving the data in a database that will be used to synthesize HOPE NPD files at a later time. HOPE stands for Humanistic Operating Parameters & Envelops.

FIG. 28 is a flowchart of the process for analyzing DUT drives whether from studied fixed courses or from synthesized road courses.

FIG. 29 is a plan view of a section of roads identifying components for extraction

FIG. 30 is a perspective view of the a road section identifying Reference Normals and other structures that define the roadway.

FIG. 31 is a flowchart of the process for extracting HOPE characteristics from the road sections of a studied fixed course. HOPE stands for Humanistic Operating Parameters & Envelops.

FIG. 32 is a flowchart of the processes of creating an NPD file for Normative Drivers who drove a studied fixed course and a process for creating a HOPE NPD file to use in assessing drivers who choose to drive off the studied fixed course in the virtual world. The basic idea in generating a HOPE NPD file is to use the averages or Means and the Standard Deviations the Normative Drivers established on various road segments in the studied fixed course as the averages or Means and Standard Deviations for similar or identical road segments in the path off the studied fixed course which the Driver Under Test chose to drive. The HOPE NPD file can then be used in testing drivers who have chosen to drive off the studied fixed course where no Normative Drivers have driven before.

FIG. 33 is a screen grab showing the direction arrow driving aid three second prediction arrow showing a reasonable path while making a right-hand turn.

FIG. 34 is a screen grab showing the direction arrow driving aid prediction of a three second long path crossing the roadway centerline into the oncoming lane.

### DETAILED DESCRIPTION OF THE VARIOUS EMBODIMENTS

There are disclosed herein multiple embodiments of processes and apparatus for driver assessment and training. The processes and apparatus disclosed herein are useful for training civilian drivers, military drivers of driverless vehicles, drone pilots, etc. The concepts disclosed herein are also useful for construction autopilots for driverless cars. Whenever the term “driver” is used, it is to be understood as also meaning pilot flying an unmanned aerial vehicle or a military driver driving an unmanned combat or logistics vehicle.

One embodiment of a driver assessment and training system measures for the driver under test or assessment driver position on the road, the driver's speed, his or her throttle position and steering input against normative values for each of these parameters at each of a plurality of times in reaction to events that occur during an assessment drive on a simulator through an assessment course. In one species of this embodiment, the normative values are developed by computing the inputs of a plurality of “trial drivers” who have driven the same assessment course on a simulator and whose inputs for each point in time were recorded and stored on a server.

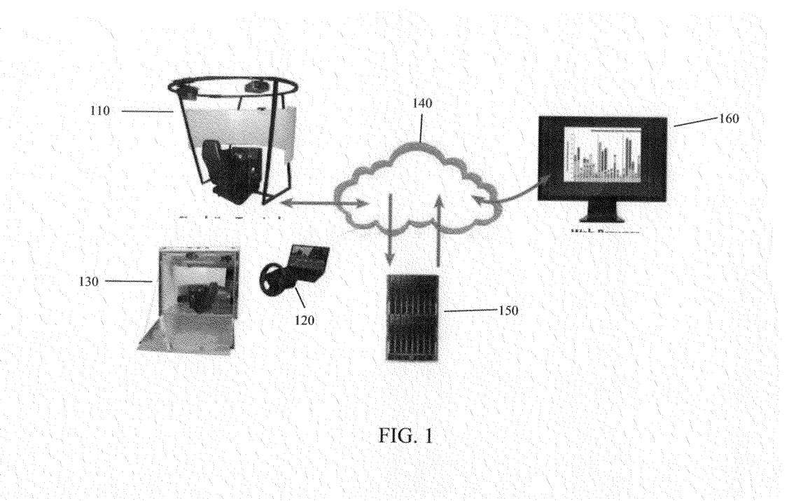

### FIG. 1

Major components of the Driver Guidance System are shown in FIG. 1. Surround Simulation Terminal 110, Basic Simulation Terminal 120, or Mobile Simulation Terminal 130, are connected via the Internet 140 to the Data Center 150. Any number of Terminals 110 as well as 120, as well as 130 may be connected to the Data Center 150 to collect driving ability information. Driving ability of people driving the Terminals is analyzed at the Data Center 150 and can be retrieved through the Internet 140 and a DGS Interface 160 such as Microsoft Internet Explorer or Firefox.

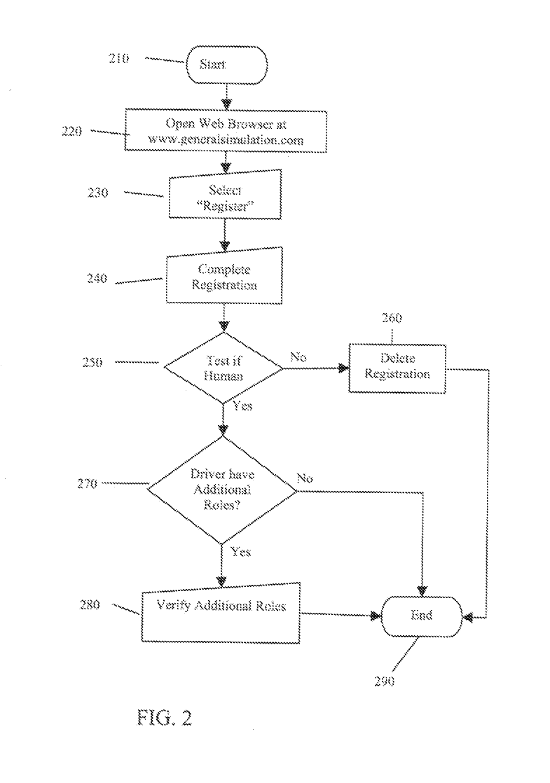

### FIG. 2

FIG. 2 describes the flow of steps and actions to complete registration on the Driver Guidance System. Registration is started at 210. Process 220 is performed by a user registering on the DGS. Manual Input 230 is then performed by the user. Manual Input 240 is then performed by the user. Test 250 is automatically performed by the DGS Interface at either or both the client or server ends. The DGS Interface completes Process 260 if the automatic systems reject the registration. If accepted, Test 270 determines if additional rolls are being requested and passes to termination of registration or to request to verify additional rolls at 280 and then to registration process termination.

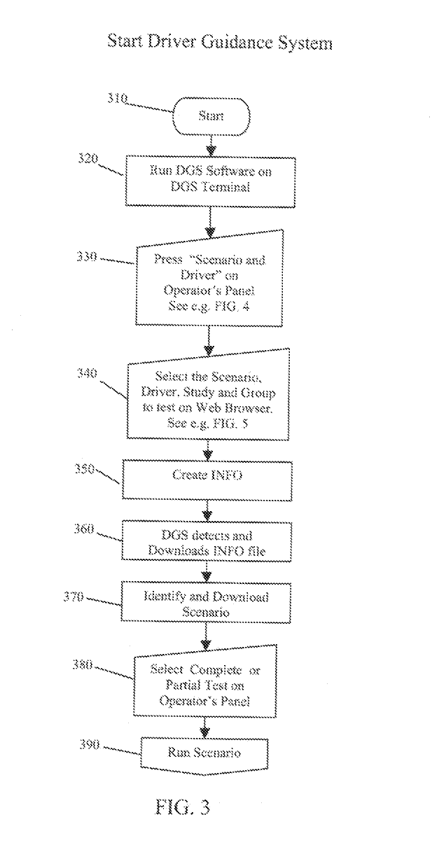

### FIG. 3

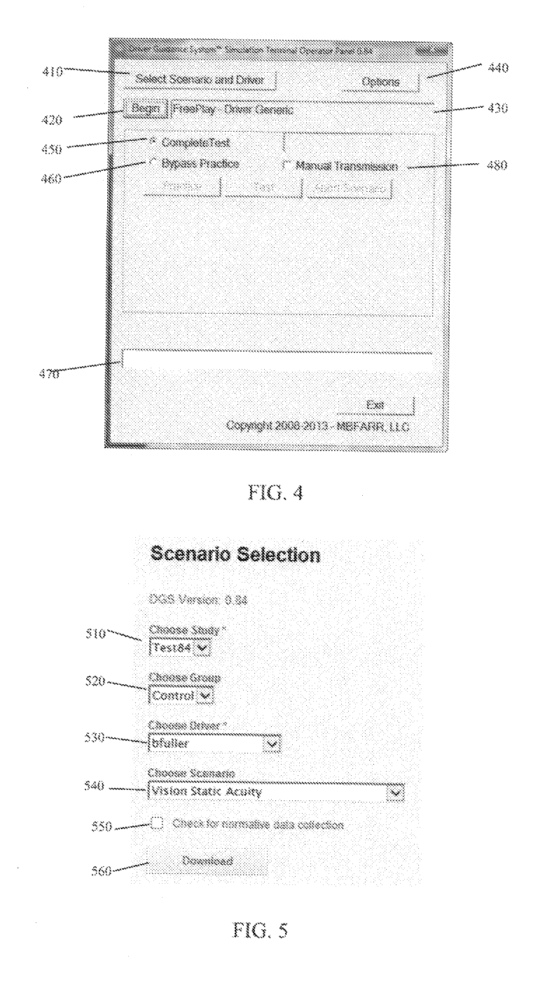

The steps to start operation of the Driver Guidance System are diagrammed in FIG. 3. Starting the DGS begins at 310 with the user activating the DGS program. Process 320 runs the DGS software on the Simulation Terminal opening the DGS Simulation Terminal Operator Panel similar to the dialog shown in FIG. 4. Step 330 allows the user to select a Scenario (a Scenario is a drive through an assessment course or a simulated flight with events that happen during the drive or the flight) and other parameters for operation of the DGS from the Data Center 150. The selection process is completed by input from the user at Step 340 using an interface to the Data Center 150 similar to FIG. 5.

### FIG. 4

A dialog box of the Driver Guidance System Simulation Terminal Operator Panel 400 is used to control the operation of the Driver Guidance System. The Operator Panel 400 contains various context active buttons and information windows. Depending on the state of the DGS, various buttons are active or inactive. Buttons 410, 420, 440, 462, 464, 466, and 490 are activated by a left-click while mouse-over. Radio buttons 450 and 460 are activated in the same manner, as is selection box 480. Information windows 430 and 470 display information to help the DGS Operator.

### FIG. 5

A dialog box of the Driver Guidance System Data Center Scenario Selection is shown in FIG. 5. A research assistant or test giver with the proper role credentials in the DGS system selects various testing parameters from drop-down boxes including the test taker in Driver selection box 530. The selections that are allowed in the various boxes 510, 520, 530, and 540 are a function of the Principal Investigator's setup of studies and the rules of the DGS.

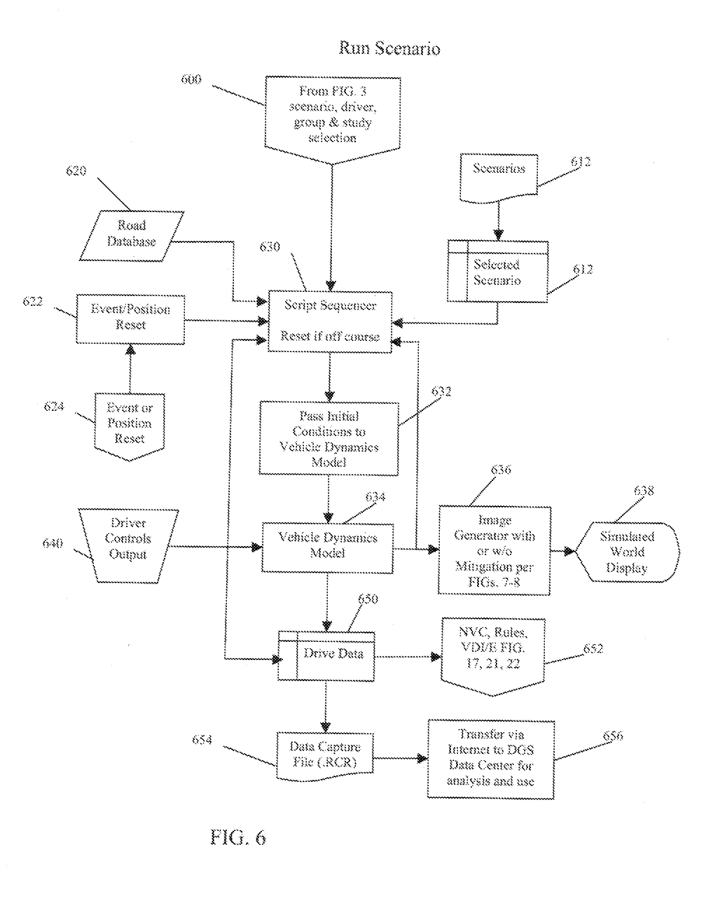

### FIG. 6

FIG. 6 is a diagram of the process of running a Scenario and collecting driver performance data.

### FIGS. 7H, 7I, 7M, 2, 3, Preferred Embodiment

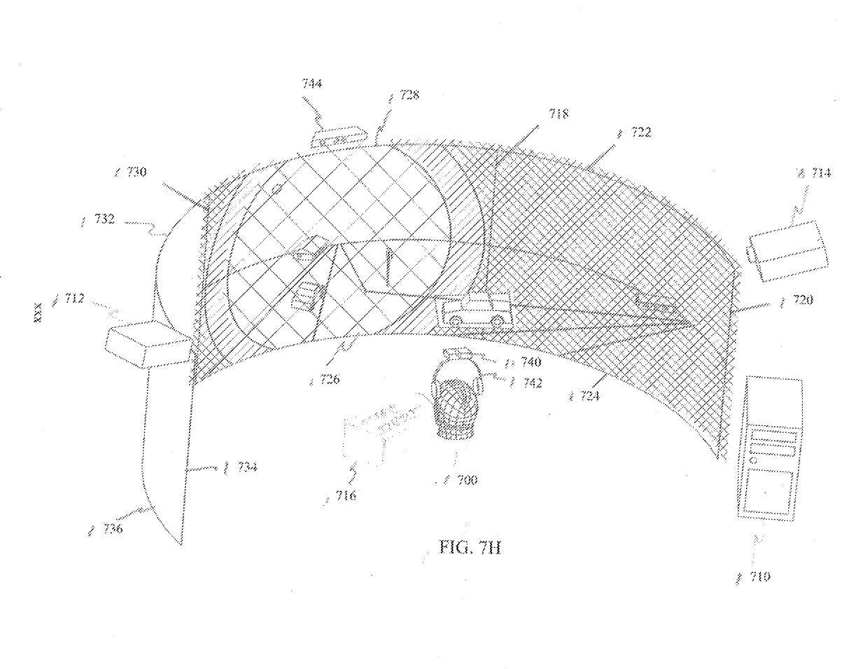

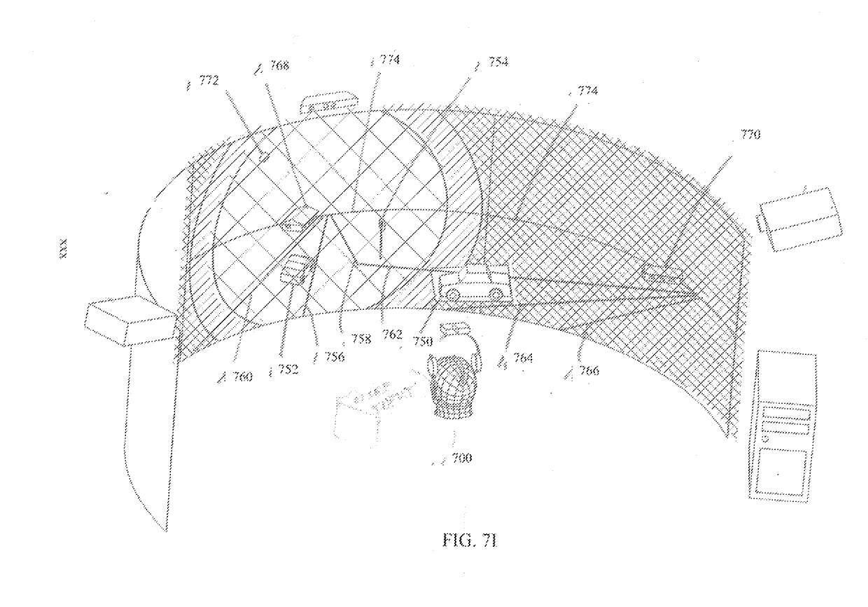

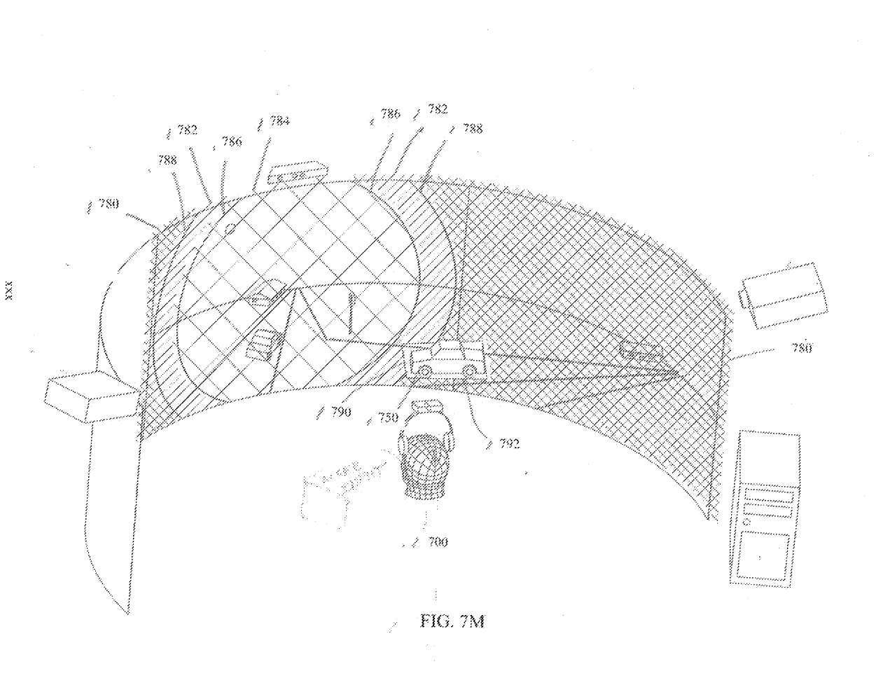

FIGS. 7H, 7I, and 7M together represent a preferred embodiment application of the present invention performing a driving simulator task. Alternate applications will be discussed later.

A preferred embodiment of hardware components/items of the Image Mitigation System of the present invention is illustrated by components in FIG. 7H. The figure represents a driving simulator. An observer or operator 700 is shown regarding the center screen of a three screen display. The person performing the duties of observer/operator can now include most of the individuals that heretofore were adversely affected by such display systems. A computer 710 runs an application that performs all processing tasks including graphics processing and interfaces with three projectors and all detection and user input/output. The computer 710 is connected by cabling (not shown) to other system components. The computer 710 of the preferred embodiment consists of a Windows 7 Pro operating system from Microsoft, a motherboard Asus M5A99X EVO from www.asus.com Asus Computer International, 800 Corporate Way, Fremont Calif. 94539, a 3.6 GHz, eight core processor of type AMD FX-8150 form AMD, a graphics card with memory size 2048 megabytes of type GEFORCE GTX 670 from www.evga.com EVGA Corporation, 2900 Saturn Street, Suite B, Brea, Calif. 92821, 4 gigabytes of 2000 MHz DDR3 main memory and other harddrive

An image projector 712 is held by a ceiling mount or other structure to project an image on a screen that is outlined by a right screen edge 720, a right top screen edge 722, a right bottom screen edge 724, and a center/right screen edge 718. The projector 712 is connected to an AC power source (120 VAC) and a video cable from the DVI-D GEFORCE GTX 670 graphics card of computer 710. The projector 712 is an InFocus IN 716, or a IN 2106 or similar DLP projector from www.infocus.com InFocus, 13190 SW 68^{th} Parkway Suite 200, Portland, Oreg. 97223. A View Sonic HD 7820 projector and other similar projectors will also function satisfactorily. A similar projector 714 is supported by a similar ceiling mount or frame (not shown) and is directed to project an image on the left screen bounded by a left screen edge 734, a left bottom screen edge 736, a left top screen edge 732 and center/left screen edge 730. Projector 714 is connected to an AC power source and a video cable from the DVI-I output of the graphics card of the computer 710. A third similar projector (not shown to minimize confusion of the perspective view) is supported in a similar fashion to the other projectors and directed to project an image on the center screen bounded by a center top screen edge 728, a center bottom screen edge 726, the center/right screen edge 718, and the center/left screen edge 730. The third projector is connected to an AC power source and the HDMI output of the graphics card of the computer 710. An operator station 716 is used by the observer/operator 700 to provide input to a software application running in computer 710. The operator station 716 of the preferred embodiment can range from a Logitec G27 Wheel A head orientation sensor 740 is mounted to a pair of headphones 742 and is shown elevated above the head of observer/operator 700. The head orientation sensor 740 connects to computer 710 to provide the angular orientation and may also provide the position of the operator 700. The sensor 740 a Sparkfun Electronics 9 Degrees of Freedom Inertial Measurement Unit SEN-10736, at www.sparkfun.com SparkFun Electronics, 6175 Longbow Drive, Suite 200, Boulder, Colo. 80301, can be replaced or augmented (added to) by a variety of equipment including but not limited to: 1) a UM6-LT Orientation Sensor from www.pololu.com Pololu Corporation, 920 Pilot Rd., Las Vegas, Nev. 89119 2) a Polhemus Patriot Digital Tracker from www.polhemus.com Polhemus, 40 Hercules Drive, PO Box 560, Colchester, Vt. 05446, and/or 3) a reflector tripod for a TrackIR 5 head tracking equipment available from www.naturalpoint.com/trackir NaturalPoint Inc., P.O. Box 2317, Corvallis, Oreg. 97339. An operator sensor 744 is mounted above the center top screen edge 728. Operator Sensor 744 is or is similar to a Microsoft Kinect Sensor and is oriented to regard the observer/operator 700 and capture head position and orientation with its Infrared and RGB cameras.

FIG. 7I represents the components of an image of a virtual driving environment as projected on a cylindrical screens of the Surround DGS 110. The image contains a longitudinal road bounded by 758, 756, and 760 that travels to the horizon 774. A house 768 is located in the distance on the left of this road. A cross road bounded by 762, 764, and 766 travels to the right and also to the horizon 774 and has a stop sign 754. Again a house 770 is located in the distance near this road. A traffic car 750 can be seen approaching the driver's path to the right on the crossroad. An on-coming traffic car 752 can be seen approaching the driver.

FIG. 7M represents the components of the preferred embodiment of the SMO components. An outside mitigation overlay 780 is shown as the dense diagonal cross hatch pattern. A central mitigation overlay 784 is shown as the less dense diagonal cross hatch pattern. A transition mitigation overlay 782 is shown as a diagonal hatch. A central boundary 786 separates overlay 784 and 782. An outside boundary 788 separates overlays 782 and 780.

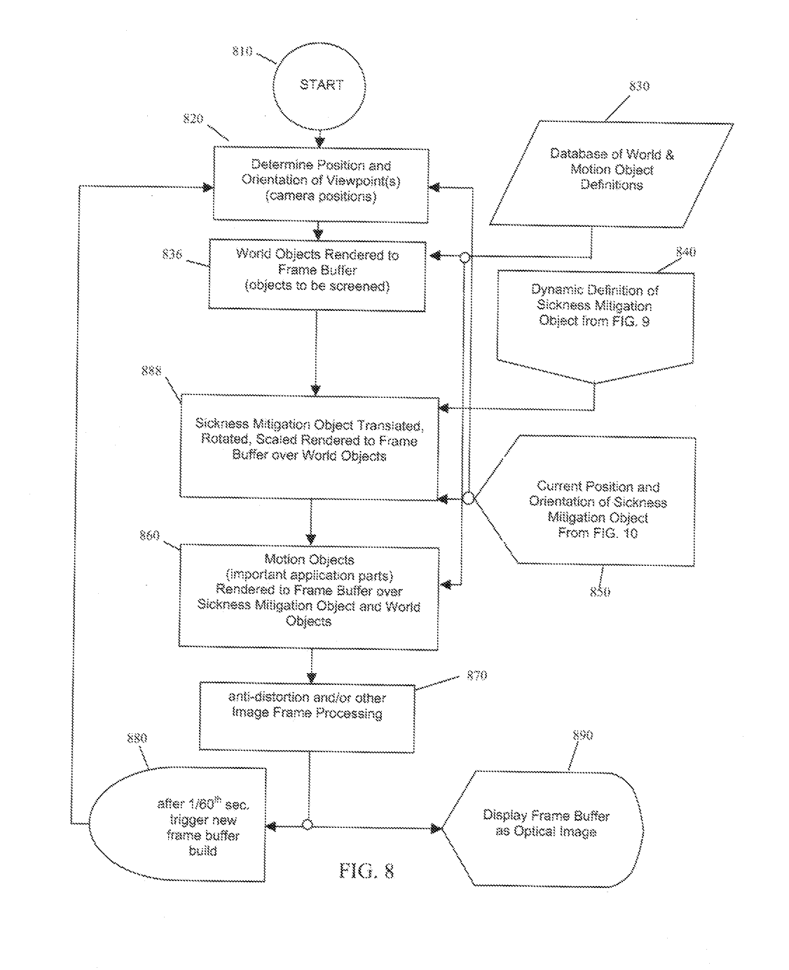

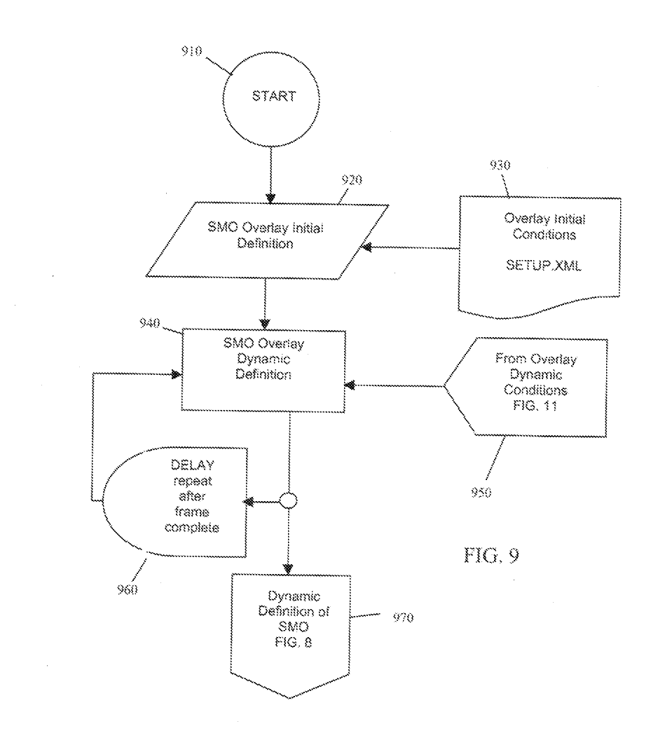

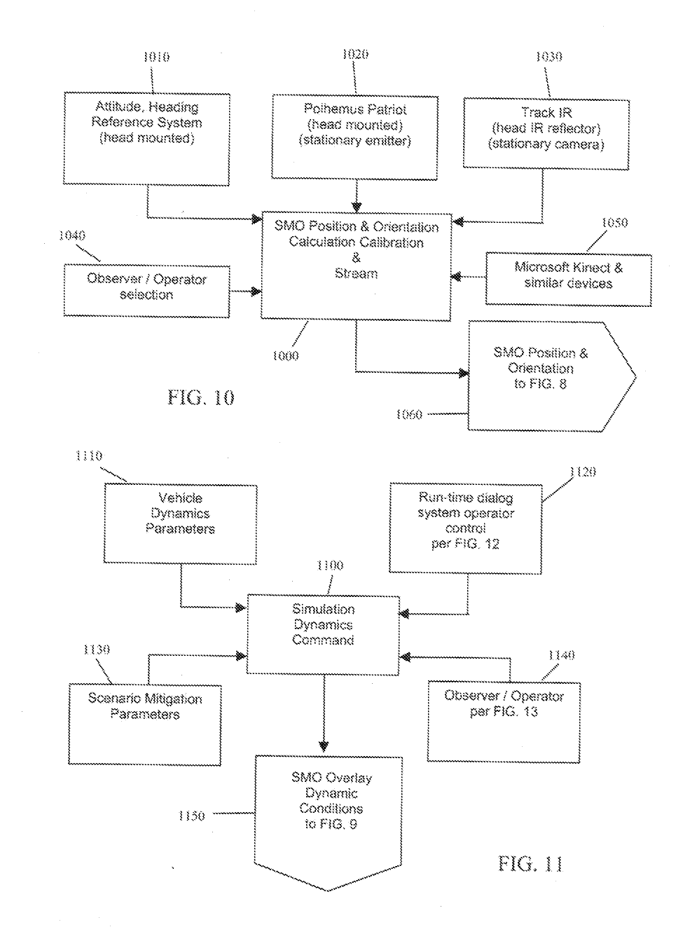

FIG. 8 is a flowchart diagram of the process of mixing the mitigation object with other visual objects to form a combined displayed image of the Image Mitigation System. The combined image is displayed on an optical image display 200. Presently, I prefer several projectors and a cylindrical screen to smoothly wrap the image around the observer/operator. However, projectors and flat screens, a projector and a flat screen, flat panel displays, a single flat panel display such as a High Definition entertainment display and similar could be used as the image display 200.

FIG. 8 illustrates a method for generation and introduction into the graphics stream of a Sickness Mitigation Object (SMO) that is not graphics engine specific. Various graphics engines that are fitted with various graphics adaptors from nVidia or ATI or others that have various memory and computation capabilities could have the World and Object databases configured differently than shown in FIG. 8. The figure shows the general use of World and Motion objects. Several aspects of the SMO are controlled dynamically by other process with inputs from FIGS. 9 and 10.

FIG. 9 is a diagram of the process of creating the mitigation object.

FIG. 9 represents a process to initialize the “appearance” or the way the SMO manifests and how the SMO is dynamically controlled by the dynamics of the simulation and other real-time inputs.

FIG. 10 is a diagram of various components to determine the position and orientation of the mitigation object.

FIG. 10 represents several interface processes for physical orientation and position sensors used to determine the position and orientation of the driver's head. Information from multiple sensors in integrated and sent to the SMO generation Process 888 and also to the general image generation starting at Process 820.

FIG. 11 is a diagram of input systems that dynamically control the shape and other parameters of the mitigation object in real-time.

FIG. 11 represents the preferred embodiment methods and apparatus used to dynamically control the operation of the SMO. The two SMO control methods 1110 and 1130 on the left side of the diagram are programmatically operated and the two on the right 1120 and 1140 are manually controlled.

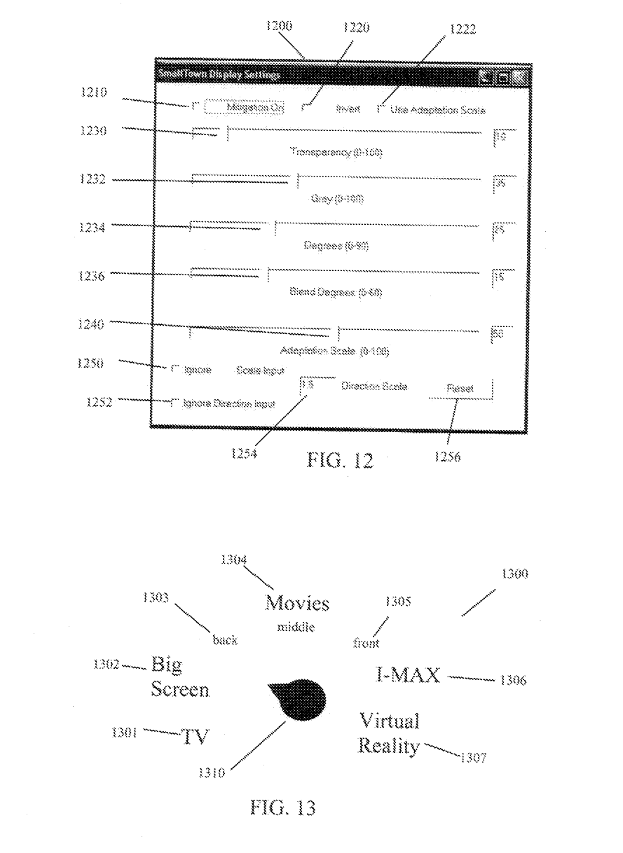

FIG. 12 is an example of a dialog box used to control the mitigation object dynamically and interactively.

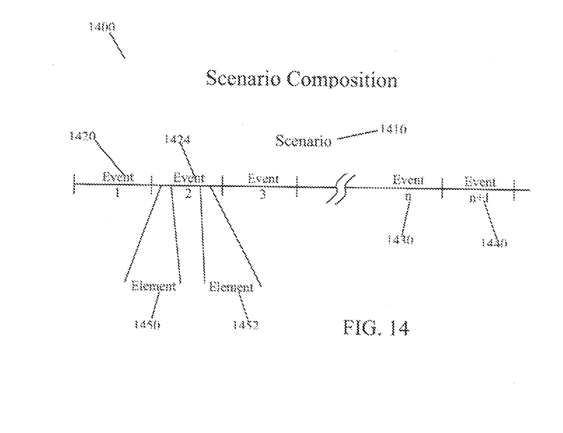

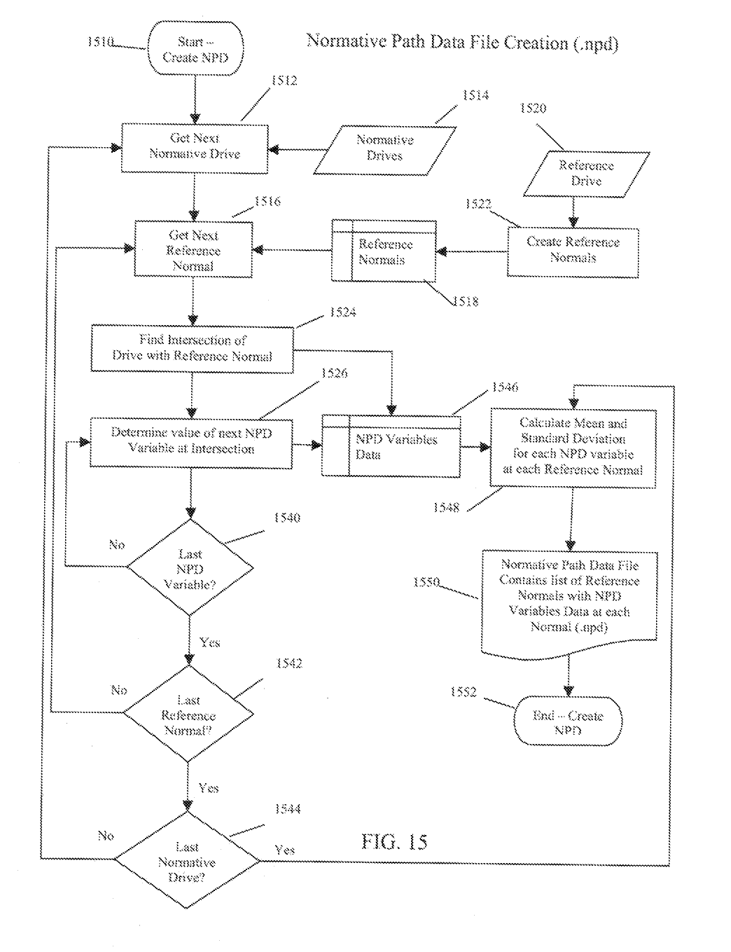

FIG. 12 is an illustration of a SMO dialog to control the application of mitigation. The adaptation scale of the dialog works in concert with the Mitigation Control of FIG. 13 to control the transparency, central degrees, and transition blend region. When the Mitigation Control if fully clockwise, the SMO is completely transparent and does not affect (cannot be seen in) the simulated image. At the opposite extreme or fully counter-clockwise, the SMO de-saturates much of the 200 degree FOV Surround DGS Simulation Terminal to reduce the sickness inducing affects to be similar to that of watching television. The desired operating point of the SMO object depends on the application of the DGS scenario. If the scenario is an assessment that needs to be acceptable to a very broad (95% of the population) set of users, the SMO will need to restrict the FOV of the central area to range around 25 degrees with transition region of about 10 degrees and a low approximately 15% transparency. If the scenario is used for training purposes with a user that has a known tolerance to simulation sickness, the DGS operator may “open up” the SMO to a level that can be accepted by the operator or driver. The controls to facilitate this type of interaction with the SMO operation and the DGS operator or driver are shown in FIG. 12.

FIG. 13 is a rendering of a user input to dynamically adjust the mitigation object.

### DESCRIPTION OF DRAWING

FIG. 13 represents a manual control and the labeling associated with that control as designed for use by the operator, observer, or driver of the DGS. The pointer of the control references a point on the dial at which the vast majority of the public has an ability to accept dynamic spatial images. It points to the upper range of the safe viewing zone for sensitive people in most of the population. Somewhere between the back and middle seats of a movie theater a portion of the public is uncomfortable with moving spatial images and are self-selecting for lower motion saturation of their visual system.

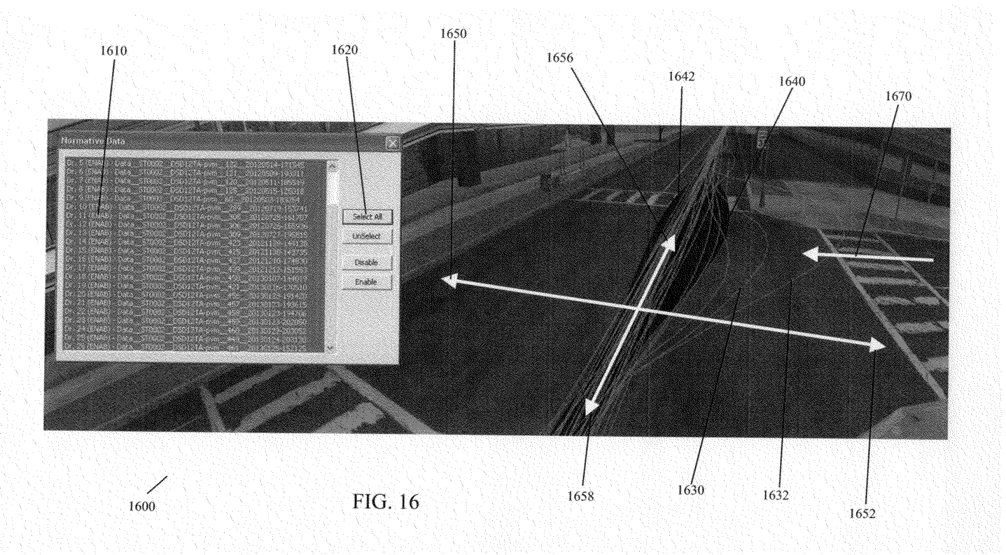

FIG. 14 depicts the sequential composition of Scenarios. A Scenario is composed of at lease one Event but may contain Event 1 through Event n+1. Events may contain Elements.

FIG. 15 represents the preferred embodiment of the process to create the Normative Path Data (NPD) and is not normally run concurrent with or at real-time during a simulation drive. The normative path and related data creation process starts at a Terminator 1510 Start Create NPD. Terminator 1510 is encountered by starting an application such as the NPD Editor from a Simulation Terminal application in the DGS. Normative drives are collected as input from previous driving sessions at an I/O 1514. Normative Drives are made available at a Process 1512 Get Next Normative Drive. Basically, the Normative Drives are drives made by a plurality of drivers who drive a studied fixed course in a simulated small town in a fictional world. The purpose of this is to derive the average or Mean and Standard Deviation at each of a plurality of sample points (Reference Normals in the preferred embodiment) of each of a plurality of Parameters such as steering and throttle inputs, braking, resulting position and speed of the car and time in some embodiments. Of course, the technology is also applicable to training and assessing pilots so the Parameters would be different for that application. More is given on that infra.

The purpose of determining these averages and Standard Deviations is to assess Drivers Under Test against them for scoring. The process of storing these Means and Standard Deviations at each sample point that is also created for the purpose is called creation of an NPD file in the discussion below.

The preferred embodiment uses a plurality of these Normative Drivers. However, there is the possibility that all or the majority of the Normative Drivers may interpret a sign wrong such as Yield at a separate right turn lane of a stop light controlled intersection or miss a sign altogether such as No Right On Red. In such a case, the average or Mean of the Parameters and Standard Deviations would be wrong at certain points on the course. So an alternative embodiment is to have a single skilled Normative Driver such as a DMV instructor or a Highway Patrol officer drive the course and use his or her Parameters at each sample point to establish the norms against which the Drivers Under Test are scored. Similarly, it may serve purpose to have the plurality of drivers be a group of poor drivers and test a DUT that is a good driver to highlight driving techniques that separate the good driving DUT from the poor drivers.

I/O 1514 can access Normative Drives on the local machine of from the DGS Data Center. Thus, the Process 1512 collects normative drives from I/O 1514 and communicates normative drive information to a Process 1516 Get Next Reference Normal. A Reference Drive is input at an I/O 1520 Reference Drive and communicated to a Process 1522 Create Reference Normals. I/O 1520 has similar access to stored drives as I/O 1514. Reference Normals are communicated from the Process 1522 to temporary storage at an Internal Storage 1518 Reference Normals. Reference Normals and associated Normative Drive information is processed at the Process 1516 and communicated to a Process 1524 Find Intersection of Drive with Reference Normal. The Process 1524 communicates data to both Process 1526 and Internal Storage 1546. A series of Tests 1540, 1542, and 1544 control the looping through the variable extraction Processes 1524 and 1526 to extract all of the variables at all of the Reference Normals of all of the Normative Drives. Then Process 1548 calculates the normal value and standard deviation of each variable at each normal. The data is stored as a file at File 1550 and the NPD creation process is complete at Terminator 1552.

FIG. 16 represents an image of a perspective view of a road intersection in a virtual environment. The image also displays several elements related to Normative Path Data and its creation. 1) A list of the drives used is shown in a text box on the left. 2) The paths driven by each of the listed drives, through the intersection, are shown by white lines traveling mostly on the right side of the longitudinal road. 3) A black band “under” the white paths representing one standard deviation of variance both to the left and to the right of the normalized path is also shown. 4) Additional graphical lines have been added to explain the calculation processes for the Normative Path Data.

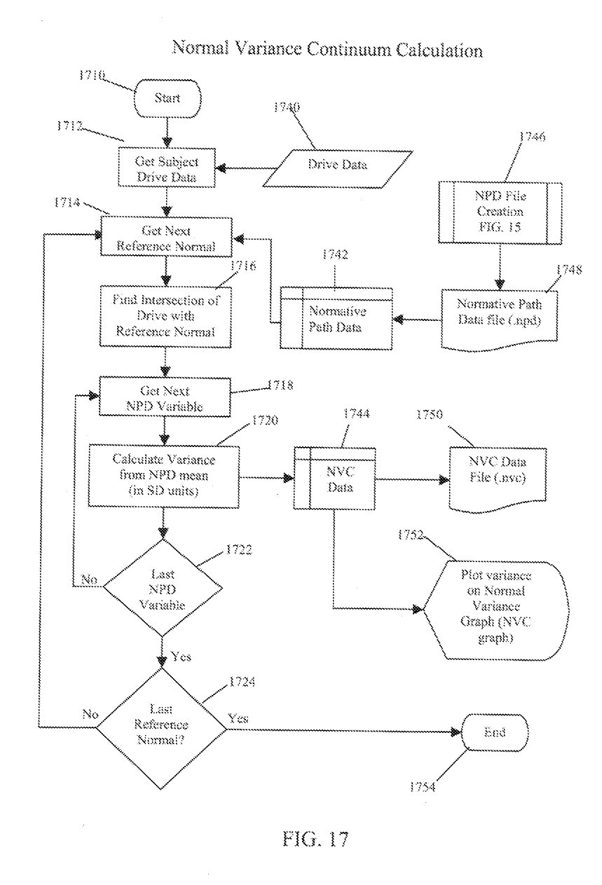

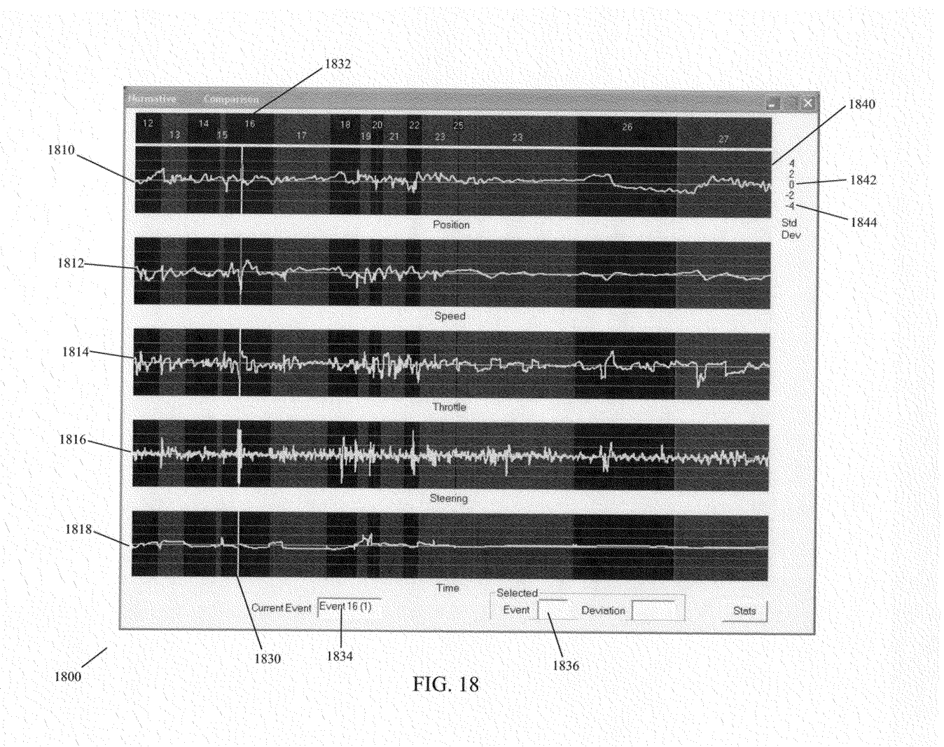

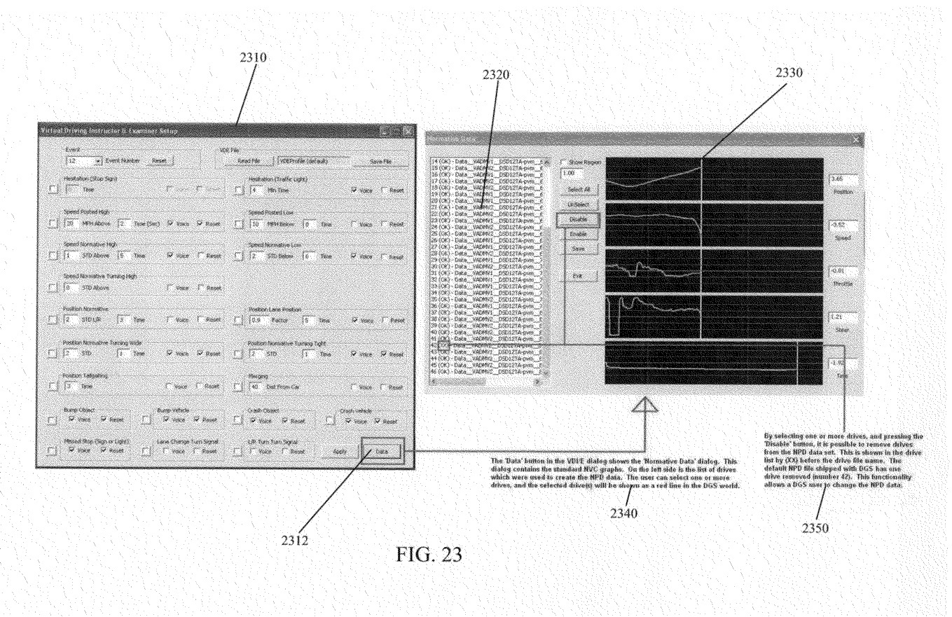

FIG. 17 is a diagram of a process to calculate a discrete instantaneous variance from normal and the running continuum of various driving variables. That is for example, the figure describes how to compare the path (or the speed etc.) that a driver is taking compared to the normalized path etc. of a group of previous drivers. The difference between the driver and the previous group of drivers can be measured in absolute inches or miles per hour or it can be measured in terms of standard deviations from the group's normal for the variable. The measurements are taken at steps along the normalized path as defined by Reference Normals in the NPD data file. The values taken together form a continuum of a driving variable and thus the name Normal Variance Continuum (NVC) refers to a set of variances from normal for a particular variable. I/O 1740 Drive Data inputs real-time or recorded drive data for NVC analysis. The baseline or NPD data in File 1748 can be accessed from the local Simulation Terminal or from a selection of baseline NPD files at the Data Center. Once calculated, the NVC data can be used immediately for the purposes of the VDIE functions (described below) or displayed in a real-time graph per FIG. 23 or stored in File 1750 for later analysis and study using tools as shown in FIG. 18 for study. The NVC data can also be numerically analyzed post drive for driver reports and other purposes.

FIG. 18 is a screen grab displaying normal variance continuums (NVC) for several driving variables across several events of a scenario. Vertically darker and lighter bands in the figure identify the extents of Events in the Scenario. An event number is located at the center top of each Event. The screen depicted in FIG. 18 represents the entire Scenario but can be expanded to show just one Event stretched horizontally across the entire screen. By scrolling the view down, additional variables are displayed.

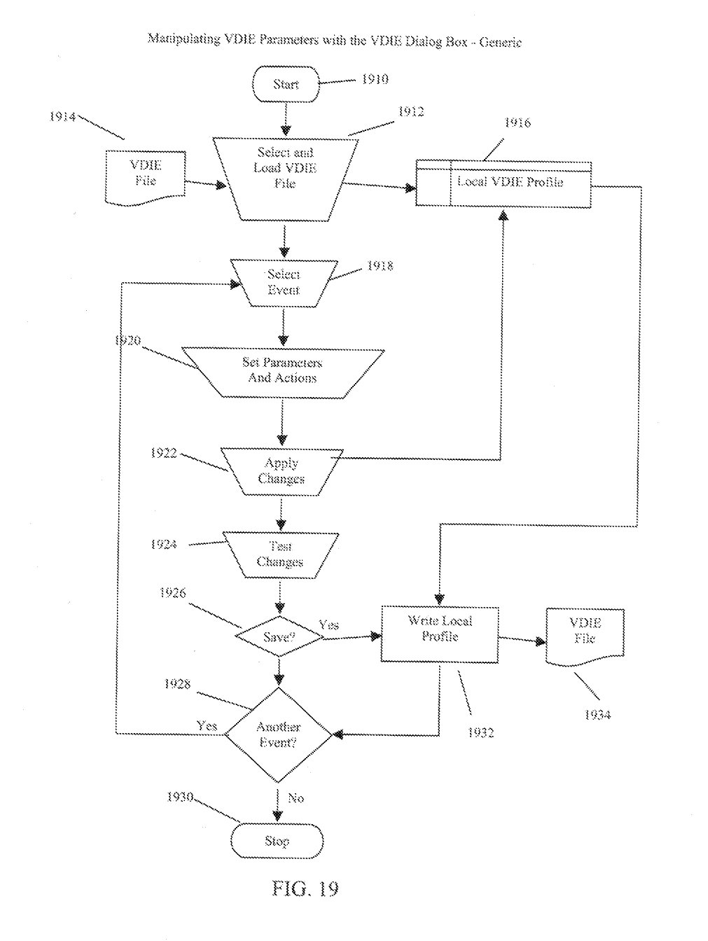

FIG. 19 is a diagram of a process to create Virtual Driving Instructor Examiner (VDIE) profiles on an event-by-event basis to assess and train driving ability

### DETAILED DESCRIPTION OF DRAWING

The process begins with the manual operation (1912) Select and Load VDIE File. VDIE File (1914) data is sent to the internal storage location Local VDIE Profile (1916). The manual operation of Select Event (1918) enables the manual operation of Set Parameters and Actions (1920); which enables the manual operation of Apply Changes (1922); which in turn enables the manual operation of Test Changes (1924). If manual operation Apply Changes (1922) is applied, the data flows to Local VDIE Profile (1916). The decision Save? (1926) will enable the process Write Local Profile (1932) to a file VDIE File (1934) if Yes, or to the decision Another Event? (1928). If Another Event (1928) is yes, control flows to Select Event (1918), else if no, the process is halted at Stop (1930).

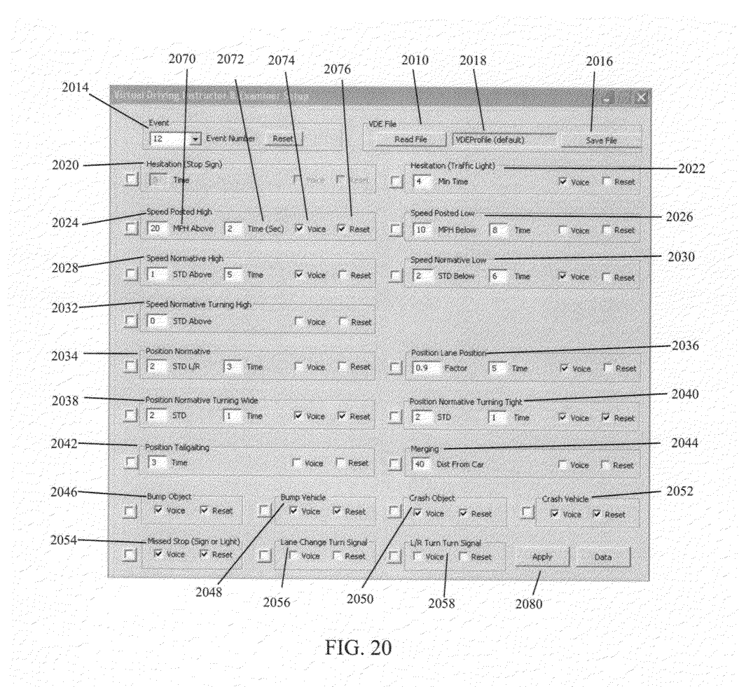

FIG. 20 is a screen grab of a tool that supports creating VDIE profiles. The majority of the selections shown belong to one Event in the profile. Selecting the Event to display and the profile name are exceptions.

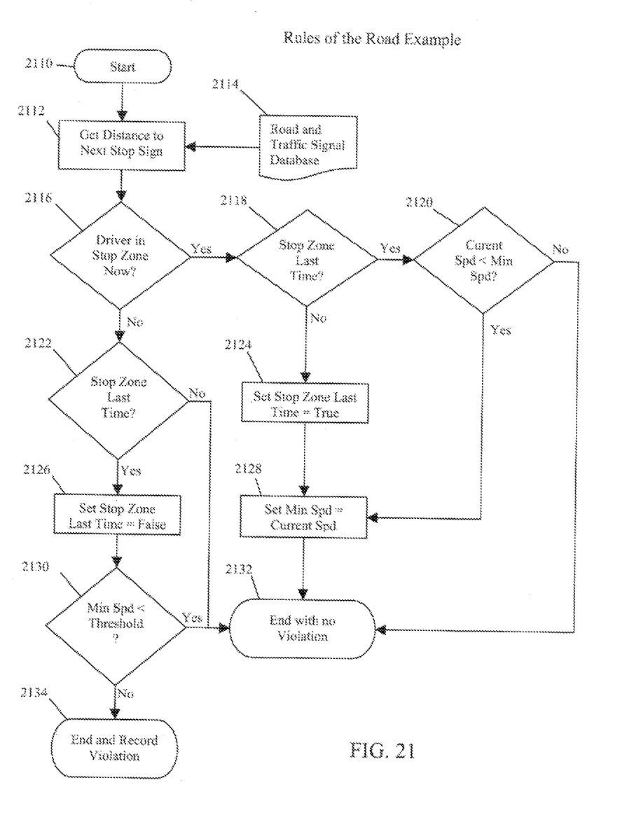

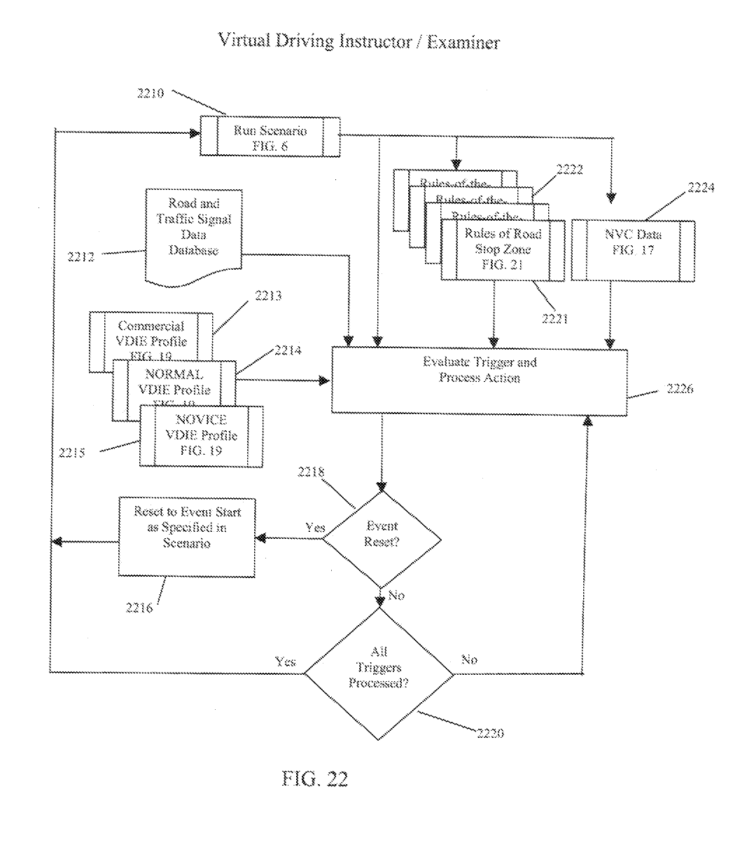

FIG. 21 is a diagram of an example of a process to test compliance to rules-of-the-road in road stop zones. This particular example demonstrates testing vehicle operation stop zones, and is representative of the process for testing other types of rules-of-the-road operation.

FIG. 22 is a diagram of a process to run a scenario in the DGS against a VDIE profile appropriate to the skills of a driver. The flowchart begins with a Predefined Process “Run Scenario” (2210) previously defined in FIG. 6. During the execution of an event within the execution a Scenario, Road and Traffic Signal Data (2212), Rules-of-the-Road (2222), NPD Data (2224) and the Predefined Process Trigger & Action Profile (2214) (defined in FIGURE is used by Evaluate Trigger and Process Actions (2226). The result is sent to Event Reset? decision (2228). If result of Event Reset? is No, send process flows to All Triggers Processed (2220), or if Yes, process flows to Reset to Event Start as Specified in Scenario (2216) process.

FIG. 23 is a screen grab of a VDIE profile in use and a screen grab of previous drives in an NPD file with the real-time NVC traces as the scenario is being driven. The NVC graph is displaying the progress through the length of an Event like a vital signs monitor in a hospital would display heart beat etc. over time. Selection of one or more of the drives will cause the path of that drive to be displayed in the virtual world similar to the paths shown in FIG. 16. Outliers can be observed and removed from the NPD calculation with this control (buttons and selection capability) of this tool.

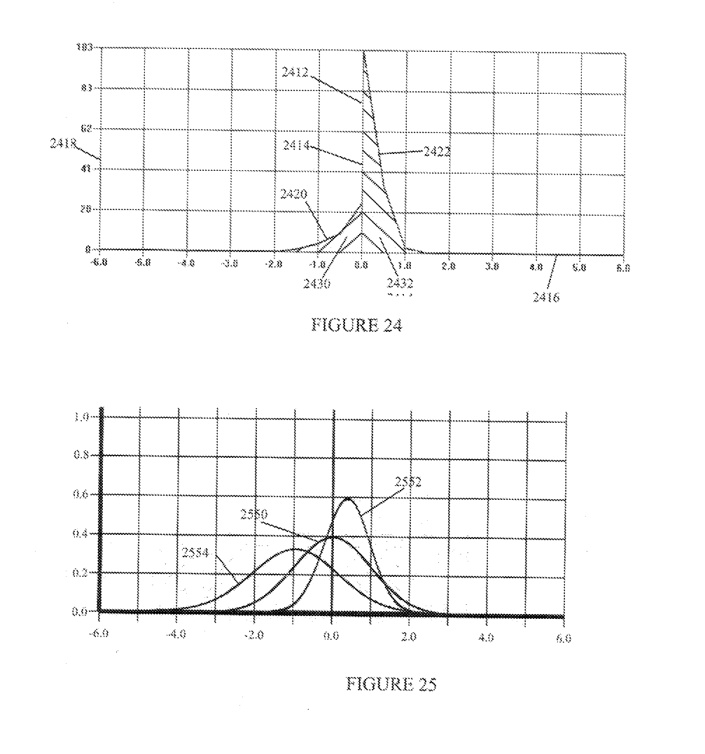

FIG. 24 is a sample graph of the variance area of the speed variable of a driver during Event 19 of a Tactical A(3) drive on the Driver Guidance System. Areas 2430 and 2432 indicate that the

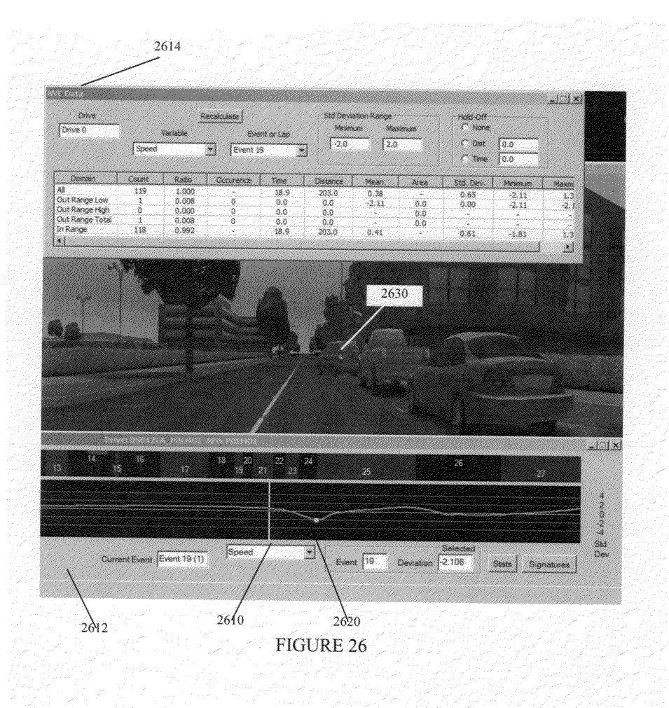

FIG. 25 is a graph of the variance of the speed variable from FIG. 24 showing the Variance 2552 of the variance at each RN. A shorter road section is analyzed for the travel lane incursion in Event 19 and shown by distribution 2554 that drops significantly below other drivers.

FIG. 26 is composite screen grab of three images. The top image is a “Stats” window showing detail of Event 19. The center image is part of the first-person point-of-view as seen during the Event from the drivers seat. The incursion vehicle 2630 is shown pulling into the drivers lane. The lower image is a NVC or Fonda graph of Events contained in the Scenario of the Tactical a(3) drive. The events range from 12 to 27. The chart shown has been expanded to show the NVC of the speed variable during Event 19.

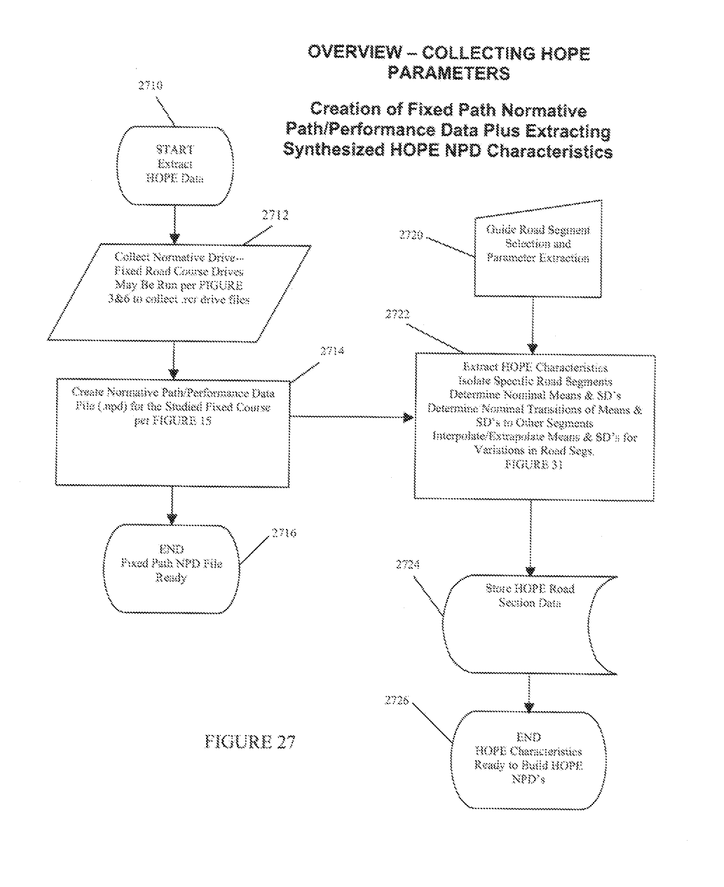

FIG. 27 is a flowchart that is intended to show the requirement that a studied fixed course needs to have been processed through the NPD creation process of FIG. 15 and associated discussion before HOPE parameters Extraction at 2722 can take place.

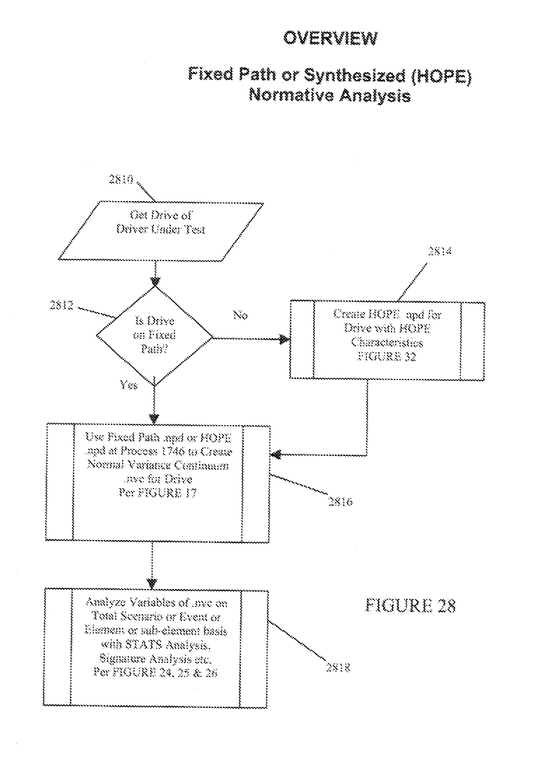

FIG. 28 is a flowchart clarifying that both studied fixed course and synthesized NPD can be analyzed at Process 2818 with the NVC techniques.

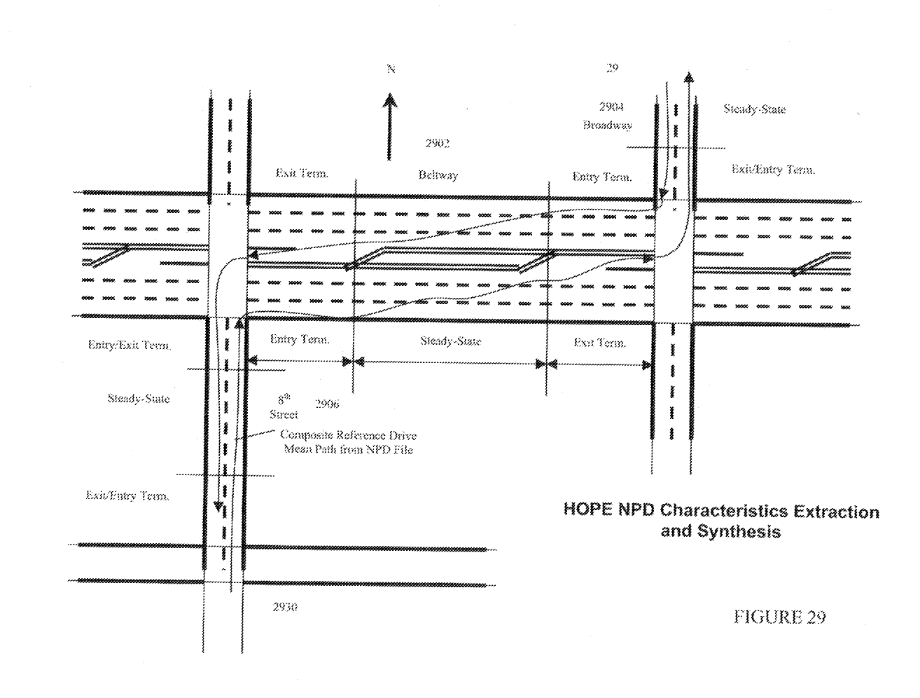

FIG. 29 is a plan view of a section of roads that happen to contain a studied fixed course and a synthesized course. The studied fixed course travels north on eth Street then east on Beltway and finally north on Broadway. The synthesized course travels the opposite direction and can be assessed with the NVC techniques following the creation of a synthesized NPD of the reverse route.

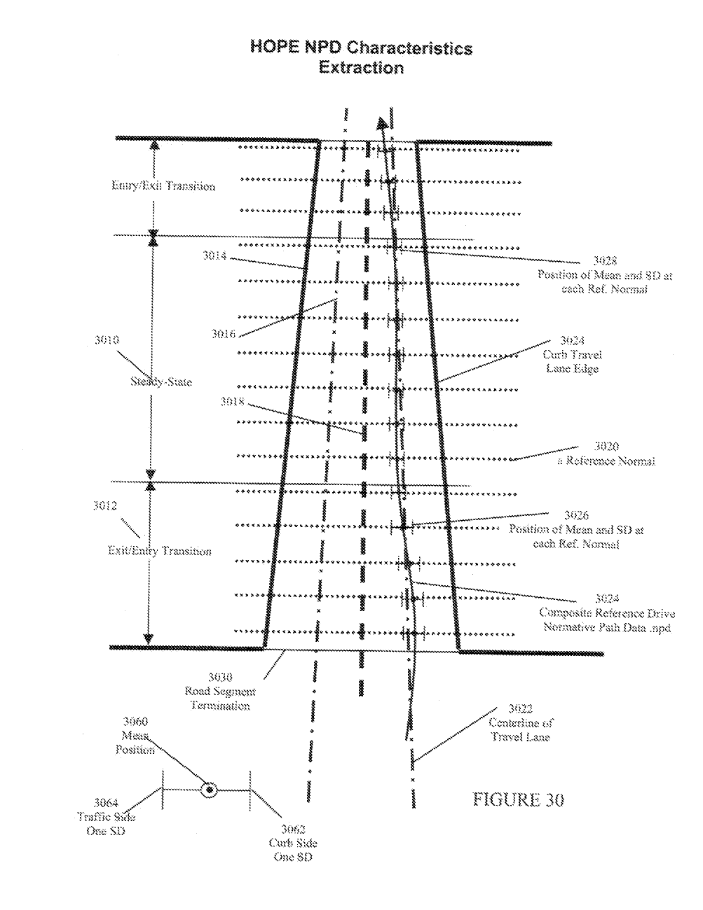

FIG. 30 is a perspective view of components of a road section important to the HOPE extraction and synthesis processes being disclosed. Central or at the base of the techniques disclosed is the Centerline of Travel Lane 3022. This is the reference line that measurements start or are based from. The line becomes the parametric centerline in the HOPE synthesis process and is used for generation Reference Normals that are subsequently loaded with Means and SD of various variables. Many other base lines could be used (for example the road section or roadway centerline) with equivalent results. The concept is that something that functions like 3022 needs to be available. Reference Normals like 3020 are shown but could be other structures like rectangles or something that would function like a sample point or analysis point.

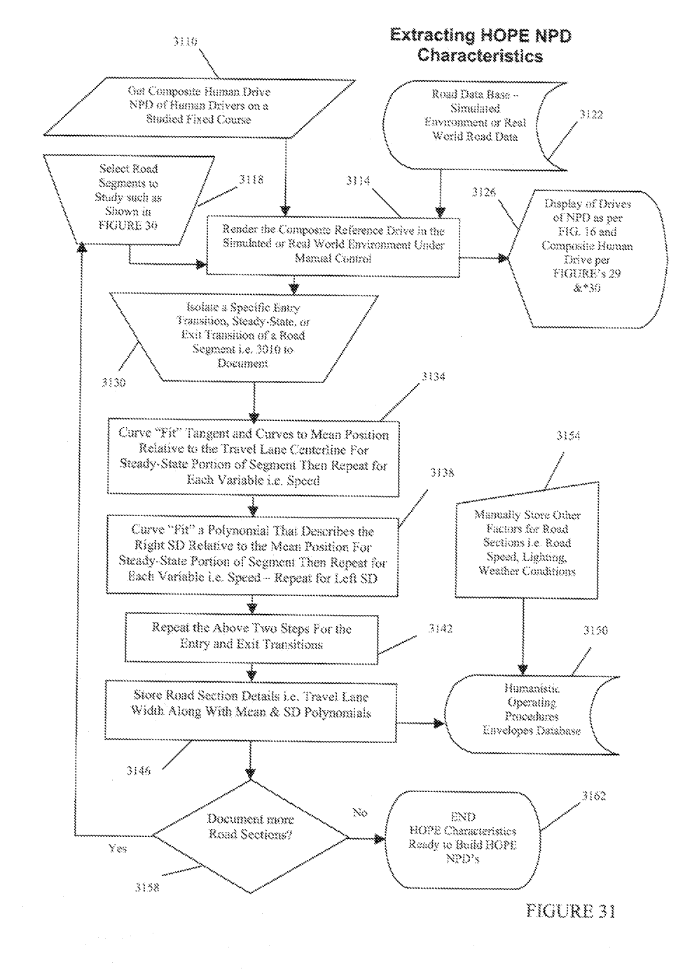

FIG. 31 is a flow chart of the manual manipulation meaning operator required HOPE NPD characteristic extraction techniques. A graphic display workstation Process 3114 gathers information about the road system and world graphic database from Store 3133 to allow an operator the ability to study the types of road sections in a studied fixed course NPD and eventually select a particular road section to extract HOPE information from at Manual Operation 3130. Then through a series of Processes 3134, 3138, and 3142 mathematically reduce “the way” the human based Composite Reference Drive navigated the particular road section. Then with additional Manual Input and through Process 3146 capture the HOPE Parameters of the road section and store them in Store 3150 for use when synthesizing similar road sections.

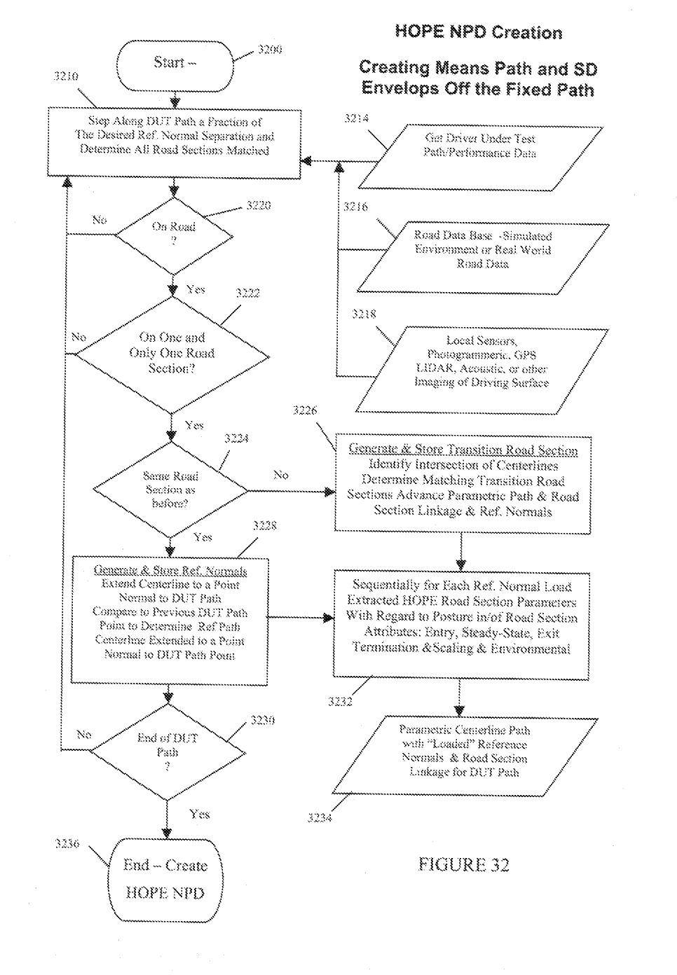

FIG. 32 is a flowchart of the process to synthesize an NPD file for any road course that can be parametrically defined and that we have similar HOPE Parameters for. The road course could contain from zero to 100 percent road sections that are from a studied fixed course. The road sections could only exist in a virtual world, or they could be real world road sections displayed in the virtual world or they could be road sections that are driven and viewed only in the real world. The first step is to compare the route of the DUT and generate a road description form the potential road structure that the DUT could potentially be navigating. This information can come from the virtual or real world Data 3216 or from sensors on the vehicle the driver drove if they are capable of determining road structures. Next the DUT Path 3214 is matched to the road structure through a series Decisions 3220, 3222, 3224 while the DUT path is incrementally followed. As this occurs, a parametric centerline of the driving or travel land like line 3022 is constructed. Then Processes 3328 and 3232 match and extract HOPE road sections from the HOPE Database 3150. Reference Normals or other sample points are generated and loaded with the respective Means and SD for the variables and the HOPE NPD is synthesized.

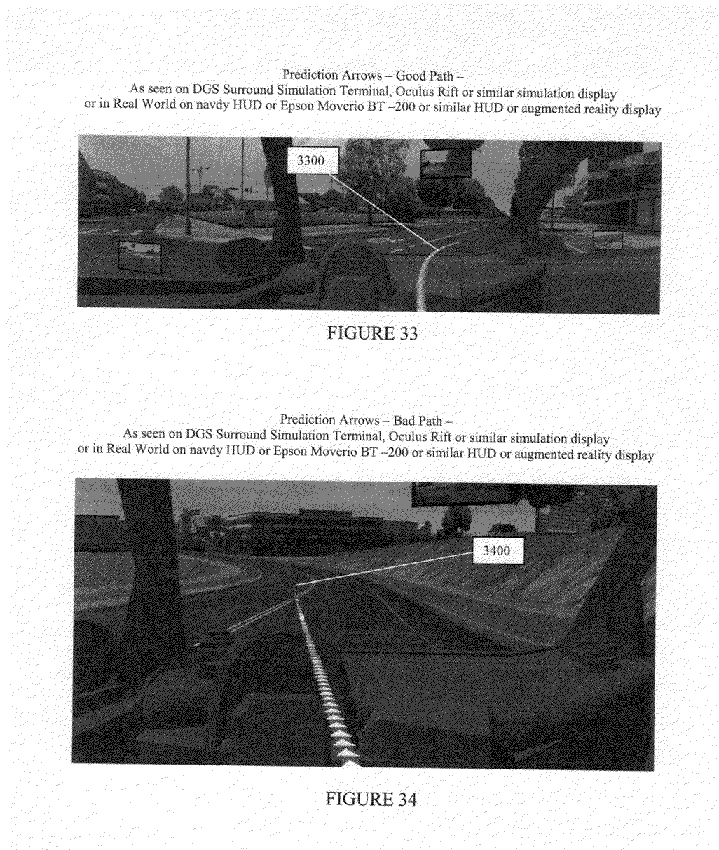

FIG. 33 is a screen grab of a vehicle turning at an intersection through a right-turn. The image is a still screen grab of the dynamic turning operation. A series of “Prediction Arrows” 3300 are shown leading the vehicle. The arrows represent the path the vehicle will take in the next three seconds.

FIG. 34 is another still screen grab of a dynamic situation. This time the Prediction Arrows 3400 cross the centerline into the oncoming traffic lane

### Section One

Detailed Operation Driver Guidance System—DGS Data Center—DGS Registration—Simulation Terminal Start—Scenario, Study, Driver Selection—DGS Roles—DGS System Functioning while Running a Scenario

### FIG. 1—Driver Guidance System—Data Center Detail

The Driver Guidance System, FIG. 1 assesses and/or trains driving ability of individuals.

Simulation Terminals present the illusion of driving a motor vehicle. Simulation Terminals (Terminals) such as 110, 120, and 130 provide a simulated vehicle operating station to capture the control manipulation of the vehicle operator (driver) and present spatial images of the environment the vehicle is transiting. The Terminals also execute Scenarios and capture the resulting drive performance data generated as the driver responds to events, i.e., the execution of Scenarios. The Terminals (110, 120, 130, and similar) capture both the actions of the driver and the resulting actions of the simulation that include the Scenario caused actions. All of this data relating to the driver and the simulation is currently captured 60 times per second. The data is transmitted through any data path, but typically the internet 140 to a server 150 for storage and analysis. The Driver Guidance System identifies and connects with various types of Simulation Terminals. The type of Terminal affects the ability of a driver to navigate Scenarios. The larger Surround Simulation Terminal 110 maintains an automobile-like, temperature-controlled environment composed of a dashboard, automobile seat, force feedback steering wheel, accelerator, pressure-sensitive brake and clutch with automatic or manual shifter. A 200 degree cylindrical display wraps around the driver for spatially accurate viewing. Angular distortion error is less than 1.5 degrees. The image displayed rate of 120 Hz is preferred to minimize image edge blurring during horizontal or vertical pan that is caused image edge stutter of common projection systems. Viewsonic 7820HD or InFocus IN116 have been found to operate satisfactorily. For a few operations of the Terminal that do not include pan or fast motion, 60 Hz will allow the Viewsonic 7820HD to operate in full native mode (1920 by 1080) and provide approximately one pixel per arc minute of image or near eye-limiting image display. Basic Simulation Terminal 120 operates on a graphics capable laptop computer with commercially available steering and pedal controls such as the Logitec G27. Current day laptops from HP, Dell with nVidia graphics systems will operate and run the Driver Guidance System at reasonable frame rates. Laptops outfitted as “gaming machines” are particularly suited for the Driver Guidance System. The Mobile Simulation Terminal 130 uses the components and systems of 110 in portable room such as common enclosed box trailers of approximately 16 feet long by 8 feet wide. There are many sources for suitable “cargo” or “toy box” trailers. Wireless connections are used to communicate with other Driver Guidance System components. Other forms of Simulation Terminals that utilize head mounted displays (not shown in FIG. 1) also function with Driver Guidance System.

Data Center 150, typically a server securely receives, stores, analyzes, and retrieves or serves the data captured from the client systems 110, 120 and 130 as Drivers Under Test drive (or fly) the Assessment Course and react to events by the executing Scenarios. Access to the Data Center is via user/password protection. Registration with the Driver Guidance System at the Data Center is required for full benefit of the system capabilities. Sensitive data is protected under Privacy and Security Policies designed to comply with HIPAA and other confidentiality requirements. A tiered user structure supports driving studies and treatment plans that are monitored by professionals. Scenarios are the impulse or challenge that drivers are measured against. A Scenario is a driving session that is composed of Events that are short segments of driving sessions that contain various driving Elements. The Scenarios are real-time scripts that are served by the Data Center to the Terminals before each driving session of a Terminal. During the execution of a Scenario, hundreds of variables are collected in real-time for real-time assessment and/or training and they are also securely stored at the Data Center for later analysis. Scenarios are provided to assess and train particular concentrated areas of driving abilities. Using driving-relevant stimuli from the Simulation Terminal's simulation of a vehicle and 3D world environment, real-time driving responses from the driver are captured. Evaluation of abilities in the following categories: Operational Driving (Vision, Motor, Cognitive through Executive Functioning) and Tactical Driving are provided. Some Strategic driving capabilities of drivers can be derived from the Scenarios. For example, consistently driving at half the posted speed limit is a strategic decision that can be evaluated. Each category contains numerous Scenarios that will be detailed later. Scenarios are significantly automated. An audio avatar instructs the driver and asks for direction input (response from the driver) via the Terminal's controls.

The DGS Interface 160 graphical user provides a variety of functionality purposed for different users: Driver, Researcher, and DGS Operator. For the Driver, it enables analysis on personal drive data. For the DGS Operator, the Web Browser enables the execution of Scenarios and the management of Drivers and Studies. For the Researcher, it provides a variety of functions including analysis, reports and the ability to manage Studies, Groups, and team members. Researchers and Drivers can also replay and view captured drive performance using a DVR-like player that plays the entire drive and highlights critical events and dissects details in slow or stop motion. The Data Center 150 also enables researchers to compute and display analyzed data in a variety of formats for web viewing or file download. Researchers can base their analysis on baseline or from normalized data from a variety of sources.

### DGS Data Center Server

A preferred embodiment of hardware components of the Data Center of the present invention is illustrated by components in Fig XXX. The figure represents a Server xx0, an Internet Router xx1, a software Firewall xx2, a DSL Modem xx3 and a representation of the Internet xx4. The Server xx0 is connected to Internet xx4 via the Server xx0 on-board Ethernet adapter to the Internet Router xx1. The Internet Router xx1 is connected to the DSL Modem xx3 and to the Internet xx4.

The Server xx0 of the preferred embodiment consists of a Linux operating system using Linux kernel version 3.2.0-48 Single Multiprocessor from Ubuntu, a motherboard Asus P5N-D from www.asus.com Asus Computer International, 800 Corporate Way, Fremont Calif. 94539, a Phoenix Technologies version ASUS P5N-D ACPI BIOS Revision 0601, an Intel Core2 Quad CPU Q9550 processor running at 2.83 GHz, 4 gigabytes of 800 MHz DDR2 main memory and 1 Tera-bytes of RAID 1 hard drives.

The Server xx0 runs several applications that facilitate data connections to all Driver Guidance System (DGS) Simulation Terminals located externally on the Internet, and also serves as a Web Server.

The Server xx0 operating as a Web Server runs several layers of applications to present various web site pages to registered users. The base web server application is Apache version 2.2.22 built with no threading but with various forking from the Apache HTTP Server Project www.apache.org. Both PHP version 5.3.10-1ubuntu3.7 from www.php.net, and Drupal version 7.19 from www.drupal.org are called by the Apache server when needed at various times depending on the request by users. All Internet connections to the web server are routed through a Secure Sockets Layer (SSL) that is validated by an SSL Certificate operated by Go Daddy.com at: www.godaddy.com.

A preferred embodiment of hardware components of the connection between the DGS Data Center Server and DGS Simulation Terminals is illustrated by components in Fig YYY. The Data Connection between the Server yy0 and any DGS Simulation Terminal yy1 uses a Public-key cryptography system. Data connections to DGS Terminals use the Secure Shell (SSH) Secure Copy protocol (SCP) to securely copy data to and from DGS Simulation Terminals. Each DGS Terminal contains one private key yy2 and the Server xx0 maintains all DGS Terminal public keys yy3. When needed, the DGS Terminal yy1 will contact the Server yy0 to receive or send secure data. Data sent from the Server yy0 to the DGS Simulation Terminal yy1 are scenarios and utility data. Data sent from the DGS Simulation Terminal yy1 to the Server yy0 is utility data and captured drive data.

An application, called DataConvert, runs on the Server xx0 as a service to convert the captured drive data that has been sent from the DGS Terminal yy1 to the Server yy0 and stores the data in a MySQL database system. Each institution that connects their DGS Terminal(s) to the Data Center has their own database. DataConvert interprets the drive data that had been captured to store in the institution's database. The database structure of each institution is identical, only the data is different. There are two major uses of the database tables: 1) to store captured drive data and 2) to maintain associated data about the drives such as Studies, Scenario names and approved accesses for users.

Each institution's database consists of 14 tables as follows:

drive
op_result
op_result_interp
op_tactical_outcomes
op_vision
recorded_simulation_data
study_ci
study_groups
study_inst
study_npd
study_ra
study_scenario
study_uid
violations

### Drupal

Custom PHP modules are used to provide a variety of services for registered users such as maintaining driver profiles, administering scenarios and analyzing captured drive data. Custom PHP modules use Drupal, a Content Management System, to provide functionality to the user. Six types of users roles have specific access to the website usage and access to data. The users and their descriptions are:
* Administrator: Complete access to all Drupal functionality to maintain the website.
* Developer: Access to developer utilities such as connection data about all DGS Terminals in the field
* Principle Investigator: Access to all drive data for assigned institution. Can maintain/add drivers and scenarios. Can create studies and groups. Can run several different analysis tools on institution's drive data.
* Co-Investigator: Can run several different analysis tools on institution's drive data.
* Research Assistant: Can add driver's to studies and administer scenarios from the DGS Terminal
* Driver: Can drive the DGS Terminal vehicle. Can view analysis of personal drives and analysis of Operational scenario data.

### DGS Roles

The application of the DGS is based upon Roles. Roles include permissions that enable data security and privacy as well as functionality. Each Role and associated functions are described below.

### DGS Operator User Role

The DGS Operator typically administers Scenarios to Drivers. Administering a DGS Session involves 1) starting the hardware and software and then 2) initiating a DGS Session. The DGS Operator controls the Driver's testing on the Simulation Terminal by the use of the DGS Operator Panel shown in FIG. 4.

The DGS Operator selects a Scenario, a Study and a Driver and optionally a Group to test a Driver. FIG. 5 shows the user interface to administer scenarios to a driver. The DGS Operator also has the permission to add Drivers to studies and to manage Drivers assigned to a specific Study.

### Investigator Role

The Investigator Role allows access to the Investigator's drive data for each driver. Specifically, the Investigator can view All Drives of all Drivers in all studies, 2) manage the study names, and view the Operational Report and Tactical Reports of a driver per study.

When selected, the All Drives web page will be presented to the Investigator. Each row identifies one Scenario drive.

Each column contains particular information or action per scenario. Those are:

Username: the username/login name of the Driver

Group: If a “Group” was selected during administering the drive, it will be shown.
Date (UTC): The date and time that the Scenario information was downloaded from the website when requested from the DGS Operator. Essentially the timestamp of the scenario. UTC Stands for Coordinated Universal Time.
Scenario: Name of the Scenario. Selecting a Scenario in this column will call functions on the web server to analyze the individual Scenario. If a Tactical Scenario is selected, the outcome variables for the selected Scenario are displayed along with z-score, standard deviation and mean.
Class: The classification. If selected, you can change the classification. When selected, the PI has full control to change the Classification text. If changed to “Normative” the particular drive will be included in the Normative pool for analysis.
CSV+: A comma-separated-value file that includes collected data used for analysis and computed outcome variables (like those displayed on the website). The file may be downloaded by clicking on the arrow.
CSV: A comma-separated-value file that includes collected data used for analysis. The file may be downloaded by clicking on the arrow.
XML: An XML file that includes other collected data used for analysis. The file may downloaded by clicking on the arrow.
RCR: An .RCR file that contains all data collected of the drive. This file is also used to playback the Scenario using the DGS Player. The file may downloaded by clicking on the arrow.
DC ver: The version number of DataConvert. Reanalyzing the drive is provided.

The Investigator may also manage Studies, Groups, Drivers, Scenarios.

The Investigator may also display current drive outcome variables of a selected Driver within a selected Study for the latest Operational Scenario of a selected Driver. This analysis shows the
Domain which is the category of the Scenario
Scenario Test
Date of the Scenario in UTC time
The Outcome Variable calculated for each Scenario Test
The Driver's individual score for each Outcome Variable
The Driver's Z-score for each Outcome Variable
The Mean for the Outcome Variable based on the Normative Pool.
The Standard Deviation (STD) for the Outcome Variable based on the Normative Pool
The number of drivers in the Normative pool for particular Operational Scenarios tested for the Driver.

The Investigator can obtain the same analysis data in Microsoft Excel format, suitable for downloading.

### Driver Role

The Driver Role may view analysis of personal drives. Each Scenario can be selected to display an analysis of the particular scenario. The functionality is similar to the All Drives functionality for the Investigator, but limited to the Driver's data only.

### DGS Data Flow

Generally speaking, a DGS Operator will administer a variety of scenarios to a driver or drivers. The data is captured by the DGS Terminal and securely sent to the Data Center. Investigators and Clinicians or the drivers themselves can later perform a variety of analysis functions on the data to view the data through various “lens” provided by the website.

FIG. 1 shows the simplified Data Flow for each component of the DGS.

### FIG. 2—DGS Registration

An individual wishing to operate many of the more useful and unique features of the Driver Guidance System must first register. Anonymous operation of the DGS provides only partial functionality. FIG. 2 describes the Driver Guidance System user registration system. The registration process starts at 210. Opening a Web browser at www.generalsimulation.com 220 to connect to the DGS Interface. The next step 230 is to find and select the “Register” link on the interface. Then Complete Registration 240 to receive a user/password for identification in the Driver Guidance System. After submission of the registration the DGS Interface will perform tests to attempt to determine if the registration is a valid human user at Step 250. If the registration does not calculate to be from a human user, the registration is deleted at Step 260 and the registration process terminates at 290. Otherwise, the registration process will allow additional rolls to be requested by the user at Step 270. Note, see below for a discussion of the various DGS rolls. If no additional rolls are requested, the registration process terminates at 290 or the request is submitted for roll acceptance at Step 280. When the rolls are confirmed or denied, the registration process is complete.

### FIG. 3, FIG. 4, and FIG. 5—Simulation Terminal Start—Scenario, Study, Driver Selection

The Driver Guidance System assesses and trains driving ability by recording and analyzing how a driver performs during various driving Scenarios. Scenarios are programmed computer instructions that target and assess particular characteristics of driving abilities. They operate within the DGS-ST application on a Simulation Terminal. Scenarios, along with the driving-relevant stimuli from the Simulation Terminal, assess and train Drivers in concentrated areas of driving in the following categories: Vision, Motor, Cognitive including Executive Functioning and Tactical Driving.

When a driving session is started on the DGS, a Simulation Terminal connects to the Data Center and the user can identify a registered Driver, Scenario, Study or Syllabus, plus a few other characteristics.

A Research Assistant or Operator (DGS OPERATOR) administers a Scenario from the Control Monitor on the Simulation Terminal using two applications:
The DGS-ST Operator Panel shown in FIG. 4—this application runs on the Simulation Terminal and controls the operation of the of the Simulation Terminal and the Scenario
DGS Interface shown in FIG. 5—this application runs at the Data Center and interfaces the Data Center to the Simulation Terminal.

Then upon downloading from the Data Center to the Simulation Terminal an Info File containing the information, the Scenario is ready to run. The process starts when a user or DGS Operator runs the DGS application at 310 in FIG. 3. The application then displays the Driver Guidance System Simulation Terminal Operator Panel. An example of the Operator Panel is shown in FIG. 4.
ACTION: The Driver is asked to sit in the driver's seat behind the steering wheel of the Simulation Terminal.
ACTION: The DGS OPERATOR executes the DGS-ST application.
RESULT: The DGS-ST Operator Panel will appear on the Control Monitor's desktop FIG. 4 and the 3D world appears on the Driver's screen(s).

Activating button 410 on the Operator Panel requests connection to the DGS Interface as shown in FIG. 5 facilitating the next step of selecting the driver etc. per Step 340.
ACTION: The DGS OPERATOR selects “Select Scenario and Driver” button on the Operator Panel 410 in FIG. 4.
RESULT: A web browser is started on the Control Monitor and the General Simulation website appears.
ACTION: The person operating the Driver Guidance System is required to log in to the General Simulation website as a DGS OPERATOR through the web browser. The DGS OPERATOR selects the “Scenario Selection” hyper-link from a DGS OPERATOR menu.
RESULT: The “Scenario Selection” DGS Interface web page appears to the DGS OPERATOR shown in FIG. 5.

The first step therein is to select the Study or Syllabus at drop-down box 510. Any Grouping of the drive is selected at 520. A registered Driver is selected at 530. A Scenario is chosen at 540 and a decision to use the drive data in a normative collection is determined by check box 550. Data about the selections are packaged into an Info File 350 that is communicated back to the Simulation Terminal when the Download button 560 is operated per 360.
ACTION: The DGS OPERATOR selects the Study form selection box 510 in FIG. 5, Group (optional) from box 520, Driver from box 530 and Scenario from box 540. Optionally, the DGS OPERATOR may indicate that this particular drive is a “Normative” drive by checking the check box 550. The DGS OPERATOR selects “Download” button 560 to download the Scenario.
RESULT: The selected Scenario, meta-data about the selected Scenario (such as information about the Study), along with de-identified driver information is securely downloaded from the Data Center to the Simulation Terminal.

The DGS application running on the Simulation Terminal will The Operator Panel shown in FIG. 4 will display that a Scenario (and the other information) is being downloaded in window 470. Upon completion of the download from the Data Center to the Terminal, the cued Scenario title will be displayed in window 430. Delivery and/or presentation of the Scenario can be further controlled by Options at 440 or the Manual Transmission selection check box 480. The Simulation Terminal and DGS Application are now ready to run the selected Scenario and accredit the results to the Driver selected per 370. When all selections are complete, the Scenario is initiated by the “Begin” button 420.
ACTION: The DGS OPERATOR selects “Begin” 420 in FIG. 4 from the Operator Panel to begin the Scenario that was downloaded under the account of the Driver with sundry other information.
RESULT: The Scenario visually begins on the Driver's screen and automated voice instructions introduce the Scenario to the Driver.

If a Scenario contains a practice session, either the full Scenario with practice session or just the Scenario can be selected with radio buttons 450 and 460 in step 380.
ACTION: The DGS Operator selects either Complete Test 450 or Bypass Practice 460 from the Operator Panel.
RESULT: A Practice Run will execute if “Complete Test” is selected.
ACTION: If “Complete Test” is selected, DGS OPERATOR will select the “Practice” Button 462 to start the Practice.
RESULT: The Driver will be able to practice the Test. An automated voice will instruct the Driver through one trial of the Scenario. No data will be collected.
ACTION: After completion of the Practice, or if the DGS OPERATOR selects Bypass Practice 460 the Practice button 462 is grayed out and the Test button 464 is activated.
RESULT: DGS OPERATOR can now start the Scenario by pressing the Test button 464.
ACTION: RA selects the “Test” 464 button.
RESULT: The Operator Panel will show input data forms specific to the Scenario being used for testing. 5 in FIG. 6 is an example of the Cognitive Divided/Selective Attention Scenario. Note: some Scenarios have data input forms and some do not.
ACTION: The Driver will perform the complete test executing all trials of the Scenario.
RESULT: Appropriate Scenario data will be captured and logged under the Driver.
ACTION: Scenario will end
RESULT: Captured scenario data will be securely uploaded to the Data Center. The Data Center will store the data in the appropriate institution's database for later retrieval and analysis.

During the execution of a Scenario, the DGS OPERATOR may select “Abort” 466 from the Operator Panel to abort the Scenario for a variety of reasons. The DGS OPERATOR will be shown a “Scenario Abort” dialog box to select the reason for the abort. Performance Drive data is uploaded to the Data Center whether the Scenario was aborted or completed.

### FIG. 6—Run Scenario and Vehicle Dynamics Model***

With reference to FIG. 6, the operation of running a Scenario in a Simulation Terminal of the DGS will be explained. Basically, this means displaying a road coarse or a simulated flight to a Driver Under Test (DUT) or a Pilot Under Test (PUT) with events that happen during the drive or flight, and recording how the DUT or PUT responds to the events. There can be Scenarios for driver training such as drives through a studied fixed course through a fictional small town, and Scenarios where the DUT can drive at random through the streets of the fictional small town and drives through the actual streets of the DUT's home town or a city of the DUT's choosing. Data from Google Maps and/or Google Earth can be used in some embodiments to supply the images of the streets of the DUT's home town or city of his or her choosing, or any other way of obtaining the data as to what the streets are and what they look like in the city of the DUT's choosing can be used in other embodiments. After selecting and initiating the operation of a Scenario via the techniques of FIGS. 3 to 5, the Simulation Terminal DGS Application runs the Scenario. Connector 600 communicates data from the selection process of FIG. 3. The data includes many components of information that will serve to make the driving performance data about to be collected more useful in both real-time and at later times. All of the information about selections made in the steps of FIG. 3 and all of the related selections such as Study selections like DGS version and other options are recorded. The exact conditions of the DGS are thus logged so that the conditions of the test can be exactly replicated and properly analyzed and reanalyzed at the current and later times. The definition or program script of the Scenario to be run can be downloaded from the Data Center stored data 610 and into an internal storage 612 of the Simulation Terminal computer. This step could also take place at the end of the selection process in FIG. 3. Thus, internal storage 612 is loaded with the Scenario script identified in the data from 600 and communicated to a Script Sequencer 630. A Road Database document 620 is located in the Simulation Terminal computer and supplies the location and physical structure like widths, lanes, posted speed limits, location of stop lines, intersections, and other related information to the Script Sequencer 630. During the initial start of a Scenario, the location and orientation of the driver's vehicle is determined from the script of the Scenario. That position and orientation is communicated to a Pass Initial Conditions Process 632. In addition to the initialization process at the beginning of Scenarios, there are other times that control is reinitialized. Connector 624 communicates resets from other process like VDI/E (to be discussed) to and Event/Position Reset Process 622. Process 622 then communicates to Sequencer 630 the parameters of the reset. Thus far, only the position and orientation of the Driver's vehicle have been discussed. The reset and initialization processes also apply to all moveable and variable objects associated with the operating Scenario. The list of affected items includes but is not limited to traffic lights and other variable road signage, other moveable or variable traffic vehicles or obstructions or precursors including items such as bicycles to bouncing balls to flying debris and the like. The initialization thus includes the reset to initial conditions of everything in the simulated environment. Points (positions) or moments in the Scenarios that are chosen as reset points are the neutral or low activity points.

In a typical five to fifteen minute Scenario, there could be five to fifty reset points that could be used. Upon restart this allows the driver to resume normal speed before the activities and challenges of the Scenarios resume. Initial Conditions Process 632 communicates with a Vehicle Dynamics Model (VDM) 634. The Vehicle Dynamics Model is a free body modeling process which calculates the position, velocities and accelerations and orientation of the vehicle in relation to inputs such as the throttle, steering, braking inputs and the terrain across which the vehicle is moving along with the weight of the vehicle and other factors such as the coefficient of friction of the tires on the surface upon which the are rolling and the tire patch, i.e., how much tire is actually in contact with the road, and other specific characteristics of the tire model. Such characteristics include braking traction force, friction circles, lateral force, i.e. how many pounds of lateral force the tire can produce to resist a skid given the slip angle and the cornering stiffness and the breakaway point, how many Gs the tire can withstand on the skid pad before slipping, etc. Such Vehicle Dynamic Models are known, and at least one embodiment thereof was used in the Hard Drivin' arcade video game marketed by Atari Games in 1988, which is hereby incorporated by reference. Vehicle Dynamics Models are also in wide use in Flight Simulators and are well known. Pioneering work on Vehicle Dynamics Models was done by William Milliken in the 1950s and is publicly available. One publication that describes some of this work on race cars was “Race Car Vehicle Dynamics” by William and Doug Milliken, published in 1995, which is hereby incorporated by reference. This is the seminal work in this area.

The VDM 634 receives vehicle control input from the driver from a manual input process 640. As a driver operates the controls, they are read by process 640 and communicated to the VDM 634 in a continuous repeating cycle as time progresses. The faster this cycle, the better for the fidelity of the simulation. Five hundred times a second, 2 ms (two millisecond) delta time between iterations is used but a 1 ms or one thousand times a second would improve operation. As the VDM 634 repeatedly receives control input from process 640, the position and orientation of the driver's vehicle change over time. The amount of change is subject to the driver's steering, throttle, brake, and other control manipulation as they affect the calculations over time within the VDM 634. The driver vehicle position and orientation, is communicated to an Image Generator 636. Data from the Road Database 620 (connection not shown) and other databases (not shown) containing the position and orientation of objects in the simulated environment and the structure and external visual texture of the objects is used to generate an image of the environment from the position and orientation of the driver's vehicle by Image Generator 636. That image is communicated to a Display 638. Image displays like Display 638 of dynamic simulated environments that subtend significant visual angles are known to cause motion sickness like symptoms in observers of the images. This causes observers to be unable to accept the use of technology that is dependent on such displays. The percentage of the population that is adversely affected by a particular display can be 50% or higher. Image Generator 636 can accommodate a larger group of observers, meaning drivers of the DGS, by mitigating the ability of the display to cause the adverse reactions. Image mitigation techniques are explained later in this disclosure. As stated above about the initialization process applying to all moveable or variable objects, the VDM 634 or other time based modeling iterates and updates the position of any associated objects at the same time the driver's vehicle is updated. Faster image display rates improve the realism of the simulated environment. The more dynamic a Scenario, the more important a faster image update rate becomes. Depending on the ability of hardware used to operate the DGS, a update rates from 60 Hz to 120 Hz are used. VDM 634 also communicates position and orientation of the driver vehicle and other moving objects back to the Script Sequencer 630. The information is used by the Sequencer 630 to interactively step through the script. As the driver progresses along the road the Sequencer 630 will trigger or initiate elements of interaction such as but not limited to voice instructions to the driver, traffic car interaction, pedestrian interaction, and other elements of the Scenario script. Many of these interacting objects will have an initial position, orientation, and velocity that Process 632 will pass to the VDM 634 for modeling over time. Then VDM 634 will communicate new information to Sequencer 630 to repeat the script sequencing process. Additionally, the Script Sequencer 630 tests for conditions that merit resetting the execution of a script to one of the reset points. If the driver does not follow the instructions of the Scenario script and leaves the path they are reset back to a point that will allow successful completion. All of the moving objects are initialized to that point and the Scenario script execution continues. As the Scenario is progressing, the VDM 634 is driving through the road course per instructions, position and orientation data of all moving objects is captured in a data storage Drive Data 650. This data is used real-time by other processes for assessment and training interaction with the driver and it is also stored. Drive Data 650 is communicated via Connector to processes labeled NVC, Rules, VDIE, FIG. 17,21,22 that are explained later. Additionally, Drive Data 650 is captured in a RCR Data Capture File 654. The captured drive data File 654 is communicated to the DGS Data Center for analysis and use.

### Section Two

### Detailed Operation—Image Mitigation System

### FIG. 7H, FIG. 7I, FIG. 7M

Operation of the simulator sickness Mitigation methods and apparatus are explained with reference to a group of figures labeled FIG. 7H, FIG. 7I, and FIG. 7M and collectively referred to as FIG. 7. Hardware components or physical items generally use reference numerals between 700 to 748, the general image elements use between 750 and 778, and the Mitigation elements use numerals 780 to 798. The preferred embodiment of the present invention uses immersive display systems such as a 200 degree field-of-view high resolution display depicted in FIG. 7. Other embodiments use display systems with smaller field-of-view subtended, such as laptop displays and because of the less significant adverse affects at causing simulator sickness benefit less from the following discussion. Conversely, other embodiments using very small displays in head mounted display systems stand to benefit greatly from the Mitigation as herein disclosed.

Hardware components of an immersive virtual reality operator/observer station for simulation systems that benefit from Mitigation technology are shown in FIG. 7H. Computer 710 runs the Driver Guidance System (DGS) Simulation Terminal application. The application can communicate with the DGS Data Center for administrative control and structure lesson control of the Scenarios that a particular driver receives. In addition, the image Mitigation methods apply to many other applications. From games to driver training to driver assessment to flight-test to tele-operation of remote vehicles, image Mitigation benefits the operator. Computer 710 generates simulation images or displays video from a remote vehicle, interacting with the driver/operator by reading control manipulation and issuing audible verbal instructions. The simulation images generated by computer 710 are projected by the right image projector 712, the left image projector 714 and a center image projector—not shown. The projectors 712, 714, and the center projector cast images on cylindrical screens covering a total of 200 degrees of an eight foot diameter arc. A driver/observer's head 700 is shown at the center of the cylindrical arc of the screens. The elevation of the eyes are set such that a 50 percentile adult is generally located at the vertical height of the horizon display. That is, the eyes of the driver/observer are at the height of the horizon plane in the virtual/remote image. The approximate rest location of the image horizon is set to bisect vertical screen edges 718, 720, 730, and 734. The operator station may contain driving, flight or other controls appropriate to the simulation and representative of the actual vehicle controls. The various head orientation or position tracking devices 740 and 744 are mounted on or positioned to monitor the driver/observer.

FIG. 7I details the components/items of a spatial image representing a virtual environment. The depicted environment is that of driving but could be flying, or video from a remote vehicle, or any spatial image. By its nature, the image from the depicted 200 degree field-of-view, dynamic, unmitigated, spatial image would cause viewing discomfort for many operators. A cross traffic vehicle 750 is shown approaching a stop sign 754 on an intersecting crossroad that is bounded by a crossroad center marker 764, a crossroad opposing edge 762, and a crossroad right edge 766. At a distance out the crossroad opposing edge 762 a house 770 near the road can be seen. An opposing direction vehicle 752 is approaching operator 700 on a road bounded by a road opposing edge 760, a road center lane marker 756, and a road right edge 758. In the distance a house 768 near the road can be seen at the horizon 774, with the sun or moon in sky 772 above and to the left of the house 768. In FIG. 7I images are shown on the center and the right screens, the left screen (shown at a high angle) is blank.

FIG. 7M details the components/items of the Image Mitigation System that are combined with the image components/items of FIG. 7I to mitigate discomfort causing aspects. An outside mitigation overlay 780 is shown as a diagonal mesh covering the right screen and parts of the center screen. If the left screen were shown, it would also be covered by overlay 780. Overlay 780 can be composed of several elements

To help the understanding of the Mitigation objects and their purpose, the hypothesis for reducing simulation sickness is explained. Starting from the fact that few if any individuals could be named that developed discomfort while watching “normal” television. That is, the television could be displaying a first person view of action packed racing, the point is very few if anybody complains of viewing difficulties. I also noticed that when the same content, that did not cause trouble on a television, was viewed in a movie theater, many people elected to sit away from the screen. It seemed that many of the same group that moved to the back of the theater seating were also in the group of lesser fans of IMAX movies. Thus, the initial hypothesis was that if the visual stimulation of the simulated environment could be reduced to the level accepted by the back of the room theater goers while still delivering the necessary information of the simulation then the vast majority of the population could accept such simulator based assessment and training. The first method for reduction of the stimulation that comes to mind is reducing the FOV of the simulated image. This method is even advocated by some researchers in the field of simulation sickness. Handbook of Driving Simulation for Engineering, Medicine, and Psychology) But reducing the field-of-view (FOV) to that of normal television viewing (15 degrees subtended or less) is not usually helpful when building high fidelity immersive driving or flight game, assessment, or training systems. Looking deeper into how the television, movies, and IMAX images were and were not accepted provides further insight. Generally, the area observed by our left eye is 120 degree horizontal by 80 degrees vertical with the center of focus 30 degrees to the left of the right edge. Our right eye observes a similar area on the right side. Thus we observe 180 degree of horizontal image with at least one of our eyes while both eyes overlap the center 60 degrees (+/−30 degrees) forward of our face. Our high-resolution central or foveal vision of each eye also overlaps in the center of the 60 degree overlap for a few (+/−2) degrees. This is a much smaller area than even television viewing indicating that the vast majority of the population can accept simulation images that fully stimulate the area of central vision. It also indicates that partial peripheral stimulation is also accepted. Believing that a very large majority of the population could accept simulation images with a relatively small area of “full” peripheral stimulation, I surmised that a larger area of peripheral vision would also be accepted if the level of stimulation could be reduced. Taking from my personal experience with headaches and associated light sensitivity I noticed that both cupping my hands around my eyes to limit the amount of light to that of a small area and also wearing sunglasses to limit the overall light provided relief. In the case of this invention the goal in not to limit the number of photons entering the eye but to limit the relative percentage of photons forming the moving image that induces simulation sickness. The hypothesis was thus extended to developing methods to mitigate or de-saturate peripheral stimulation while delivering the simulation information and content. The term “de-saturate” is used to indicate that a portion of the photons, up to 100%, of the combined image is composed of photons that do not induce simulation sickness. The goal was to find methods to reduce the overall peripheral stimulation of the simulation image while maintaining the simulation related image information. It was hoped that by the time the peripheral image was de-saturated and fully extended to the 180 degrees perceived, that the elements of the simulation image still functioned to provide information necessary for the majority of the simulation operation. Stated in terms of square degrees of area, the challenge was to reduce the saturation of the peripheral stimulation such that the ability to accept approximately 500 to 1000 sq. degrees—saturated—could be stretched to accept approximately 14,000 sq. degrees—de-saturated. To that end, a main element of the Mitigation is a screen 780 of FIG. 7M. The outside mitigation overlay (screen) 780 is an image component that is combined with the simulation image components of FIG. 7I. Various visual forms of the screen 780 have been tested. A gray homogeneous partially transparent (fog like) overlay is the currently preferred version. Other forms of the screen 780 include non-homogeneous meshes similar to the diagonal cross-hatch as actually drawn in FIG. 7M, or vertical, horizontal, or both mesh structures. These mesh structures can be opaque or partially transparent like the homogeneous screens and the size of the elements of the mesh structure can vary in size from many percentage points of the screen to indistinguishably small or homogeneous like. As the opacity is increased (the transparency is decreased) of screen 780 the simulation image is de-saturated. As de-saturation is increased, eventually, the simulation sickness inducing affect of the simulated image is mitigated to a point that the most sensitive observers are able to accept the simulation image across their full peripheral vision for extended periods of time without discomfort. Millions of people have operated the large immersive driving simulators I have been responsible for, because of simulation sickness thousands have been made uncomfortable, and many have been very uncomfortable. I have studied the theories about simulation sickness and lamented with the various authors that it was a fact of life that just had to be accepted. Not anymore. At least not for but a very very few people or for people using applications where the mitigation herein described cannot be applied.

FIG. 7M depicts several elements of the Mitigation that improve the ability of the simulated image to deliver its full payload of entertainment, assessment, and/or training value. But the figure does not depict the dynamic methods that also help. Screen 780 is usually only necessary when the simulation image is causing simulation sickness. That is when the vehicle is moving through the simulated environment (world) and as a result the image is moving around on the screen to depict motion. Screen 780 is not normally needed in a driving simulation when the driver's vehicle is stopped and the simulated image is constant or mostly constant. Thus, when a driver pulls to a stop at a stop sign or stoplight, the opacity of the screen 780 can be reduced or eliminated. The driver can now “look both ways” etc. and observe the simulated world using the fully saturated simulation image. As the driver pulls away from the stop, the Mitigation (de-saturation of the simulated image) can be increased to reduce adverse affects. By smoothly changing the Mitigation over time the driver is less likely to be distracted by the Mitigation objects. Many times it is useful to ramp up the Mitigation quickly and ramp it down slowly. Heavy braking causes the nose of the vehicle to dip and is reported by others to be a significant contributor to simulation sickness. If the Mitigation is operating at a relatively low value (more saturated simulated image) and a driver brakes heavily, the Mitigation will need to be ramped up in the range of 50 milliseconds or two or three video frames in a 60 Hz vertical refresh system. In the preferred embodiment, the Mitigation is operated at a relatively high value and fades away only when the driver's vehicle is stopped. Other improvements in the Mitigation system are used to improve the utility of the simulated image. One such improvement is to vary the density of the Mitigation such that the central area or areas of interest are more saturated. The central mitigation overlay 784 is an example. The lower density diagonal cross hatch of the central mitigation 784 in the drawing indicates a more saturated simulated image in that region. As the Mitigation increases and decreases because of the motion of the simulated vehicle in the simulated world, the perceptible change of the central mitigation 784 is less than screen 780. Thus the fade out and in of the Mitigation is harder to detect by the driver when their attention is principally in the center of the image. Another advantage is that the payload of the simulated image in the central area is easier to observe. In the preferred embodiment the central mitigation 784 is set very low to off. To minimize the contrast between the central mitigation 784 area and the screen 780 area a transition mitigation overlay 782 region lies between a central boundary 786 and a outside boundary 788. Transition 782 feathers the mitigation value in a visually smooth manner between the boundaries 786 and 788. As a result, fade out and in of the Mitigation is less noticeable to the driver. The Mitigation assembly of the central 784, transition 782 and screen 780 can also be moved “over” the simulation image to best allow the driver/operator to view the simulated image. Several methods have been tested for moving and keeping the central mitigation 784 area centered at the driver's area of regard as deduced from the orientation of the driver's face and head. One method uses a head orientation sensor 140 that is attached to headphones 742 or to a hat or headband. Another method is to derive the orientation of the driver's face from a sensor like the Kinect sensor depicted as a operator sensor 744 in FIG. 7H. Inferring the direction of interest by monitoring the direction the driver/operator is steering the vehicle can also be used to move the central 784 area in that direction and then fade over time back to center. Another improvement in the delivery of the payload of the simulation image involves choosing certain components of that image and not applying all or only applying part of the Mitigation screen over them. Cross traffic vehicle 750 of the simulation image is shown in FIG. 7M partially within the area of screen 780 but without the screen 780 applied. Vehicle 750 could also have had any fraction of screen 780 applied as a function of its position in the image or per its proximity to the driver's vehicle. Also, to communicate important information about Vehicle 750 and other simulated items an opening in screen 780 and the transition 782 showing the location of 750 on the road is provided. In this instance, easy accurate determination of the lane position and speed by the driver of vehicle 750 is facilitated. Object cutout boundaries 790 and 792 may form larger or smaller openings in the Mitigation 780, 782 and 784 to improve delivery of the simulation image payload in balance with overall de-saturation goals. Operating the Mitigation system with a center screen fixed central overlay 784 of 40 to 45 degrees subtended set at fully transparent (no mitigation), a transition overlay 782 of 15 degrees subtended, and the balance of the image variably under screen 780 dependent on the motion of the driver's vehicle and set at 75% opaque, with moveable objects such as vehicle 750 shown on top of all overlays, a significant reduction in simulation sickness was observed. It was found that even individuals very sensitive to simulation sickness could accept the image in the context of a driving simulation. Further, individuals not notified of the Mitigation methods before their drive have failed to notice its operation on drives as long as 45 minutes. Upon asking these drivers about the Mitigation, comments like, “wow, I didn't even notice that” have been received.

In addition to utility with purely simulated environments, the mitigation technology is useful to alleviate related discomforts experienced by operators of remote vehicles. The wide-field images from remotely operated vehicles cause a similar discomfort that can be debilitating. When an image is captured from the perspective of a remote vehicle driving a road, it manifests on an operator display(s) as shown by the components of the image in FIG. 7I. All of the Mitigation components of FIG. 7M are applied to the video image from the remote vehicle. The majority of the features of the image from the remote vehicle remain in relative position to one another. That is, for example, the houses 768 and 770 maintain their position and orientation relative to the road edges 760 and 762 respectively. By analyzing the frame to frame video stream, the moving vehicle 750 is detected and separated from the relatively co-located features in the video image. Once separated the features like 750 are displayed in a more saturated manner to facilitate detection by the operator's peripheral vision. This serves the dual purpose of image caused sickness mitigation and highlighting the objects moving in the scene as observed by the remote vehicle.

### FIG. 8

### Description of FIG. 8

FIG. 8 illustrates a method for generation and introduction into the graphics stream of a Sickness Mitigation Object (SMO) that is not graphics engine specific. Various graphics engines that are fitted with various graphics adaptors from nVidia or ATI or others that have various memory and computation capabilities could have the World and Object databases configured differently than shown in FIG. 8. The figure shows the general use of World and Motion objects. Several aspects of the SMO are controlled dynamically by other process with inputs from FIGS. 9 and 10.

### Operation of FIG. 8

A method for generating the virtual image with simulation sickness mitigation depicted in FIG. 7 is detailed in this section.

The specific methods used to create images of three-dimensional 3D) environments depend on the specific graphic engine used. Open Scene Graph, Direct X, and Unity are a few examples of graphics engines or image generators (IG's) as they are often called. The DGS Simulation Terminal application currently uses Direct X for image generation. This description is written at the level above the specific IG details and the practitioner building the IG will need to apply the standard methods of their specific IG to add the SMO to their system.

Creation and display of the SMO in the 3D environment begins at a Terminator 810 Start. When the DGS Simulation Terminal application starts a scenario, the virtual world image generation starts at Terminator 810. Scenarios or driving sessions in the DGS start at different “physical” locations in the virtual driving environment. We have named our environment “SmallTown” and depending on the purpose of the scenario's assessment or training the starting position varies. Thus, an initial position and orientation in the SmallTown virtual driving environment will be delivered by the scenario. A Process 820 Determine Position & Orientation of Viewpoints captures the scenario initial conditions and starts the process of generating the virtual images of the SmallTown roads and other structures. The DGS Simulation Terminal application operates on a series of platforms as noted in FIG. 1 and Process 820 sets the viewpoints for the number of displays needed for the platform being operated. Microsoft Windows environment variables and Display Settings functions are used to control the number of displays. In the Surround DGS Simulation Terminal, three forward looking, three rearward looking, and two control displays are generated by the application. Process 820 sets the position and orientation of each 3D virtual environment view. Additionally, Process 820 updates the position and orientation of the viewpoints depending on the simulation application. In the DGS Simulation Terminal application a Vehicle Dynamics Model (VDM) receives input from a driver operating the steering wheel etc. and guides the simulated vehicle through the SmallTown environment. As a result, the position and orientation of the viewpoints change. Process 820 communicates the resulting position and orientation of the viewpoints and their details to a Process 836 World Objects Rendered to Frame Buffer. Process 836 also communicates with an object database that defines the objects and also defines the location of the objects in the SmallTown environment. An Internal Storage 830 Database of World & Motion Object Definitions contains both the 3D object definitions and the 3D World definitions. Both fixed objects and motion objects are included in Internal Storage 830. Process 836 uses the definitions of objects and their location and orientation from Internal Storage 830 plus the location and orientation of viewpoints from Process 820 to render the virtual images to a Frame Buffer of all the objects that may potentially be screened by the SMO. Certain motion objects that will not be screened by the SMO are rendered to the frame buffer after the SMO. A Process 860 Motion Objects Rendered to Frame Buffer over SMO and World Objects renders the selected motion objects to the frame buffer after the SMO and other World or motion objects have been rendered. After Process 836 completes rendering objects to the frame buffer that will be screened by the SMO a Process 888 Sickness Mitigation Object Translated, Rotated, Scaled Rendered to Frame Buffer over World Objects operates. Process 888 accepts input about the definition of the SMO from two processes. A Connector 840 Dynamic Definition of Sickness Mitigation Object from FIG. 9 supplies the initial conditions of SMO usage and the scenario or dynamics or operator based control of the SMO object. Additional details of these inputs will be discussed following.

A Connector 850 Current Position and Orientation of Sickness Mitigation Object from FIG. 10 provides information about the head position of the driver/operator. This information is used in two modes. When the display and driver are stationary, as in the Simulation Terminals shown in FIG. 1, head orientation or face regard information can be used to move the center of the SMO to follow the area of interest. Thus, as the Kinect sensor 744 face mask software or AHRS 740 or other sensor determine, for example, the driver is rotating their head to the right, the structures of the SMO, central mitigation overlay 784, transition mitigation overlay 782, outside mitigation overlay 780, and their boundaries 786, and 788 will also rotate to the right. This allows the driver/etc. to see details with a lower motion de-saturation (less mitigation screen) by moving their head in the direction they wish to gaze. The preferred embodiment operates with or without moving the SMO. Many driving assessment and training applications provide good side visibility by dynamically increasing the transparency of the mitigation screen 780 etc. when the vehicle is stopped or close to stopped. For applications that require high contrast detail meaning highly saturated motion detail at high angles beyond the central mitigation overlay boundary 786, rotating the mitigation structure is appropriate and accommodated by the sensors as input through Connector 850. A second mode using the tracking information from Connector 850 is when the display is attached to the driver's head as in the case of head mounted displays. The least provocative dynamic spatial image as far as simulation sickness is concerned is when the fewest objects (pixels or spatial area) are moving, meaning when more of the photons from the image are constant and do not depict a moving image. So as with the first mode of operation (display and driver stationary) holding the SMO stationary relative to the physical room provides the highest most effective sickness reduction. This method (using head tracking to spatially fix the SMO to the actual physical environment of the observer) is appropriate for operator station applications that have a relatively fixed direction of regard for normal operation. Driving and flying a vehicle fit this requirement. Other operations may need to move the SMO with head motion some of the time to all of the time to best fit the application.

The original SMO was a semi-transparent half cylinder with a central hole that allowed the center of the SmallTown image to be unaffected by the object. The preferred embodiment uses a parametrically generated SMO that allows the edges of the center hole to be softened and feathered over a range of degrees before reaching the full obscuration of the SMO screen. After the SmallTown image of World Objects has been constructed with the SMO alpha blended to the frame buffer, Process 888 passes to Process 860 for the addition of the Motion Objects that will not be screened by the SMO as noted above. The alpha blending process mixes the color of a pixel from the SMO object and the SmallTown image and effectively reduces the motion saturation of the dynamic 3D image. The screening affects depicted in FIG. 7 are thus accomplished. Vehicle 750 is not screened by the SMO but the two houses may or may not be depending on the view. In the preferred embodiment, the screening affects of the SMO are not held constant. Dynamically, the transparency of the SMO is increased when a driver pulls to a stop. When the driver starts traveling again the SMO transparency decreases. This allows a “clear” view of the SmallTown environment at stop and look and other decision points like stop signs or when turning into cross-traffic at a traffic light. Some test drivers using the SMO have driven a complete scenario without noticing the mitigation was operational. After Process 870 has completed the adding the motion objects to the frame buffer, the frame buffer is ready to be displayed. A Display 890 Display Frame Buffer as Optical Image can take various forms in the DGS but the Surround DGS Simulation Terminal drives three projectors with forward and embedded rearview images plus additional control displays as depicted in FIG. 7. Process 870 also communicates with a Delay 880 After 1/60^{th} or 1/120^{th} sec trigger new frame buffer build to create the nest image by returning to Process 820 and building another image.

Panoramic video streams from remote vehicles displayed on surround screens are also highly effective at inducing simulation sickness. Operators can benefit from the SMO applied to the screens. In this case the output of Process 836 would switch from the virtual world to the remote video world. The SMO is either fixed direction or tracks the operator's head and is dynamic in screen density dependant on the vehicle motion as in the virtual world use. Security video motion isolation technology isolates components of the video stream highlight by displaying on top of or in cutouts of the screen.

### FIG. 9

### Detailed Description of Drawing

FIG. 9 represents a process to initialize the “appearance” or the way the SMO manifests and how the SMO is dynamically controlled by the dynamics of the simulation and other real-time inputs.

### Detailed Operation

As the DGS Simulation Terminal's graphics application starts up, a Terminator 910 Start is run during initiation. An I/O 920 SMO Overlay Initial Definition reads the initial control and definition information regarding the application and conditions for use of the mitigation parameters including the SMO initial conditions from a File 930 Overlay Initial Conditions. I/O 920 passes the information to a Process 940 SMO Overlay Dynamic Definition. Process 940 assembles a control instruction consisting of the initial conditions of the SMO and other mitigation control information such as whether the SMO is guided by a tracking device such as the devices shown in FIG. 10 or whether the SMO screen is homogeneous or of a particular pattern and the like. Process 940 also collects SMO dynamic control information from a Connector 950 From Overlay Dynamic Conditions FIG. 11 and integrates the dynamic information into the SMO control instructions. Process 940 passes the SMO control instructions to the graphics system generating the SMO through a Connector 970 Dynamic Definition of SMO FIG. 8. The preferred embodiment uses gray (fog like) homogeneous screens. A Delay 960 DELAY repeat after frame complete, waits while a frame is being assembled by the image generator and then gathers the new dynamic information for the SMO control instructions and again passes the information on to the graphics system image generator through Connector 970.

### FIG. 10

### Description of FIG. 10

FIG. 10 represents several interface processes for physical orientation and position sensors used to determine the position and orientation of the driver's head. Information from multiple sensors in integrated and sent to the SMO generation Process 888 and also to the general image generation starting at Process 820.

### Operation

In the preferred embodiment, a Microsoft Kinect 744 is connected to a Process 1050 Microsoft Kinect & similar devices that uses Microsoft API's to track the head of the driver/operator. Similarly, an AHRS 740 is connected to a Process 1010 Attitude Heading Reference System to track the head of the driver. Other tracking devices connect to associated processes and communicate the head position and/or orientation of the driver to a Process 1000 SMO Position & Orientation Calculation Calibration & Stream. The other tracking processes are a Process 1020 Polhemus Patriot, a Process 1030 Track IR, and a Process 1040 Observer/Operator selection. The purpose of all of the Processes 1010, 1020, 1030, 1040, and, 1050 is to interface with their appropriate input systems and communicate head position that is then estimated to be the direction of regard of the driver/etc. and communicate with Process 1000. Process 1000 integrates the information of multiple inputs to improve resolution and reduce dropouts (due to light levels for example) and extend ranges of the sensors. Process 1000 then communicates the best estimate of the direction of regard and/or position of regard to the image generation process through a Connector 1060 SMO Position & Orientation to FIG. 8. The position information is used to determine the XYZ of the viewpoint and allows such effects as for example the driver moving his/her head and seeing the A-pillar and mirrors move in position respectively. This function also serves to uncover the objects behind the mirrors or A-pillar.

### FIG. 11

### Description of FIG. 11

FIG. 11 represents the preferred embodiment methods and apparatus used to dynamically control the operation of the SMO. The two SMO control methods 1110 and 1130 on the left side of the diagram are programmatically operated and the two on the right 1120 and 1140 are manually controlled.

### Operation

A Process 1100 Simulation Dynamics Command reads input from manually operated controls and from programmatically derived controls instructions for the control of the SMO overlay. For some systems the amount of screening necessary to reduce simulation sickness varies at different times. For example, in a driving simulation when the driver is stopped at a traffic light or sign the image is relatively stationary and the image is less provocative of simulation sickness. This is also a time when wide angle viewing of the roadway is important; when deciding when to make a turn especially a left turn into cross-traffic from a stop sign. For these reasons the DGS increases the transparency of the SMO to 100% transparent over a short period of time (approximately 0.5 sec.) when the vehicle stops. This allows the driver unmitigated view of the complete surround image and as a result approximately 200 degrees of a fully saturated image of the roadway can be viewed by all drivers while operating the simulation regardless of their susceptibility to simulation sickness. As soon as the vehicle starts moving again, the SMO transparency is reduced over a short period of time to normal operating levels. A process 1110 Vehicle Dynamics Parameters is responsible for passing these SMO transparency commands to a Process 1100 Simulation Dynamics Command. The size of the SMO could also have been modified but that adds a level of movement or visual flow that is contrary to reducing simulation sickness and the preferred embodiment uses only transparency changes. A Process 1130 Scenario Mitigation Parameters allows Scenarios to control any or all of the SMO construction or position and orientation parameters. In Operational Scenarios discussed below, a peripheral vision test needs a wide field of view presented to the driver to properly test their peripheral vision. During the important moments of the test for example, the Peripheral Vision Operational Scenario can increase the transparency of the SMO or open up the Central Boundary 786 etc. to best administer the test. Process 1130 communicates these changes to the SMO through Process 1100. A Process 1120 Run-time dialog system operator control and a Process 1140 Observer/Operator communicate SMO control from FIG. 13 and FIG. 13 respectively. Process 1100 integrates the various SMO commands and passes them to a Connector SMO Overlay Dynamic Conditions to FIG. 9. Generally, if one of the Processes 1110, 1130, 1120 or 1140 wants the SMO in a high transparency state, that is the command sent to Process 1150 and to FIG. 9.

### FIG. 12

### Description of Drawing

FIG. 12 is an illustration of a SMO dialog to control the application of mitigation. The adaptation scale of the dialog works in concert with the Mitigation Control of FIG. 13 to control the transparency, central degrees, and transition blend region. When the Mitigation Control if fully clockwise, the SMO is completely transparent and does not affect (cannot be seen in) the simulated image. At the opposite extreme or fully counter-clockwise, the SMO de-saturates much of the 200 degree FOV Surround DGS Simulation Terminal to reduce the sickness inducing affects to be similar to that of watching television. The desired operating point of the SMO object depends on the application of the DGS scenario. If the scenario is an assessment that needs to be acceptable to a very broad (95% of the population) set of users, the SMO will need to restrict the FOV of the central area to range around 25 degrees with transition region of about 10 degrees and a low approximately 15% transparency. If the scenario is used for training purposes with a user that has a known tolerance to simulation sickness, the DGS operator may “open up” the SMO to a level that can be accepted by the operator or driver. The controls to facilitate this type of interaction with the SMO operation and the DGS operator or driver are shown in FIG. 12.

### Detailed Operation

SMO Dialog 1200 controls “static” parameters of the object. Mitigation Switch 1210 turns the SMO on and off. A Use Adaptation Scale 1222 switch activates or deactivates the Adaptation Scale 1240 slider

Top of the cloud gray as opposed to the bottom of the cloud gray

### FIG. 13

### Description of Drawing

FIG. 13 represents a manual control and the labeling associated with that control as designed for use by the operator, observer, or driver of the DGS. The pointer of the control references a point on the dial at which the vast majority of the public has an ability to accept dynamic spatial images. It points to the upper range of the safe viewing zone for sensitive people in most of the population. Somewhere between the back and middle seats of a movie theater a portion of the public is uncomfortable with moving spatial images and are self-selecting for lower motion saturation of their visual system.

### Detailed Operation

For many training and some assessment applications of the DGS the exact same presentation of the virtual world from user to user is not required. In this case, an educated user or driver or the test giver could reduce the mitigation relative to the ability of the DGS user to tolerate dynamic surround virtual images. A Mitigation Control 1300 allows the DGS user to set the amount of reduction of motion saturation that the DGS surround image delivers to the person's visual system on a scale linked to real world experiences. The idea is to allow the user to operate the DGS at a point that is comfortable to them. If a person has no problem with simulation sickness or motion sickness symptoms in the front row of an action movie (with their eyes wide open) then, they likely need little occlusion by the SMO for comfort. They could expect to operate the DGS with a Rotating Selector 1310 of the Mitigation Control pointed to the Movies Front 1305 position. On the other hand, if a person has difficulty with action movies in theaters unless sitting in the back, their dial position will be closer to position of the Selector 1310 shown in FIG. 13. Rotating the Selector 1310 from the position shown in FIG. 13 to the Movies Front 1305 position adjusts the 1) transparency from 75% opaque to 50% opaque, 2) Central Boundary 786 central image degrees from 40 degrees to 60 degrees, 3) blend degrees from 10 degrees to 20 degrees, and the color of the transparency constant at a semi-bright gray. For the balance of the clockwise rotation of Selector 1310, the openings in the SMO remains constant and the transparency will reduce from 50% opaque to 0% opaque or fully transparent. Below or counter-clockwise from the Movies Back Selector 1310 position, the central image bounded by Central Boundary 786 reduces from 40% to 10%

The operation of the Mitigation Control 1300 is fundamentally the same for head mounted displays but with modified central and transition FOV angles because of the increased ability of these display systems to induce simulation sickness.

### Section Three

### Detailed Description—Scenarios—Outcome Variables—Anlaysis & Reports

### FIG. 14—Scenarios—Definition and Outcome Variables

### Description of the Drawing

FIG. 14 depicts the sequential composition of Scenarios. A Scenario is composed of driving or flying through either a fixed course or along a path chosen by the driver or pilot through a city or airspace of his choosing wherein at lease one Event occurs along the fixed course or path to which the driver or pilot must react. A Scenario may contain Event 1 through Event n+1. Events may contain Elements.

### Detailed Description of Operation

The make up of a Scenario is shown by 1400 Scenario Composition in FIG. 14. A Scenario Name 1410 names a serial collection of Events such as and Event 1 1420 through the end Event which in this figure is Event n+1 1440. Events may be made of various Elements such as Element 1450 and Element 1452.

The DGS uses a series of Operational and Tactical Scenarios to assess and train driving.

### Operational Scenarios

Vision, Motor, Cognitive and Executive Functioning Scenarios are known as “Operational Scenarios” These assess certain abilities of the driver: Vision Scenarios test the physical visual system; Motor Scenarios test physical motor abilities such as arm and hand, and foot and leg coordination; Cognitive Scenarios test cognition abilities such as attention and decision making; and Executive Functioning Scenarios test executive functions such as working memory, problem solving, task switching and mental flexibility.

Operational Scenarios are based on “trials”—individual tests within the scenario. Each trial is repeated to determine the driver's best score. Once the best score is determined, the Scenario ends.

### Specific Operational Scenario Instructions

Each Scenario has specific instructions that are given by an automated audio avatar and by the Research Assistant. Details follow for each Scenario.

### Vision

### Static Visual Acuity

The goal of the test is to determine the Driver's visual acuity by testing with an electronic sign that will present a group of three letters at smaller and smaller sizes. If the Driver can read 2 of the 3 letters correctly in their appropriate order, another pairing will be presented at a smaller size. If the Driver cannot read 2 of the 3 letters a different pairing will be tried at this size. If they fail once more, the last image size they could read successfully is logged as their visual acuity.

### Contrast Sensitivity

The goal of the Contrast Sensitivity test is to determine the Driver's contrast sensitivity by testing with an electronic sign that will present a group of three letters that will become progressively brighter shades of gray on a white background. If the Driver can read 2 of the 3 letters correctly in their appropriate order, another pairing will be presented at the next level of difficulty. If the Driver cannot read 2 of the 3 letters a different pairing will be presented. If they fail once more, the last image contrast value they could read successfully is logged as their contrast sensitivity

### Dynamic Vision

The goal of the test is to assess the Driver's dynamic vision by testing with an electronic sign that will present a group of three scrolling letters at a progressively faster rate. If the Driver can read 2 of the 3 letters correctly in their appropriate order, another pairing will be presented at the next level of difficulty. If the Driver cannot read 2 of the 3 letters, a different pairing will be tried at the same speed. If they fail once more, the last scrolling speed they could read successfully is logged as their dynamic vision value.

### Information Processing Speed

The goal of the test is to assess the Driver's visual information processing speed by testing with an electronic sign that will flash two letters for progressively shorter durations of time. Signs are spaced along the Operational Test road every 300 ft so that the Driver arrives at a sign every 6 seconds traveling 35 MPH. If a Driver can read the letters correctly another set of letters will be presented at the next level of difficulty. If the Driver cannot read the letters a different letter set will be displayed on the next sign for the same duration. If they fail once more, the last duration they could read successfully is logged as their visual information processing speed

### Peripheral Vision

The goal of the test is to determine the Driver's peripheral vision by directing the Driver's visual attention forward with one task and determining when they perceive another car in their peripheral vision. The operator will click a button on the DGS Operator Panel, or press a cursor key, to log the Driver's response. This must occur within three seconds of the brakes first being illuminated or the car penetrating to the furthest determined distance for it to be logged as a “hit”. If the Driver does not indicate that they saw at least 2 of the 3 cars per side and degree of penetration, they do not pass for that trial. A score for this test will show the furthest a Driver can see on either side, and their total combined field of view. There will be a total of 27 trials. The Driver will tap the brake when they see the brake lights ahead.

### Motor

### Foot/Leg Coordination

The goal of the test is to measure the ability of the Driver to brake in response to brake lights. This will be measured at speeds of up to 35 mph and coming to a stop. For a Driver to be successful they will have to be able to apply adequate leg pressure and make coordinated movements between the two foot pedals.

### Arm/Hand

The goal of the test is to measure the ability of the Driver to avoid objects in the road, potholes in this case. Potholes will be placed at certain places on the road. During the test, the Driver must align his car behind the lead car with the aid of a red vertical alignment bar The Driver must avoid the pothole and then realign his car behind the lead car. The car will be traveling at a controlled speed so these potholes are reached at a set cadence. If the Driver does not steer to avoid a pothole they will feel some motion in the steering and hear a pothole sound effect.

### Cognitive

### Divided Attention

This test is roughly modeled after the Useful Field of view test for assessing divided attention. The Driver will need to attend to a signal ahead of them, while monitoring for the presence of secondary signals in their peripheral field of view. This will be measured at a speed of 35 mph. This presentation will occur at shorter and shorter intervals similar to the Visual Information Processing Speed Test.

### Divided/Selective Attention

This test is in all ways similar to test 1, with the addition of “distracter” signs.

Follow the instructions for the ‘Divided Attention’ scenario above. The voice instructions are slightly modified to account for the additional ‘distracter signs’. During actual trials, only one car will appear as in the above scenario, but signs will display in the empty car positions (positions A thru G).

### Hazard Detection

The Driver will be exposed to three different types of cars, all of which look exactly the same. Cars on the left side will be stopped in the median and cars on the right side will be stopped up on the curb.

### Executive Functioning

### Dual Processing

The goal of the test is to measure the ability of the Driver's dual processing ability. They will be instructed to depress the brake in response to a lead car's brake lights and steer away from behind both gray and black potholes. The Driver will have control of steering and will be guided by an alignment bar.

### Response Inhibition

The goal of the test is to measure the ability of the Driver to avoid objects in the road, black potholes in this case. Black and gray potholes will be placed at certain places on the Operational Test Road. The car will be traveling at a controlled speed so these potholes are reached at a set cadence. If the Driver does not steer to avoid a black pothole they will feel some motion in the steering and hear a pothole sound effect.

The Driver will follow a car which drives over potholes and its brake lights will periodically illuminate for either a long or a short period. Gray potholes are filled and are safe to drive over. However, the Driver must steer around from the black potholes. Whenever the lead car's brake lights illuminate they must remove their foot from the accelerator. However, unlike previous test, the Driver should only press the brake pedal if the lead car's brake lights stay on for a long time and the lead car starts to slow down.

### Working Memory

The goal of the test is to measure the ability of the Driver's memory when recalling road signs. They will be instructed to maintain the accelerator to avoid tones, depress the brake in response to a lead car's long brake lights and steer away from behind black potholes. The Driver is also instructed to not avoid filled (gray) potholes and not depress the brake on short brake lights. The Driver will have control of Steering and will be guided by an alignment bar. At the end of each trial the Driver must recall the signs in order by moving the steering wheel to the sign and depressing the accelerator.

### Operational Outcome Variables Per Scenario

### Definitions

Scenario: A series of trials to assess the capabilities of a Driver in certain characteristics of driving a motor vehicle. Also known as a “Test”.

Trial: Operational Scenarios are composed of a series of Trials. Depending on the scenario, each trial is usually more difficult than the last.

### Vision Scenarios

Static Acuity: The goal of the test is to determine the Driver's visual acuity by testing with an electronic sign that will present a group of three letters at smaller and smaller sizes. If the Driver can read 2 of the 3 letters correctly in their appropriate order, another pairing will be presented at a smaller size. If the Driver cannot read 2 of the 3 letters a different pairing will be tried at this size. If they fail once more, the last image size they could read successfully is logged as their visual acuity. This test is modeled after the Snellen eye-chart.

| Outcome Variable | Definition |
|---|---|
| Visual Acuity | Records the best reading score. |

Contrast Sensitivity: The goal of the Contrast Sensitivity test is to determine the Driver's contrast sensitivity by testing with an electronic sign that will present a group of three letters that will become progressively brighter shades of gray on a white background. If the Driver can read 2 of the 3 letters correctly in their appropriate order, another pairing will be presented at the next level of difficulty. If the Driver cannot read 2 of the 3 letters a different pairing will be presented. If they fail once more, the last image contrast value they could read successfully is logged as their contrast sensitivity. Modeled after the Pelli-Robson test, where the contrast is decreased by a factor of 0.707 for successive trials

| Outcome Variable | Definition |
|---|---|
| Contrast Ratio | The final score is the last contrast ratio |
| | correctly reported twice. |

Dynamic Vision: The goal of the test is to assess the Driver's dynamic vision by testing with an electronic sign that will present a group of three scrolling letters at a progressively faster rate. If the Driver can read 2 of the 3 letters correctly in their appropriate order, another pairing will be presented at the next level of difficulty. If the Driver cannot read 2 of the 3 letters, a different pairing will be tried at the same speed. If they fail once more, the last scrolling speed they could read successfully is logged as their dynamic vision value.

| Outcome Variable | Definition |
|---|---|
| Scrolling Speed | Last scrolling speed they could |
| | read successfully twice. |

Information Processing Speed: The goal of the test is to assess the Driver's visual information processing speed by testing with an electronic sign that will flash two letters for progressively shorter durations of time. Signs are spaced along the Operational Test road every 300 ft so that the Driver arrives at a sign every 6 seconds traveling 35 MPH. If a Driver can read the letters correctly another set of letters will be presented at the next level of difficulty. If the Driver cannot read the letters a different letter set will be displayed on the next sign for the same duration. If they fail once more, the last duration they could read successfully is logged as their visual information processing speed. This test is modeled after the UFOV Central Information Processing Speed Test.

| Outcome Variable | Definition |
|---|---|
| Shortest Duration | The final score is the last speed |
| | correctly reported twice. |

Peripheral: The goal of the test is to determine the Driver's peripheral vision by directing the Driver's visual attention forward with one task and determining when they perceive another car in their peripheral vision. If the Driver does not indicate that they saw at least 2 of the 3 cars per side and degree of penetration, they do not pass for that trial. A score for this test will show the furthest a Driver can see on either side, and their total combined field of view. There will be a total of 27 trials. The Driver must tap the brake when they see the brake lights ahead to keep them looking forward.

| Outcome Variable | Definition |
|---|---|
| Left | Widest angle when cars are on Left side |
| Right | Widest angle when cars are on Right side |
| Both | Widest angle when cars are on Both sides |

### Motor Scenarios

Foot/Leg: The goal of the test is to measure the ability of the Driver to brake in response to brake lights. This will be measured at speeds of up to 35 mph and coming to a stop. For a Driver to be successful they will have to be able to apply adequate leg pressure and make coordinated movements between the two foot pedals. No steering inputs will be used in this scenario. The Driver's car will travel straight down the middle lane.

| Outcome Variable | Definition |
|---|---|
| Average Short Duration: | The time between the lead car brake lights illuminating for a Short |
| Detection Time | period of time and when the Driver removes their foot from the |
| | accelerator |
| Average Short Duration: | The time between the Driver removes their foot from the |
| Movement Time | accelerator and presses the brake for Short Duration of lead car |
| | brake lights |
| Average Short Duration: Total | Detection Time + Movement Time for Short Duration of lead car |
| Reaction Time | brake lights |
| Average Long Duration Slow: | The time between the lead car brake lights illuminating for a Long |
| Detection Time | period of time and when the Driver removes their foot from the |
| | accelerator |
| Average Long Duration Slow: | The time between the Driver removes their foot from the |
| Movement Time | accelerator and presses the brake for lead car brake lights on for a |
| | long period of time |
| Average Long Duration Slow: | Detection Time + Movement Time for Long Duration Slow for |
| Total Reaction Time | lead car brake lights on for a long period of time |

Hand/Arm: The goal of the test is to measure the ability of the Driver to avoid all objects in the road, potholes in this case. They will be both filled (gray) and open (black) potholes. Potholes will be placed at certain places on the road. During the test, the Driver must align his car behind the lead car with the aid of a vertical alignment bar The Driver must avoid the pothole and then realign his car behind the lead car. The car will be traveling at a controlled speed so these potholes are reached at a set cadence. If the Driver does not steer to avoid a pothole they will feel some motion in the steering and hear a pothole sound effect.

| Outcome Variable | Definition |
|---|---|
| Average Reaction Time - | The length of time between the appearance of a pothole and when |
| Combined | the Driver turns the steering wheel. |
| Average Reaction Time - Left | The length of time between the appearance of a pothole on the left |
| | and when the Driver turns the steering wheel. |
| Average Reaction Time - Right | The length of time between the appearance of a pothole on the right |
| | and when the Driver turns the steering wheel. |
| Steering Confusion - Both | Steering Confusion Left + Steering Confusion Right |
| Steering Confusion - Left | The number of times a Driver initially steers in the direction a |
| | pothole on the right. |
| Steering Confusion - Right | The number of times a Driver initially steers in the direction a |
| | pothole on the right. |
| Steering Control: Lane Incursion | Number of times Driver steered to avoid a pothole and went into an |
| Count - Both | adjacent lane |
| Steering Control: Lane Incursion | Number of times Driver steered to avoid a pothole and went into |
| Count - Left | the adjacent lane to the left |
| Steering Control: Lane Incursion | Number of times Driver steered to avoid a pothole and went into |
| Count - Right | the adjacent lane to the right |
| Steering Control: Lane | Average of how far Driver went into the adjacent lane in square |
| Incursion. | feet. Formula: When the Driver is outside the center lane, the |
| | outside of his car traces a curve in the adjacent lane. The |
| | intersection of this curve with the center lane boundary forms a |
| | closed region. Multiple regions outside the center lane are summed. |
| Steering Control: Pothole | The smoothness of steering during maneuver. All steering values |
| Avoidance Steering Average. | are in the range −1.0 to 1.0. A steering value of 0 means the |
| | steering wheel is in the straight-ahead position. A steering value of |
| | 1.0 means the steering wheel is at full lock to the right. “Sum the |
| | \|delta\| from nominal (of steering position just before appearance) |
| | for the 100 ms after pot hole appearance with the \|delta\| for each |
| | 100 ms period thereafter until adjacent with the pothole and divide |
| | by the total number of periods” |
| Ineffectual Turning | The number of times the Driver turns their wheel attempting to |
| | avoid a pothole but still hits it. |
| Inattenion/Misses | The number of times the Driver does not make an attempt to avoid |
| | but still hits a pothole. |

### Cognitive Scenarios

Divided Attention: This test is roughly modeled after the Useful Field of view test for assessing divided attention. The Driver will need to attend to a signal ahead of them, while monitoring for the presence of secondary signals in their peripheral field of view. This will be measured at a speed of 35 mph. This presentation will occur at shorter and shorter intervals similar to the Visual Information Processing Speed Test. The final score is the shortest interval of displaying the signals where the driver was correct for two times in a row.

| Outcome Variable | Definition |
|---|---|
| Absolute Processing Speed | Shortest duration that Driver could recognize the direction of the |
| | Truck and the location of the Barrel, according to the pass/fail |
| | criteria |
| Relative Processing Speed | Difference between the score received for Visual Information |
| | Processing Speed and the absolute processing speed of this test |
| 1st Consecutive Error | Whether the Error occurred in the Central (Truck), Peripheral |
| | (Barrel) or Both |
| 2nd Consecutive Error | Whether the Error occurred in the Central (Truck), Peripheral |
| | (Barrel) or Both |
| Barrel Position of 1st Error | Laterality of Errors: The position of the additional barrel that was |
| | missed of the first error, if any |
| Barrel Position of 2nd Error | Laterality of Errors: the position of the additional barrel that was |
| | missed of the second error, if any |

Divided/Selective Attention: This test is in all ways similar to Divided Attention, with the addition of “distracter” signs. The distracter signs are meant to distract the Driver from viewing the secondary signals in their peripheral field of view by filling the Driver's field of view with clutter.

### Uses:

### Cognitive Divided Attention Outcome Variables

Hazard Detection: The Driver will be exposed to three different types of cars: Hazardous, Non-Hazardous and Stationary. All cars look exactly the same. Cars on the left side will be stopped in the median and cars on the right side will be stopped up on the curb. Some cars will move out and be far enough away that there will be no possible collision with the Driver's car. Some cars will move slightly and then stop. Some cars will move in front of the Driver's car and the Driver must avoid collision.

| Outcome Variable | Definition |
|---|---|
| Average Detection Time | Combined Average time between the movement of the Hazard Car |
| | and when the Driver begins to remove their foot from the |
| | accelerator |
| Average Detection Time - | Time between the movement of the Hazard car on the left, and the |
| Hazard car on Left | Driver removing foot from accelerator |
| Average Detection Time - | Time between the movement of the Hazard car on the right, and the |
| Hazard car on Right | Driver removing foot from accelerator |
| Average Movement Time | Combined Average time it takes the Driver to remove foot from the |
| | accelerator and place it on the brake |
| Average Movement Time - | Time between the movement of the Driver's foot from the |
| Hazard car on Left | accelerator to the brake for the Hazard car on the left |
| Average Movement Time - | Time between the movement of the Driver's foot from the |
| Hazard car on Right | accelerator to the brake for the Hazard car on the right |
| Average Total Reaction Time | Sum of Average Detection time and Average Movement time |
| Average Total Reaction Time - | Sum of Average Detection time and Average Movement time of |
| Hazard car on Left | Hazard car on left |
| Average Total Reaction Time - | Sum of Average Detection time and Average Movement time of |
| Hazard car on Right | Hazard car on right |
| Response Inhibition/Impulsivity | Number of times the Driver removed their foot from the accelerator |
| | and braked in response to non-hazardous or stationary vehicles |
| Response Inhibition/Impulsivity - | The number of times the Driver removed foot from the accelerator |
| When Hazard car is on the Left | and braked in response to non-hazardous or stationary vehicles that |
| | is located on the left. (NOTE: Removing their foot from the gas |
| | but not braking should is counted.) |
| Response Inhibition/Impulsivity - | The number of times the Driver removed foot from the accelerator |
| When Hazard car is on the | and braked in response to non-hazardous or stationary vehicles that |
| Right | is located on the right. (NOTE: Removing their foot from the gas |
| | but not braking should is counted.) |

### Executive Functioning Scenarios

Dual Processing: The goal of the test is to measure the ability of the Driver's dual processing ability. They will be instructed to depress the brake in response to a lead car's brake lights and steer away from behind both gray and black potholes. Driver will have control of Steering and must align the alignment bar on the lead car's license plate. This confirms that the driver will stay directly behind the lead car.

### Uses:

### Motor Foot/Leg Outcome Variables

### Motor Hand/Arm Outcome Variables

Response Inhibition: The Driver will follow a car which drives over potholes and its brake lights will periodically illuminate for either a long or a short period. Gray potholes are filled and are safe to drive over. However, the Driver must steer around from the black potholes. Whenever the lead car's brake lights illuminate they must remove their foot from the accelerator. However, unlike previous test, the Driver should only press the brake pedal if the lead car's brake lights stay on for a long time and the lead car starts to slow down that would result in a collision.

### Uses:

### Motor Foot/Leg Outcome Variables

### Motor Hand/Arm Outcome Variables

Working Memory: The goal of the test is to measure the ability of the Driver's memory when recalling road signs. They will be instructed to maintain the accelerator to avoid tones, depress the brake in response to a lead car's long brake lights and steer away from behind black potholes. The Driver is also instructed to not avoid filled (gray) potholes and not depress the brake on short brake lights. The Driver will have control of Steering and will be guided by an alignment bar. At the end of each trial the Driver must recall the signs in order by moving the steering wheel to the sign and depressing the accelerator to select the appropriate sign.

### Uses:

### Motor Foot/Leg Outcome Variables

### Motor Hand/Arm Outcome Variables

plus:

| Outcome Variable | Definition |
|---|---|
| Signs | Number of Signs Recalled, in order, out of 18 |

### Tactical Scenarios

### Tactical A

Tactical Scenarios are tests that are much like a DMV road test, but with obstacles and driving requirements that cannot often be accomplished on public streets with a real automobile. Tactical Scenarios assess how well the driver is aware of surroundings, the skills of merging into traffic, how well they follow rules of the road and road laws. The scenario also captures how they operate the vehicle such as: braking and steering skills, if they follow too closely to the car in front, how they stay centered in their own lane, how they pass a vehicle, etc.

While the driver is being assessed with a Tactical Scenario, the driver's current drive is compared to a Composite Normative Drive in real-time as the driver is driving the test. A Composite Normative Drive is the amalgamation of all Normative Drives of this Tactical derived from multiple normative drives.

Each Scenario is scripted to allow the driver to practice a trial so that they can both get a feel for the Scenario and repeat the Scenario instructions if unclear about the procedure. There is no limit to the number of times the driver can review the verbal instructions.

### Autistic Spectrum Disorder

This Scenario is a version of a Tactical Scenario and provides an effective method for drivers with high performing Autism Spectrum Disorder (ASD) to perform a drive on the Tactical Test A Scenario. When they have failed to perform a Scenario requirement, the driver may start the event again. A failure of a Scenario requirement is either incurring a driving violation or a deviation from the Composite Normative Drive (using NPD or .npd data files) within the defined Event area.

Since high performing ASD patient's tend to have problems understanding language in context, a non-threatening voice instruction summarizing the failure and a reassuring suggestion of way(s) to accomplish the event successfully accompanies the scenario repeat.

The Driver's specific driving performance will be compared with previous performances of either a single Normative drive or a Composite Normative Drive. The comparison of the Driver's driving performance with the CND drive will be shown visually upon playback of the event or events when the Driver goes out-of-bounds during the execution of the Scenario.

### Tactical Outcome Variables

The following are the Outcome Variables that are collected and analyzed for all Tactical Scenarios.

### Cognitive

| | |
|---|---|
| Open Road | When car is more than 150 feet from the last or next intersection (on assigned |
| | route) that requires driver to stop. |
| STD Time Active | Standard deviation of all samples of the calculated time between when Active |
| | Condition is met and when it is no longer met |
| Total Time Active | Sum of all periods |
| Stop Sign Hesitation | If car is within stopzone and moving <0.1 mph |
| Average Time Active | Average periods of all calculated time between when the Active Condition is met |
| | and when it is no longer met |
| STD Time Active | Standard deviation of all samples of the calculated time between when Active |
| | Condition is met and when it is no longer met |
| Total Time Active | Sum of all periods |
| Stop Light Hesitation | If light is green and car is within stopzone and moving |
| Average Time Active | Average periods of all calculated time between when the Active Condition is met |
| | and when it is no longer met |
| STD Time Active | Standard deviation of all samples of the calculated time between when Active |
| | Condition is met and when it is no longer met |
| Total Time Active | Sum of all periods |
| Low Speed | When the car is 20 mph below the speed limit in Open Road condition (see above |
| | for Open Road definition) |
| Average Time Active | Average of time between when the Active Condition is met and |
| | when it is no longer met |
| STD Time Active | Standard deviation of all samples of the calculated time between |
| | when Active Condition is met and when it is no longer met |
| Total Time Active | Sum of all periods |
| Missed Stop | Not an Active Condition - this is a violation. When driver drives |
| | through Stop Signs (at >5 mph) or through a Red Light |
| Occurrence | Drive-through-stop/number-of-required-stops |
| Missed Stops | Number of missed stops |
| Total Stops | Total number of Stop lines |
| Missed Turn Resets | Driver went off Scenario path |
| Total Events | Number of times off path |
| Missed Turn Signal for | Turn Signal required to turn onto another street |
| Turn | |
| Total Signals | Number of Turn Signals used |
| # of Turn Events | Number of times a turn signal is needed” |
| Missed Turn Signal for | Turn Signal required for a lane change |
| Lane | |
| Total Signals | Number of Turn Signals used |
| # of Lane Changes | Number of times a turn signal is needed |

### Steering

| | |
|---|---|
| Off Road Resets | Event occurs causing Scenario to reset to a known location |
| Total Events | Total number of Resets |
| Across Midline | When car is in opposing lane. Not active within an intersection, road change or |
| | special circumstances such as when driver is required to pass lead car. (Area |
| | calculated by multiplying the distance into the opposing road by the |
| | approximate distance traveled in 0.1 sec) |
| Avg Mag When Active | Average of area that driver drove in opposing lane |
| Avg Time Active | Average of the calculated time between when the Active Condition is met and |
| | when it is no longer met |
| STD Mag When Active | Standard deviation of sampled areas |
| STD Time Active | Standard deviation of all samples of the calculated time between when Active |
| | Condition is met and when it is no longer met |
| Total Mag When Active | Sum all of the sampled areas |
| Total Time Active | Sum all of the periods |
| Swerving/Lane Position | Active when on a two lane road (one traffic lane in each direction, parking |
| | lanes are not counted). Sampled every 10th of a second. Not active within an |
| | intersection or a road change. (Value is the position of the car: −1.0 to +1.0. |
| | 0.0 = Car in Center of Lane. +1.0 = Center of Car is in right side of lane. −1.0 = |
| | Center of car is in left side of lane)”></a>’, ‘LanePos’, |
| | array(0, 1, 2, 3, 4, 5, 10, 11, 12), |
| Avg Mag When Active | Average of Absolute value of car's sampled lane position |
| Avg Time Active | Average periods of all calculated time between when the Active Condition is |
| | met and when it is no longer met |
| STD Mag When Active | Standard Deviation of absolute value of car's lane position |
| STD Time Active | Standard Deviation of the calculated time between when the Active Condition |
| | is met and when it is no longer met |
| Total Mag When Active | Sum all of the sampled car position magnitudes |
| Total Time Active | Total time Active Condition is met |
| Total Active | Sum all of the sampled car positions”></a></br> |
| Avg Active | Average of car's sampled lane position |
| STD Active | Standard Deviation car\'s lane position |
| Off Road | When one or more tires are off pavement |
| Avg Time Active | Average of time between when Active Condition is met and when it is no |
| | longer met |
| STD Time Active | Standard Deviation of the time between when Active Condition is met and |
| | when it is no longer met |
| Total Time Active | Sum all of the periods |
| Total Events | Total number of times off road |

### Braking

| | |
|---|---|
| Rolling Stop | Not an Active Condition - this is a violation. Rolling Stop Violation is when |
| | min speed within a stop zone is >1 mph and <5 mph. A Valid stop is <=1 mph |
| | within stop zone. |
| Occurrence % | The number of rolling stops/number of Stop Zones |
| # Rolling Stops | Total number of times driver incurred a Rolling stop |
| Total Stop Zones | Total number of stop zones |
| Inappropriate Braking | If car is in Open Road and brake pedal >0.15″>Inappropriate Braking |
| Avg Time Active | Average of time between when Active Condition is met and when it is no |
| | longer met |
| STD Time Active | Standard Deviation of the time between when Active Condition is met and |
| | when it is no longer met |
| Total Time Active | Sum all of the periods |
| Total Events | Total number of discreet periods the driver met Active Condition |
| Deceleration Smoothness | Capture if brake pedal is being pushed more than 0.02 and the absolute delta |
| | from the last pedal position is >0.1 (sampled every tenth of a second)” |
| Avg Mag When Active | Average of brake pedal position |
| Avg Time Active | Average of all calculated time between when Active Condition is met and |
| | when it is no longer met |
| STD Mag When Active | Standard Deviation of brake pedal position |
| STD Time Active | Standard Deviation of the time between when Active Condition is met and |
| | when it is no longer met |
| Total Mag When Active | Sum all of the sampled brake pedal position magnitudes |
| Total Time Active | Sum all of the periods together that meet Active Condition |
| Crash | Capture if the current time is less than 0.5 sec from previous time AND the |
| | car's average acceleration over period is >= (10 * Standard Gravity) |
| Total Events | Total number of times a ‘crash’ occurred. |
| Bump | Capture if the current time is less than 0.5 sec from previous time AND the |
| | car\'s average acceleration over period is >= (3 * Standard Gravity) AND < (10 * |
| | Standard Gravity) |
| Total Events | Total number of times a ‘bump’ occurred. |

### Accelerator/Speed Control

| | |
|---|---|
| Tailgating | Capture the times when the driver is tailgating (if speed >= 15 mph AND |
| | closest car in front <15 ft) Sample every tenth of a second |
| Avg Time Active | Average of time between when the Active Condition is met and when it is no |
| | longer met |
| STD Time Active | Standard Deviation of the time between when the Active Condition is met and |
| | when it is no longer met |
| Total Time Active | Sum all of the periods |
| Speed Limit | Sample of car speed when in 35 MPH, 40, or 45 MPH zones when in open |
| | road (see above for Open Road Active Condition). Note assumption: absolute |
| | values are used of how close driver is to the speed limit |
| Avg Mag When Active | Average of car speed (every tenth of a second) subtracted from the posted |
| | speed limit |
| Average Time Active | Average periods of all calculated time between when Active Condition is met |
| | and when it is no longer met |
| STD Mag When Active | standard deviation of a sample car speed (every tenth of a second) subtracted |
| | from the posted speed limit” |
| STD Time Active | Standard deviation of all samples of the calculated time between when Active |
| | Condition is met and when it is no longer met |
| Total Mag When Active | Sum all of the sampled car speeds minus the posted speeds |
| Total Time Active | Sum of all periods together |
| High Speed >5 mph | The time when car is 5 mph above the speed limit in open road (see above for |
| | Open Road Active Condition) |
| Avg Time Active | Average of the calculated time between when the Active Condition is met and |
| | when it is no longer met |
| STD Time Active | Standard Deviation of the calculated time between when the Active Condition |
| | is met and when it is no longer met |
| Total Time Active | Sum all of the periods together that meet the Active Condition |
| High Speed >20 mph | The time when car is 20 mph above the speed limit in open road (see above for |
| | Open Road Active Condition) |
| Avg Time Active | Average of the calculated time between when the Active Condition is met and |
| | when it is no longer met” |
| STD Time Active | Standard Deviation of the calculated time between when the Active Condition |
| | is met and when it is no longer met |
| Total Time Active | Sum of all periods |
| Car is Stopped | When car is stopped (when speed <0.5) |
| Avg Time Active | Average time between when the Active Condition is met and when it is no |
| | longer met |
| STD Time Active | Standard Deviation of the calculated time between when the Active Condition |
| | is met and when it is no longer met |
| Total Time Active | Sum all of the periods |
| Accelerator Smoothness | Gas pedal is being pushed >0.02 units (0 to 1 inclusively) and the absolute |
| | value of the change from the last pedal position is greater than 0.1. Sample |
| | every 10th of a sec |
| Avg Mag When Active | The calculated average of sample of pedal position every tenth of a second |
| Average Time Active | Average periods of all calculated time between when Active Condition is met |
| | and when it is no longer met |
| STD Mag When Active | The calculated standard deviation of a sample pedal position every tenth of a |
| | second |
| STD Time Active | Standard deviation of all samples of the calculated time between when Active |
| | Condition is met and when it is no longer met |
| Total Mag When Active | Sum of all sampled pedal position magnitudes” |
| Total Time Active | Sum of all periods |

Example of a driving assessment report.

### Performance Report

| | |
|---|---|
| Patient Name: | Gender: |
| MRN: | Medical condition: |
| DGS Version: | Occupation: |
| Date of evaluation: | Reason for Testing: |
| Age: | Driving experience: |
| Referring agent: | Other drivers in household: |
| Session duration: | CPT code: |

| Test Administered | Normal Limits | Score | z Scores |
|---|---|---|---|
| Working Memory | | | |
| Short Duration Detection | .8436 | 0.673 | 0.8904 |
| Short Duration Movement | .3134 | 0.3178 | −0.0896 |
| Long Duration Detection | .9405 | 0.5225 | 0.8866 |
| Long Duration Movement | .4475 | 0.3775 | 0.4071 |
| Reaction Time (Both) | .9523 | 0.94 | 0.066 |
| Steering Confusion (Both) | .0909 | 0 | 0.233 |
| Lane Incursion Count (Both) | .8788 | 2 | −1.0485 |
| Lane Incursion | 6.0605 | 3.5082 | 0.1491 |
| Ineffectual Turning | .4242 | 0 | 0.664 |
| Inattention/Misses | .3333 | 0 | 0.4473 |
| Signs Recalled | 15.9394 | 18 | −0.6654 |
| Response Inhibition | | | |
| Short Duration Detection | .7506 | 0.55 | 1.0098 |
| Short Duration Movement | .2613 | 0.3725 | −0.4024 |
| Long Duration Detection | .8222 | 0.5675 | 0.5599 |
| Long Duration Movement | .4257 | 0.3425 | 0.5355 |
| Reaction Time (Both) | .8408 | 0.88 | −0.4287 |
| Steering Confusion (Both) | .0606 | 0 | 0.1183 |
| Lane Incursion Count (Both) | .2727 | 0 | 0.4384 |
| Lane Incursion | 3.9733 | 0 | 0.3115 |
| Ineffectual Turning | 1 | 1 | −0.0687 |
| Inattention/Misses | .1515 | 0 | 0.2331 |
| Dual Processing | | | |
| Short Duration Detection | .6624 | 0.5775 | 0.3373 |
| Short Duration Movement | .2543 | 0.405 | −0.9961 |
| Long Duration Detection | .8177 | 0.605 | 0.3121 |
| Long Duration Movement | .2816 | 0.19 | 0.898 |
| Reaction Time (Both) | .7619 | 0.6863 | 0.2878 |
| Steering Confusion (Both) | .1563 | 1 | −1.6741 |
| Lane Incursion Count (Both) | .6563 | 1 | −0.1562 |
| Lane Incursion | 7.2357 | 0.4341 | 0.2429 |
| Ineffectual Turning | 1.5625 | 0 | 0.99 |
| Inattention/Misses | .8125 | 0 | 0.3809 |
| Selective Attention | | | |
| Absolute Processing Speed | 18.9091 | 16 | 0.1933 |
| Divided Attention | | | |
| Absolute Processing Speed | 17.9394 | 16 | 0.2202 |
| Arm-Hand | | | |
| Reaction Time (Both) | .8274 | 0.7717 | 0.0349 |
| Steering Confusion (Both) | .0882 | 0 | 0.3355 |
| Lane Incursion Count (Both) | .6765 | 3 | −1.4992 |
| Lane Incursion | 7.6196 | 32.3651 | −1.4978 |
| Ineffectual Turning | 1.4412 | 1 | 0.2339 |
| Inattention/Misses | .3529 | 0 | 0.3806 |
| Foot-Leg | | | |
| Short Duration Detection | .5797 | 0.45 | 0.6979 |
| Short Duration Movement | .3179 | 0.23 | 0.4866 |
| Long Duration Detection | .6034 | 0.52 | 0.3367 |
| Long Duration Movement | .3384 | 0.284 | 0.3872 |
| Vision Peripheral | | | |
| Left | 70 | 70 | 0.1555 |
| Right | 70 | 70 | 0.2227 |
| Both | 70 | 55 | −3.8568 |
| Information Processing Speed | | | |
| Shortest Duration | 16 | 16 | 0 |
| Vision Dynamic | | | |
| Scrolling Speed | 903.0303 | 700 | −0.3604 |
| Contrast Sensitivity | | | |
| Contrast Ratio | 0.235 | 0.0235 | −0.3994 |
| Acuity | | | |
| Visual Acuity | 20/30 | 30 | 0 |
| Open Road | | | |
| STD Time Active | | 36.0608 | −1.3672 |
| Total Time Active | | 565.583 | −0.8309 |
| Stop Sign Hesitation | | | |
| Average Time Active | | 4.2722 | −0.8674 |
| STD Time Active | | 4.51 | −0.3696 |
| Total Time Active | | 12.8166 | −0.8103 |
| Stop Light Hesitation | | | |
| Average Time Active | | 2.3833 | −0.029 |
| STD Time Active | | 1.8143 | 0.0667 |
| Total Time Active | | 7.15 | 0.0927 |
| Low Speed | | | |
| Average Time Active | | 3.7861 | −0.0606 |
| STD Time Active | | 1.7352 | −0.3243 |
| Total Time Active | | 22.7167 | −0.4605 |
| Missed Stop | | | |
| Occurrence | | 0 | −0.4125 |
| Missed Stops | | 0 | −0.4275 |
| Total Stops | | 7 | 0.7592 |
| Missed Turn Resets | | | |
| Total Events | | 0 | −0.4806 |
| Missed Turn Signal for Turn | | | |
| Total Signals | | 7 | −0.1224 |
| # of Turn Events | | 11 | −0.3127 |
| Missed Turn Signal for Lane | | | |
| Total Signals | | 3 | −0.9801 |
| # of Lane Changes | | 14 | 0.2062 |
| Off-Road Resets | | | |
| Total Events | | 0 | −0.1361 |
| Across Midline | | | |
| Avg Mag When Active | | 0.3358 | −0.549 |
| Avg Time Active | | 0.5583 | −0.5943 |
| STD Mag When Active | | 0.176 | −0.5997 |
| STD Time Active | | 0.075 | −0.8513 |
| Total Mag When Active | | 22.4984 | −0.5515 |
| Total Time Active | | 1.1166 | −0.728 |
| Swerving/Lane Position | | | |
| Avg Mag When Active | | 0.2642 | −0.2438 |
| Avg Time Active | | 44.5711 | 0.1688 |
| STD Mag When Active | | 0.2148 | −0.7065 |
| STD Time Active | | 38.9527 | 0.0094 |
| Total Mag When Active | | 10599.1 | −0.2702 |
| Total Time Active | | 668.567 | −0.2545 |
| Total Active | | 4258.42 | 0.6396 |
| Avg Active | | 0.1062 | 0.7082 |
| STD Active | | 0.3235 | −0.5452 |
| Off Road | | | |
| Avg Time Active | | 4.7667 | 1.8216 |
| STD Time Active | | 0 | −0.2949 |
| Total Time Active | | 4.7667 | 0.7418 |
| Total Events | | 1 | −0.0754 |
| Rolling Stop | | | |
| Occurrence % | | 0 | −0.1458 |
| # Rolling Stops | | 0 | −0.1674 |
| Total Stop zones | | 3 | 0.3012 |
| Inappropriate Braking | | | |
| Avg Time Active | | 0.8333 | 0.1971 |
| STD Time Active | | 0.5 | −0.2681 |
| Total Time Active | | 1.6666 | −0.3738 |
| Total Events | | 2 | −0.3396 |
| Deceleration Smoothness | | | |
| Avg Mag When Active | | 0.4515 | 1.1594 |
| Avg Time Active | | 0.2833 | 3.2449 |
| STD Mag When Active | | 0.2738 | 0.7924 |
| STD Time Active | | 0.1675 | 2.3332 |
| Total Mag When Active | | 7.675 | −0.1812 |
| Total Time Active | | 1.7 | −0.4287 |
| Crash | | | |
| Total Events | | 0 | −0.4738 |
| Bump | | | |
| Total Events | | 0 | −0.6124 |
| Tailgating | | | |
| Avg Time Active | | 0.8267 | −0.2869 |
| STD Time Active | | 0.5711 | 0.1922 |
| Total Time Active | | 5 | 1.1977 |
| Speed Limit | | | |
| Avg Mag When Active | | 10.7886 | −0.5762 |
| Average Time Active | | 107.954 | −0.5891 |
| STD Mag When Active | | 10.5572 | 0.2616 |
| STD Time Active | | 86.0419 | 0.5246 |
| Total Mag When Active | | 279522 | −0.4778 |
| Total Time Active | | 431.817 | −0.4548 |
| High Speed >5 mph | | | |
| Avg Time Active | | 2.7167 | −0.6817 |
| STD Time Active | | 1.7498 | −0.5812 |
| Total Time Active | | 16.2999 | −0.6317 |
| High Speed >20 mph | | | |
| Avg Time Active | | 0 | −0.3422 |
| STD Time Active | | 0 | −0.2615 |
| Total Time Active | | 0 | −0.3351 |
| Car is Stopped | | | |
| Avg Time Active | | 6.45 | −0.8916 |
| STD Time Active | | 6.7013 | −0.4604 |
| Total Time Active | | 51.6002 | −0.7764 |
| Accelerator Smoothness | | | |
| Avg Mag When Active | | 0.3419 | 0.6345 |
| Average Time Active | | 0.1511 | 0.7808 |
| STD Mag When Active | | 0.2344 | 1.3673 |
| STD Time Active | | 0.0783 | 0.9317 |
| Total Mag When Active | | 45.477 | −0.1338 |
| Total Time Active | | 13.3003 | −0.2299 |

### Section Four

Normal Performance Calculation—Variance from Normal—Virtual Driving Instructor Examiner

### FIGS. 15 & 16 Normal Performance Calculation

In the preferred embodiment, Normative Path Data (NPD) is used by the Driver Guidance System (DGS) for several purposes, including measuring the performance of a driver during their actual simulation drive and again after their simulation drive for additional analysis. With reference to FIG. 15 and FIG. 16 the generation of Normative Path Data will be explained. Normative Path Data is basically the average and standard deviation of each of a plurality of Parameters that characterize how a Normative Driver or Normative Pilot controlled his vehicle and how it responded at each of a plurality of sample points along a path in a virtual world. In the preferred embodiment, the path driven and the events that occur such as crash in front of the Normative Driver or Normative Pilot or a car running a stoplight and crossing into the path of the Normative Driver or Normative Pilot, or a pedestrian running suddenly into the roadway, are called a Scenario.

The process of creating the NPD file begins by reading Parameter recorded for a first Normative Driver (or Normative Pilot) to be normalized in the process of FIG. 15. Normalized means each of the Parameters recorded at each of the sample points for all of the Normative Drivers or Normative Pilots are averaged, i.e., the Mean is calculated, and the Standard Deviation for each of the Parameters at each of the sample points is also calculated. That process happens in step 1548 of FIG. 15. To score a Driver Under Test (or Pilot Under Test) who is being evaluated or trained, each of the Driver Under Test's (or Pilot Under Test) Parameters recorded at each of the various sample points in time or sample points in space along the path driven or flown through the virtual world is compared to the Mean and Standard Deviation established at each sample point by the Normative Drivers or Normative Pilots. The Parameters which are normalized for the Normative Drivers and which are compared during scoring of a Driver Under Test include position, steering, throttle, braking, speed, turn signals, distance from the car ahead. Other Parameters are used for the Normative Pilot and the Pilot Under Test such as altitude, airspeed, heading, GPS position, within weapons envelope, selected weapon, distance from bogey, relative kinetic energy state, relative potential energy state, performance parameters of Pilot Under Tests plane according to Energy Maneuverability diagrams for his plane for the current altitude and airspeed conditions, performance parameters for bogey's plane for the current altitude and airspeed conditions, etc. Various factors that are important in dogfighting include the ability to outturn, out-climb, and out-accelerate your opponent. These abilities in turn depend upon the thrust, weight, drag, wing area and other flight characteristics of an aircraft.

Energy-maneuverability theory is a model of aircraft performance. It was developed by Col. John Boyd, and is useful in describing an aircraft's performance as the total of kinetic and potential energies or aircraft specific energy. It relates the thrust, weight, drag, wing area, and other flight characteristics of an aircraft into a quantitative model. This allows combat capabilities of various aircraft or prospective design trade-offs to be predicted and compared.

Specific Excess Energy (PsubS) is:

PsubS=V[(T−D)/W]

### V=Velocity T=Thrust D=Drag W=Weight

Boyd, a U.S. jet fighter pilot in the Korean War, began developing the theory in the early 1960s. He teamed with mathematician Thomas Christie at Eglin Air Force Base to use the base's high-speed computer to compare the performance envelopes of U.S. and Soviet aircraft from the Korean and Vietnam Wars. They completed a three-volume report titled Energy-Maneuverability on their studies in 1966 which is hereby incorporated by reference. It is publicly available at http://www.archives.gov/declassification/iscap/pdf/2011-052-doc1.pdf. Energy Maneuverability came to be accepted within the U.S. Air Force and brought about improvements in the requirements for the F-15 Eagle and later the F-16 Fighting Falcon fighters.

The Parameters that are important in winning dogfights of various types can be derived from Appendix D, the Aerial Attack Study, authored by Col. John Boyd, Revised 11 Aug. 1964. This study gives different types of maneuvers and counter-maneuvers to use in fighter to fighter combat in various situations such as defensive turns, scissors maneuvers, high-speed and low-speed yo yo's, barrel roll attacks, overhead attacks, vertical rolling scissors, high G barrel roll attacks and nose quarter attacks.

### FIG. 15.

A Process 1512 Get Next Normative Drive sequentially retrieves drives from an I/O 1514 Normative Drives. I/O 1514 can be a local database or storage on the cloud. I/O 1514 connects to a managed list of normative drives such as is shown in FIG. 16. A tool for managing Normative Drives is shown in FIG. 16. The display of a table in FIG. 16 shows normative drive files for each of a plurality of trial drivers. Each normative drive files stores the inputs that trial driver made at each point in time for a plurality of points of time which define an interval during which the trial driver was driving the assessment course on a simulator. One of the Normative Drive file names is shown at 1610. A set of control buttons for selecting a drive to be highlighted or to be enabled in the NPD calculation is located under the lead line of 1620. Lead line 1620 actually points to a button which if selected such as being pushed on a touchscreen, clicked with a mouse or spoken as a voice command causes all normative drive files to be selected. The path driven by a particular driver in the Normative Drive 1610 is shown at the lead line of 1630. This particular driver deviated significantly to the right in the intersection area compared to the paths of most other drivers. The specific drives chosen as Normative Drives depend on the purpose of the NPD file and could, for example, be representative of normal drivers, an elite group of drivers, or a group of inexperienced drivers.

In addition to the path information (position on the “Fondas” of FIG. 18) the Normative Drive files include information about speed, throttle position, steering wheel position, brake pedal pressure, turn signal, front wheel angle, and other variables along the entire length of the drive. Thus, NPD files actually contain normalized data for more than just the path. Normalized speed, throttle position etc. are also included. Only the path information is displayed in FIG. 16 but the state of or value of the above identified or other useful assessment or training variables such as airspeed, altitude, angle of attack, attitude, heading, GPS coordinates of the vehicle or aircraft could also be displayed. The basic idea is to assess how a driver or pilot reacts to things observed in his environment. This reaction in any one or more parameters (such as throttle position, braking, etc.) is compared to either: 1) what is deemed a correct reactions from experienced drivers or pilots; or 2) as compared to the mean reaction for each parameter upon which performance is judged calculated from “drives” executed by a plurality of Normative Drivers (or pilots).

Examples of things or events that should be observed by a fighter pilot flying a UAV when dogfighting either a manned or unmanned fighter in a two-circle dogfight may, in some embodiments, include: 1) whether the other pilot is using his thrust vectoring or looks like he is turning harder than is possible using airfoil surfaces alone for his type of plane; 2) whether vapor is condensing on the top of his opponent's wings indicating a hard turn dissipating his kinetic energy rapidly; 3) airspeed readouts for his opponent indicating rapid deceleration (indicating rapid dissipation of kinetic energy) as indicated on the Pilot Under Test's Infrared Search and Track System or side-looking or rear-looking or front-looking radars; 4) his opponents rate of turn indicating the rate of kinetic energy dissipation as shown on the Pilot Under Test's Infrared Search and Track System or side-looking or rear-looking or front-looking radars; 5) potential energy situation as indicated by relative altitude of his opponent versus the altitude of the plane or drone being flown by the Pilot Under Test; 6) the Pilot Under Test's own altitude and airspeed; 7) range to his opponent; 8) whether his opponent is in a range envelope of weapons still available; 9) whether his remaining weapons such as air-to-air missiles can be fired off-boresight or whether the nose of the Pilot Under Test's plane or drone needs to be within a certain angle of pointing at his opponent; 10) whether the Pilot Under Test's fire control radar or Infrared Search and Track System has a lock on his opponent; 11) whether there are any friendly aircraft within the range and azimuth envelope of the weapon selected for release; 12) whether a positive identification of the opponent in accordance with the Rules of Engagement has been made; 13) if the opponent is in the “cone of control” of the pilot under test, whether the opponent is close enough that a high G barrel roll by the Pilot Under Test will cause an overshoot by the opponent and put the Pilot Under Test in the cone of control of the opponent; 14) all other factors deemed important in a dogfight that will dictate the correct defensive or offensive maneuver to make to win or just survive the dogfight. Such other factors are identified in “Fighter Combat: Tactics and Maneuvering” by former Navy Top Gun Pilot Robert L. Shaw and “Fighter Pilot Tactics” by Mike Spick, both of which are hereby incorporated by reference.

All these factors control the selection of the correct maneuver to make by the Pilot Under Test. For example, in a two-circle fight between a Chinese Su-30MK2 Flanker with thrust vectoring and a U.S. F-35, if the Flanker pilot chooses to use his thrust vectoring to turn harder than the F-35 to get in the cone of control of the F-35 and gain the advantage, the Flanker pilot will squander a great deal of his kinetic energy. In that situation, the correct maneuver by the F-35 pilot is probably to go ballistic and fly straight up as soon as he observes vapor on the top of his opponent's wings and rapid deceleration of the Flanker as indicated on the F-35 360 degree Infrared Search and Track System. The Flanker pilot, having squandered much of his kinetic energy will not be able to keep up with the F-35 in the climb and some separation will be achieved. This separation may be enough to take the F-35 out of the weapons envelope of the Flanker, and the F-35 may then take an off-boresight AMRAAM missile or Sidewinder shot or do a rudder reversal and shoot the Flanker in the face during his climb with an air-to-air missile of cannon fire.

Application of the concepts disclosed in this patent application for assessment and training of drivers to a pilot training and assessment scenario can be done. In one embodiment, the assessment and training system would recall and display all the factors the Pilot Under Test should be observing about his own plane's energy and position state and the position and energy state of his opponent and the changes in each which are occurring at each of a set of points in time in the scenario. How a Good Fighter Pilot would react to all these factors in terms of control inputs to his plane are recorded for each point in time in the scenario. These control inputs of a Good Fighter Pilot are recorded for each point in time and serve as the reference against which the actual control inputs of the Pilot Under Test are compared at each point in time. A Pilot Under Test who recognizes the situation faster and reacts faster in his control inputs to the plane than the Good Fighter Pilot gets high scores. A Pilot Under Test who misses factors he should be observing, or who reacts slower than the Good Fighter Pilot gets lower scores. A Pilot Under Test who makes the wrong maneuver for the situation as opposed to the maneuver the Good Fighter Pilot makes in the same situation, gets scored even worse. There are many perhaps hundreds or thousands of different situations in dogfighting which can occur and which can be programmed into different scenarios of the assessment and training system and to which a Pilot Under Test can be subjected. The assessment and training system will also store the control inputs of a Good Fighter Pilot at each point in time in response to each situation to serve as a reference point against which the Pilot Under Test's control inputs are measured. In some situations, there may be more than one correct maneuver to make or the correct maneuver to make depends upon the plane or UAV being flown by the opponent and the plane or UAV being flown by the Pilot Under Test. In fact, the type of plane or drone being flown by the opponent versus the type of plane or drone being flown by the Pilot Under Test is one of the factors that the Pilot Under Test must take into account. This is because each different plane has different thrust-to-weight ratio and wing loading factors which affect turning and acceleration and climb performance. In addition, some planes have thrust vectoring and some do not, and that affects how fast a plane can turn. Also, the range of the weapons and radar or IRST systems of different planes or drones are different. Also, the number and type of weapons are different for different planes or drones. All these things are factors to be taken into account by the Pilot Under Test.

One function of the display is to allow the omission of Normative Drives that fall out of the acceptable tolerance. Removing outliers is a common function of statistical analysis and the ability to find problems with data is an important function. Normative Drive Path 1632 may be one such “outlier” drive that a researcher of other professional would want to remove from a normative pool so as to not skew the normative value for position at that particular time in response to whatever even is active in the situation represented by FIG. 16. Path 1632, as can be seen in FIG. 16, used the sidewalk for a portion of this section of road.

The position and other variables of the driver's vehicle in the Normative Drives data files are not continuous functions but are discrete data points extracted about every sixtieth 1/60 of a second from the DGS when the data was collected. Other shorter or longer intervals can be used in other embodiments. Shorter intervals would typically be used for high speed simulations such as aircraft flying. For the purposes of the NPD files, the data values of the NPD files are converted from a time based storage to position based. In other words, each set of values for the parameters being recorded at each point in time is converted to a set of the same values linked to whatever position on the assessment course corresponds to that time. Stations (typically simulators, computers or laptops “driven” by trial drivers) progressing along a Reference Drive 1520 are used to make this conversion. The “Reference Drive” is a specially recorded path driven along a predetermined route or studied fixed course. A Reference Drive can also be a Reference Flight. A portion of a Reference Drive path is shown by Reference Path Arrows 1656 and 1658. The arrows indicate the path extends the entire length of the Reference Drive that is usually the same as the Normative Drives. The stations along the Reference Drive path are chosen normal to the path at the intersection point of the station. One such station a Reference Normal line is shown by the line between Reference Normal Arrows 1650 and 1652. The Reference Normals can be spaced at various intervals, approximately one and a half meters is used in the current embodiment. The Reference Normals represent a plurality of sample points. The sample points can be determined by any other method also such as establishing a time interval between recordings of Parameters which can be any time interval that gives sufficient sample points to properly evaluate the performance of a Driver Under Test or a Pilot Under Test.

A Process 1522 Create Reference Normals creates the Reference Normals and stores them in Internal Storage 1518 Reference Normals.

A Process 1516 Get Next Reference Normal starts with the first 1518 Reference Normal located at the beginning of the Reference Drive and then steps to the next one as creation of the NPD file progresses. A Test 1542 Last Reference? returns to Process 1516 until the last Reference Normal of the Normative Drive being processed is encountered. Each time the Process 1516 operates, it passes the Reference Normal and the Normative Drive data being processed to a Process 1524 Find Intersection of Drive with Reference Normal. As an example, the point of intersection of Normative Drive Path 1630 with the Reference Normal between arrows 1650 and 1652 is determined by Process 1524. The coordinates along the Normative Drive of the intersection point are passed into the NPD variable Internal Storage 1546 NPD Variables Data. Process 1524 also passes the point of intersection along the Normative Drive to a Process 1526 Determine Value of Next NPD Variable at Intersection. Process 1526 then extracts the next NPD variable at the intersection calculated in Process 1524 and passes the variable to Internal Storage 1546. If the last NPD variable has not been extracted, a Test or Decision 1540 loops back to Process 1526 to collect and store the next NPD variable. When Test 1540 determines all NPD Variables have been collected, a Test 1542 Last Reference Normal? determines if another Reference Normal on the Reference Drive is available to intersect with the Normative Drive and if so loops back to Process 1516. Otherwise, a Test 1544 tests if the last Normative Drive has been processed. If not, the next normative drive is similarly processed starting at Process 1512. For example, after processing Path 1630, Normative Drive Path 1632 may be the next to be processed. When the processing advances to finding the intersection of Path 1632 with the Reference Normal between Arrows 1650 and 1652, the intersection of the path and normal will be calculated and stored. Now the points of intersection with the normal and the value of all the NPD variables at that point have been determined and stored for two of the Normative Drives 1630 and 1632.

When Test 1544 determines the last Normative Drive has been processed, calculation of the normative path, normative speed, and other normative variables begins. That is, after all of the intersection points and other NPD variables for all of the Reference Normals for all of the Normative Drives in the Normative Drive List have been collected and stored in Storage 1546, a Process 1548 Calculate Mean and Standard Deviation for each NPD Variable at each Reference Normal operates. In one embodiment, the Mean is simply an average for each Parameter of the values of that particular parameters recorded for each of the Normative Drivers at each sample point. In other words, for each Parameter, at each sample point or Reference Normal, there will be an average or Mean of that Parameter recorded for each of the Normative Drivers at that sample point or Reference Normal. The Mean is calculated for each Parameter at each sample point or Reference Normal.

When there is only one Normative Driver such as the flight training embodiment wherein a single Good Pilot serves as the Normative Driver, there is no need to calculate the Mean or average. All that is necessary is to record each of the Parameters for the pilots control inputs and how the plane is responding at each of the sample points.

Examples of some of the Parameters are given in FIG. 18. For every point in the drive of the Driver Under Test, his car will have a position and speed that are dictated by his throttle, braking and steering inputs. The position and speed in simulator embodiments are calculated values calculated by a free body modeling process called the based upon the time parameter, the thrott

Whenever a Mean or average is calculated, a Standard Deviation can also be calculated. Process 1548 calculates those Standard Deviations for each Parameter at each sample point or Reference Normal.

A “Reference Normal” is a reference line perpendicular to a path along the course at each meter and a half. In other words, the Reference Normals are spaced 1.5 meters apart along the Reference Drive path driven through the evaluation course. Each of the Reference Normals crosses the Reference Drive path at some point which is deemed the origin or zero. Each of the Normative Drivers will cross that Reference Normal at some point relative to zero or the origin. In other words, at each Reference Normal, each of the Normative Drivers will cross the Reference Normal and define an intersection which has some distance from the origin. For example, assume Normative Drive 1 crosses Reference Normal 1 at +1 relative to the origin and Normative Driver 2 crosses Reference Normal 1 at −3 relative to the origin. These positions or intersections represent data points. All of these data points define a “mean” in the mathematical sense. This means, the positions of the intersection are added up and divided by the number of intersections, i.e., the number of Normative Drivers. That will be the mean path origin for all of the Normative Drivers for Reference Normal 1. In one embodiment, that process is repeated for each of the Reference Normal to find the mean position parameter at each Reference Normal. That mean at each Reference Normal for position will be the base of the standard with the scaling controlled by the distance from that base divided by the size of the Standard Deviation by which the position of the intersection of the path driven by the driver under evaluation or training will be judged. This process is repeated at each Reference Normal for each parameters such as speed, throttle position, steering input, and brake.

There are dependent and independent variables. The independent variables are used at inputs to the Vehicle Dynamics Model which calculates what the vehicle is doing in response to these inputs such as sliding, accelerating, braking, turnine, etc. The Vehicle Dynamics Model generates the dependent variables which are position, orientation and velocities meaning both and direction of movement. The calculations of this Vehicle Dynamics Model implement a free body model. Therefore the Vehicle Dynamics Model calculates a velocity vector for the vehicle. This velocity vector includes a component along the axis aligned with the direction of the wheel and it includes an orthogonal component which, when combined with the component along the direction of the wheel, makes up the calculated velocity vector.

In the preferred embodiment, the Driver Under Test is evaluated based not only upon what his car did, such as slide into another object, but also when he made inputs relative to the mean response to avoid a collision. More specifically, assume that an event on the test course is a motorcycle incursion from a cross street into the lane in which the Normative Drivers and the Driver Under Test is driving. The Normative Drivers will each have some reaction on the steering, brake or throttle or all or some of the above in response to this event. These data points for the Normative Drivers define “mean” standards for throttle response, steering response and brake responses. It is these “mean” standards which define times in the event scenario against which the reactions of the Driver Under Test can be compared to determine the level of his situational awareness and reaction times. In the preferred embodiment, the Driver Under Test is scored not only on what his vehicle did in response to his inputs, but also what his relative reactions times were compared to these “means” standards for reaction times on steering, brake and throttle. All these concepts can be extended to different applications such as training fighter pilots to fly UAV fighters or drone attack pilots flying drones such as the Predator, Predator C, Reaper, etc. and military drivers of unmanned combat and logical ground vehicles.

This same process can be repeated for whatever application the system is being used such as airspeed, attitude

For example, the mean path position along the normal shown between Arrows 1650 and 1652 can be determined by Process 1548 by summing the length of the offset, offset deltas, for each intersection point relative to the Reference Path intersection (or some other reference point along the normal) and dividing by the number of offset deltas summed. The result is the point on the normal of the mean path intersection. By connecting the mean path point similarly found of all Reference Normals the mean path driven by the drivers of the Normative Drives for the entire length of the scenario is determined.

Additionally, the standard deviation of variance from the mean path point can be calculated. The standard deviation to the left and standard deviation to the right of the mean path point are calculated separately. In FIG. 16 a black ribbon lying under the white tracks of the Normative Drive paths can be seen. One standard deviation to the right of the calculated mean path is shown at an edge 1640 Right One Standard Deviation Ribbon. An edge 1642 Left One Standard Deviation Ribbon is also shown and it represents one standard deviation to the left of the mean path. Further, Process 1548 also calculates the mean and standard deviation of the speed and other variables at each path intersection point.

This section of road demonstrates a splaying out or widening of the standard deviation ribbon that was caused by an interaction with a motorcycle and the drivers of the Normative Drives. The intersection entry path of the motorcycle is shown as Vector 1670 Cross-Traffic Motorcycle Path. When drivers slowed approaching the intersection the motorcycle cleared their lane of travel and they were able to maintain a path near the Reference Path without risk of collision. Drivers traveling faster needed to swing to the right to clear the motorcycle. Process 1548 stores the normalized data along with all the Normative Drives to a file. A File 1550 Normative Path Data File Contains list of Reference Normal with NPD Variables Data at Each Normal (.npd)

FIGS. 17 & 18 Variance from Normal

A Normal Variance Continuum (NVC) is a discrete function in distance (at the granularity of the Reference Normals) representing the difference between the driver's variable and that normalized variable in units of one standard deviation of that normalized variable at that Reference Normal. These NVCs are affectionately called Fonda Curves or Fondas, and examples of them for the position, speed, throttle and steering variables are shown in FIG. 18. They represent variance in standard deviations of the parameters of a Normative Driver's car performance such as position and speed and driver inputs such as throttle and steering from the mean values for each of these parameters or variables as derived from the drives of the Normative Drivers (or flights of the “Good Pilot” discussed elsewhere infra). The performance of a Driver Under Test (or the Pilot Under Test) can be assessed by study of these Fondas since each event has position on the Assessment Course and the horizontal axis of each Fonda is position. The vertical axis is the variance in standard deviations from the mean derived from the Normative Drivers (in one embodiment). In another embodiment, the Fonda curves can be compared to norms established by analysis of the correct and safest way to drive any course on roadways of a certain type or various types which change over the course and in a certain event scenario or multiple event scenarios. In other words, a fixed course is not necessary. The norms can be derived by analyzing what kind of a roadway exists at a particular position on a random drive through a test town or even the Driver Under Test's home town (by importing roadway information from Google Earth). Once the type of roadway situation is recognized by the computer or simulator being driven by the Driver Under Test, a norm for each of the parameters for how to drive in that particular type of roadway situation and event scenario wherever it exists (which has been previously stored in memory) is recalled from memory. The Driver Under Test's actual drive parameters are then compared to those norms.

An NVC for a variable during a person's drive in the DGS can be calculated real-time or subsequent to a drive. The values of a variable's variance are calculated at the positions of the Reference Normals that were generated in the NPD creation process. Thus, before the NVC of any variable can be calculated, normative information along the path for that variable must exist; an NPD file for the path needs to exist. If a driver drove the exact path as the NPD file mean path, the path or position NVC would be zero for the entire length of the path driven. If the driver drove one standard deviation to the right of the NPD mean path, the NVC would be one (1.0) for the entire length of the path. In FIG. 18, 1800 represents an NVC graph of several variables of a drive. A Position NVC Function 1810 represents the variance of the driver's position compared to the NPD mean position through the Events of the scenario being driven in terms of standard deviations. At a Cursor Position 1830 the NVC Position appears to spike to approximately +3.5 standard deviations. The cursor masks or covers some of the spike making the actual read difficult in the static image of FIG. 18. To improve reading fine detail, the NVC graphing function supports expanding a single Event to the full screen. A Event Number 1832 shows the cursor is in Event 16. Events are delineated from one another by lighter and darker backgrounds as shown in NVC Graph 1800. On the right side of the NVC Graph 1800 are several scale markings. A Scale Line 1840 represents plus 4 units of standard deviation above the mean value of the variable. A Scale Label 1842 marks the mean or zero position on the scale. A Scale Label 1844 also marks the minus 4 units of SD. Only the Position variable scale lines are labeled. The Speed NVC function etc. use the same +4 to −4 SD units.

Calculation of the NVC variables can be initiated from the DGS for post drive analysis or for real-time performance assessment and begins at Terminator 1710 Start in FIG. 17. An I/O 1740 Drive Data accesses data stored in the DGS Data Center for post analysis or from the DGS Simulation Terminal Connector 652 for real-time analysis as required. The drive data accessed can be from the standard .rcr file used to record and store all drives in the DGS or can be just the variable information necessary from a real-time drive on the DGS. The I/O 1740 supplies the information to a Process 1712 Get Subject Drive Data. Process 1712 supplies position and other variable information to a Process 1714 Get Next Reference Normal. Reference Normals are created during Predefined Process 1746 NPD File Creation FIG. 15. A File 1748 Normative Path Data File that is appropriate for the NVC creation is selected from the DGS Data Center or is calculated through the local Simulation Terminal DGS application. File 1748 loads into Internal Storage 1742 Normative Path Data and contains Reference Normals, variable means (averages) and variable standard deviations at each normal in addition to other information. Starting from the first Reference Normal, the intersection with the Drive Data is calculated in a Process 1716 Find Intersection of Drive with Reference Normal. A Process 1718 Get Next NPD Variable extracts information about the next NPD variable that is the first variable or position variable in this case from both the Reference Normal being processed and the Drive Data in the proximity of the Reference Normal for the next process. A Process 1720 Calculate Variance from NPD mean or the HOPE NPD (in SD units) uses the Process 1718 information and determines the variance from mean for the variable (position in this first case) and passes it to Internal Storage 1744 NVC Data. In the preferred embodiment, the variance of each Parameter of the Driver Under Test (DUT) or Pilot Under Test (PUT) is compared to the Mean of the corresponding Parameter at every Reference Normal from the NPD or HOPE NPD file. This variance data can be used for scoring or assessment of the DUT or PUT, and scoring can be any one of a number of different schemes. For example, one scoring scheme is to compare the variances to the variances of Normative Drivers who reported less than zero accidents and zero tickets in the last two years. Likewise, the variances can be compared against variances of drivers who self-reported more than one accidents or one ticket in the last two years and so on for all the different possibilities of tickets and accidents in the last two years. The test report could then take the form of, “You drive about 10% like drivers who had no tickets and no accidents in the last two years and 90% like drivers who had more than four accidents and four tickets in the last two years. You should turn in your drivers license before somebody gets hurt.” Any other form (hopefully less extreme) of scoring also suffices to practice the invention. Another method of scoring uses the variances to assess the reaction time and situational awareness of the DUT or PUT by comparing the time of reaction as indicated by the variances from the Mean of some or all of said Parameters to the variances of the same Parameters for one or more selected Normative Drivers or Normative Pilots who are considered exemplary drivers or pilots.

A Test 1722 Last NPD Variable? then determines if the last variable at the Reference Normal has been processed. If variables remain to be processed Test 1722 returns to Process 1718 to get the next variable for processing. If the last variable has been processed, Test 1722 passes to a Test 1724 Last Reference Normal? If Reference Normals remain to be processed in a post analysis file Test 1744 returns to Process 1714 to get the next Reference Normal and continue processing. If the NVC is running real-time, Test 1744 will check for end of scenario to exit the NVC Calculation or wait until the next Reference Normal is available before returning to Process 1714 and continuing the process. As all of the variables at all of the Reference Normals are sent to Process 1720 their variance from the NPD normal is recorded in 1744 NVC Data. That data is stored in File 1750 NVC Data File (.nvc) and can also be displayed. A Display 1752 Plot variance on Normal Variance Continuum Graph (NVC graph, i.e., a Fonda graph) similar to the image of FIG. 18 for post analysis of similar to the image of FIG. 23 for real-time analysis.

### FIGS. 19, 20, 21, 22, 23 Virtual Driving Instructor Examiner

### Detailed Description of Operation

The user opens the VDIE dialog box at a Terminator 1910 Start in Start. At this point, he or she can either accept the default VDIE file, or select another file with Manual Input 1912 Select and Load VDIE File by selecting Read File button 2010. The data from a File 1914 VDIE File is then loaded into a Temporary Storage 1916 Local VDIE Profile. This local profile is used for the current Scenario running in the Simulator Terminal.

Next, the user via Manual Input 1918 Selects an Event by selecting the Event dropdown box 2014. For this event, a number of triggers are displayed (2020 through 2058). Each trigger has various parameters that can be set by the user through a Manual Input 1920 Set Parameters And Actions. These parameters control when triggers occur. For example, the Speed Posted High trigger 2024 has parameters MPH Above 2070 and Time 2072. This trigger (as shown in FIG. 20) will activate if the driver exceeds 20 mph as shown at 2070 over the speed limit for more than two seconds as shown at 2072.

Once the parameters are set, the user can enable actions that will be performed when the trigger occurs. These may include playing a voice instruction, or resetting to the beginning of the current Event. For example, in the Speed Posted High trigger as shown in FIG. 20, if the trigger occurs both a voice instruction as set in check box 2074 will be heard and the scenario will be reset because check box 2076 is also checked.

At this point, the user can decide to apply his changes with the apply button via Manual Input 1922 Apply Changes by selecting Apply button 2080. This copies the modified parameters to the 1916 Local VDIE Profile for testing.

The user can then try the Event, and determine if the trigger performs as expected at a Manual Input 1924 Test Changes. The user can then decide to save his changes at a Test 1926 Save? Test 1926 monitors a button Save 2016. The file can be saved to the original VDIE file, or to another file name by optionally entering a filename at text box 2018. If the user decides to save, the local copy of the VDIE profile is saved in Process 1932 Write Local Profile to a File 1934 VDIE File.

If the user wishes to modify the triggers for another event, he or she can select Another Event to edit at Test 1928 Another Event? and repeat the save functions above or stop execution of the dialog via Terminator 1930 Stop by closing the dialog.

Features and operation of the VDIE Dialog to create VDIE Profiles are further explained on the following pages of user manual directions.

### VDI/E Dialog Interface

The Virtual Driving Instructor & Examiner monitors the DUT's performance as he drives a tactical scenario. The DUT's performance can be compared to normative-data for other drives doing the same scenario, or to standard limits on his speed, proximity to other vehicles, lane position, etc.

Evaluation of the DUT relative to a particular road condition or normative data is called a ‘Trigger”. The VDI/E dialog contains user adjustable parameters which control when a Trigger occurs, and what happens when a Trigger occurs. A tactical scenario is composed of a series of adjacent events. Triggers are set and adjusted on a per-event basis. The sum of all the Triggers for all the events in a scenario is called a ‘profile’. Profiles are stored as files, which can be retrieved when a scenario starts by the user.

When a Trigger occurs, one or more actions are executed by the VDE/E. There are currently two types of actions: a voice instruction, and a reset. Voice instructions inform the DUT about a problem with his driving. Voice instructions are specific to a Trigger, and can't be modified using the VDI/E dialog interface. Resets move the DUT back in the scenario so he can practice driving the same section of road again. For any Trigger, the user can disable the voice and reset actions. Typically, the reset action is disabled to allow the DUT to continue driving, while still playing a voice instruction. If both the voice and reset actions are disabled, nothing happens when the Trigger occurs. It is recommended that if the voice action is disabled, that the reset action is also disabled.

Another feature of the VDI/E dialog interface is that many Triggers can be adjusted. Speed Triggers typically contain two parameters which control when the Trigger occurs. For the Speed-Posted-High Trigger, the VDI/E dialog contains a user-editable field containing the MPH above the posted speed which will cause the Trigger to occur. Another user-editable field contains the number of seconds the DUT must drive above the posted speed in order for the Trigger to occur. These two values are stored for each event in the VDI/E profile.

### Triggers

### Hesitation Triggers

### Hesitation (Stop Sign)

Requirements: A stop sign(s) must be present in the event.
   It is not recommended that this Trigger be set at a stop sign with traffic.
Parameters: Time: The time in seconds after the DUT stops until the Trigger occurs.
Notes: This Trigger is currently disabled, since there are no stop signs in the Tactical-A scenario without traffic.

### Hesitation (Traffic Light)

Requirements: A traffic light(s) must be present in the event. It is not recommended that this Trigger be set at a traffic light with traffic.
Parameters; Time: The time in seconds after the light turns green until the Trigger occurs.
Notes:

### Speed Triggers

Speed Triggers typically use a ‘Trigger Threshold’. For the Posted Speed Triggers, this is some speed above or below the posted speed (as displayed on the speed limit signs). For Normative Speed Triggers, the threshold is measured in standard-deviations from the mean speed of other drivers at that position on the road.

### Speed Posted High

Requirements: A section or road without stop signs, traffic lights, or intersections.
Parameters: MPH Above: The speed above the posted speed which will activate the Trigger
Time. (see Time parameter below)
Time: The time in seconds the DUT must maintain a speed greater than the posted speed plus ‘MPH Above” before the Trigger occurs.
Notes: If the DUT maintains a speed above the Trigger threshold, and the reset action has been disabled, then the voice instruction will repeat every ‘Time’ seconds.

### Speed Posted Low

Requirements: A section or road without stop signs, traffic lights, intersections, or traffic in front of the DUT.
Parameters: MPH Below: The speed below the posted speed which will activate the Trigger
Time. (see Time parameter below)
Time: The time in seconds the DUT must maintain a speed less than the posted minus plus ‘MPH Below” before the Trigger occurs.
Notes: If the DUT maintains a speed below the Trigger threshold, and the reset action has been disabled, then the voice instruction will repeat every ‘Time’ seconds.

### Speed Normative High

Requirements: A section of road without an intersection.
Parameters: STD Above: The number of standard-deviations above the mean speed (at this road position) which will activate the Trigger Time (see below)
Time: The time in seconds the DUT must maintain a speed above the Trigger threshold before the Trigger occurs.
Notes: The Trigger threshold at any point on the road will depend on the normative data set used to calculate the mean speed and the standard deviation of the speed. The Trigger threshold also depends on the ‘STD Above’ parameter.

### Speed Normative Low

Requirements: A section of road without an intersection.
Parameters: STD Below: The number of standard-deviations below the mean speed (at this road position) which will activate the Trigger Time (see below)
Time: The time in seconds the DUT must maintain a speed below the Trigger threshold before the Trigger occurs.
Notes: The Trigger threshold at any point on the road will depend on the normative data set used to calculate the mean speed and the standard deviation of the speed. The Trigger threshold also depends on the ‘STD Below’ parameter.

### Speed Normative Turning High

Requirements: An intersection. For this Trigger, an intersection is defined as the transitional area where the DUT is driving from one road onto another road. This includes ramps.
Parameters: STD Above: The number of standard-deviations above the mean speed (at this road position) which will cause the Trigger threshold to be exceeded.
Notes: If the Trigger threshold is exceeded a majority of the time during the turn, the Trigger will occur.

### Position Triggers

Position Triggers typically use a ‘Trigger Threshold’. For Normative Position Triggers, the threshold is measured in standard-deviations from the mean position of other drivers at that position on the road.

### Position Normative

Requirements: None
Parameters: STD L/R: The number of standard-deviations from the mean position of other drivers which will cause the Trigger threshold to be exceeded.
Time: The time in seconds the DUT must maintain a position above the Trigger threshold before the Trigger occurs.
Notes: The Trigger threshold at any point on the road will depend on the normative data set used to calculate the mean position and the standard deviation of the position.
The Trigger threshold also depends on the ‘STD L/R’ parameter.
If the DUT maintains a position above the Trigger threshold, and the reset action has been disabled, then the voice instruction will repeat every ‘Time’ seconds.

### Position Lane Position

Requirements: A section of road without an intersection (any road change). A section of road with one or fewer lanes in each direction.
Parameters: Factor: Typically a number between 0.5 and 1.0. The factor describes the position of the DUT car relative to the lane. A factor of 0.0 indicates the DUT is in the center of his lane. A factor of 1.0 indicates the side
   of the DUT car is on the lane marker (either to the left or to the right). If the factor is set to 1.0, then any time part of the DUT car is outside of his lane, the Trigger threshold will be exceeded. Time: The time in seconds the DUT must maintain a position above the Trigger threshold before the Trigger occurs.
Notes: Multiple lanes on a road allows the DUT to change lanes, which would cause this Trigger to occur. Therefore, for the time being, this Trigger will process only on roads with one traffic lane in each direction (and ramps with a single lane in one direction). If the DUT maintains a position above the Trigger threshold, and the reset action has been disabled, then the voice instruction will repeat every ‘Time’ seconds.

### Position Normative Turning Wide

Requirements: An intersection. For this Trigger, an intersection is defined as the transitional area where the DUT is driving from one road onto another road. This includes ramps.
   Parameters: STD The number of standard-deviations from the mean position of other drivers which will cause the Trigger threshold to be exceeded. The position of the DUT must be on the ‘outside’ of the normative drivers (relative to the turn direction).
   Time: The time in seconds the DUT must maintain a position above the Trigger threshold (and be on the outside of the turn) before the Trigger occurs.
   Notes: This Trigger will occur at most one time (or not at all) during a turn.

### Position Normative Turning Tight

Requirements: An intersection. For this Trigger, an intersection is defined as the transitional area where the DUT is driving from one road onto another road. This includes ramps.
Parameters: STD The number of standard-deviations from the mean position of other drivers which will cause the Trigger threshold to be exceeded. The position of the DUT must be on the ‘inside’ of the normative drivers (relative to the turn direction).
Time: The time in seconds the DUT must maintain a position above the Trigger threshold (and be on the inside of the turn) before the Trigger occurs.
Notes: This Trigger will occur at most one time (or not at all) during a turn.

### Position Tailgating

Requirements: The DUT is behind a traffic car that is in the same lane (or partially in the same lane)
Parameters: Time: The time the DUT must be below the Trigger threshold before the Trigger occurs.
Notes: The Trigger threshold is defined internally by the DGS as a speed dependent distance behind the traffic car. This distance can't be set using the VDI/E dialog interface. If the DUT maintains a position behind the lead vehicle which the DGS considers tailgating, and the reset action has been disabled, then the voice instruction will repeat every ‘Time’ seconds.

### Merging

Requirements: An intersection. For this Trigger, an intersection is defined as a road junction where two roads meet or cross, creating a ‘T junction’ or ‘crossroads’. The DUT should be making a left or right turn onto the cross road, where traffic cars are moving on the cross road, either in the intended direction of travel, or opposite to it. Traffic cars on the initial road, moving in the opposite direction, are also supported by this Trigger.
Parameters: Dist From Car: A traffic car closer than this approximate distance (in feet) from the DUT car will cause this Trigger to occur. Traffic cars moving away from the DUT during the turn will cause the Trigger to occur if they get closer than “Dist From Car”/2.0.
Notes: This Trigger is designed to work with merges from ramps onto roads, but there are currently no portions of Tactical-A (events 12-27) where these types of merges occur. Using this Trigger in this type of merge may not function correctly.

### Bump/Crash Triggers

Bump and Crash Triggers work the same way, but a Bump will occur if there is a low energy collision, whereas a Crash will occur for higher energy collisions. The thresholds for determining what is a Bump and what is a Crash are built into the DGS, and aren't settable using the VDI/E dialog interface. Bumps and Crashes can occur with other vehicles (cars, motorcycles, or bicycles), or with any object in the DGS world.

### Bump Object

Requirements: Low energy collision with all objects except other vehicles.
Parameters: None
Notes: Collisions with traffic signs which fall over won't cause the Trigger to occur. It is recommended that the reset action for Bumps/Crashes not be disabled.

### Bump Vehicle

Requirements: Low energy collision with another vehicle (car, motorcycle, or bicycle)
Parameters: None
Notes: It is recommended that the reset action for Bumps/Crashes not be disabled.

### Crash Object

Requirements: High energy collision with all objects except other vehicles.
Parameters: None
Notes: Collisions with traffic signs which fall over won't cause the Trigger to occur. It is recommended that the reset action for Bumps/Crashes not be disabled.

### Crash Vehicle

Requirements: High energy collision with another vehicle (car, motorcycle, or bicycle)
Parameters: None
Notes: It is recommended that the reset action for Bumps/Crashes not be disabled.

### Missed Stop Triggers

The rules which determine when these Triggers occur are built into the DGS, and aren't currently settable using the VDI/E dialog interface. Note: The rules may be available in another document (documentation of violations for stop-zones)

### Missed Stop (Sign Or Light)

Requirements An intersection with a stop sign or red traffic light.
Parameters: None:
Notes:

### Turn Signal Triggers

The rules which determine when these Triggers occur are built into the DGS, and aren't currently settable using the VDI/E dialog interface. The DGS looks for a turn signal at some time before (and during) the lane change or turn. Any use of either turn signal during this time will cause these Triggers not to occur.

### Lane Change Turn Signal

Requirements: A section of road without an intersection, and where there are multiple lanes in the direction of travel.
Parameters: None:
Notes:

### L./R Turn Signal

Requirements: An intersection. For this Trigger, an intersection is defined as the transitional area where the DUT is driving from one road onto another road. This includes ramps.
Parameters: None

### Changing Trigger Parameters/Actions Using the VDI/E Dialog

The parameters and actions for Triggers can be edited by the user using the VDI/E Dialog Interface. The VDI/E Dialog appears when the scenario starts. Generally, Trigger parameters and actions shouldn't be changed (edited by the user) while a DUT is actually performing a scenario.

### Editing the Triggers Before the Scenario Starts

When the scenario begins, the first event number (Event 12) in the scenario is shown in the ‘Event List’ at the upper left corner of the VDI/E Dialog. The DUT vehicle will be stationary at the start of the scenario. Before the driver (DUT or user) starts driving, the user can edit the parameters and actions for all the Triggers for Event 12. To save the changes to the Event 12 Triggers, press the [Apply] button at the bottom right corner of the dialog. Another event number can be selected from the Event List, and the Triggers for that event can be edited and applied.

When done editing the Triggers, press the [Save File] button to save the changes to a file. No changes can be saved to the default VDE profile (VDEProfile), so a new VDE file must be created to save any changes made to the default profile.

### Editing the Triggers During the Scenario

As the driver (DUT or user) performs a scenario, the Event number displayed in the Event List will change. It is not recommended that Triggers be edited while the driver is actually driving the scenario. Instead, press the [Reset} button. The scenario will be reset to before the beginning of the current Event, and the DUT vehicle will be stationary. Before the driver starts driving, the Triggers for any Event can be edited by selecting the Event from the Event List, editing the Triggers for that Event, and pressing the [APPLY] button. All changes made can then be saved to a profile file by pressing the [Save File] button.

Whenever Trigger parameters or actions are changed, the changes should be saved to a file if they will be needed in the future. Using only the [Apply] button, but not the [Save File] button, will result in the changes being lost when the scenario ends.

### Using Profiles (Reading Profiles)

The methods used to create and use VDI/E profiles are still under development. The current methods are subject to change as the VDI/E changes.

DGS currently ships with several predefined profiles. For DGS version 0.90, these files are in the C:\DGS\DGS-ST_{—}000_{—}90\Working\NormPath directory. See the next section for a list of profiles that are available for DGS 0.90.

When a scenario is downloaded, and after the [Begin] button is pressed in the Operator Panel, the DGS will always read the default profile (VDEProfile.xml). The VDI/E dialog will appear, and will show “VDEProfile (default)” in the upper right of the dialog. Before pressing the [Test] or [Practice] buttons, the user can read another VDE profile by pressing the [Read File] button. Another dialog will appear which show any other profile files available. The user can select any other profiles which have been shipped with that version of the DGS, or any profiles created by the user. If another profile is selected, the VDI/E Dialog will show the name of that profile in the upper right of the dialog.

Once the user presses the [Test] button in the Operator-Panel, the [Read File] button is disabled in the VDI/E dialog, but it will still be possible to edit the Triggers.

### FIG. 21

The Rules of the Road system evaluates whether the driver is following a set of “rules of the road”. There are a number of modules, each of which is responsible for a particular rule of the road. Each module looks at the driver's position and speed on the road, the position of other cars, and a database of road lane, speed limit, traffic sign, and traffic signal information. The module then decides if the driver is following the particular rule of the road that it is designed to check. If the module detects a violation, it records the time and position of that violation, and the severity of the violation. This information can be used to determine if a driver has passed a “virtual road test”, compare their driving to other drivers, or give the driver instruction on his mistakes. One example of a Rules of the Road (The StopSignViolation module) is described below, but there are many such modules, one for each “rule of the road” to be checked.

The associated FIG. 21 shows how the “StopSignViolation” module operates. This module determines if the driver runs a stop sign. The module is called every 1/60 of a second of simulated time. On entry, we check a the Road and Traffic Signal Database (2110) to determine the distance from the driver's car to the next stop sign ahead on the road. If the next stop sign is less than 50 feet ahead of the driver's car, the driver is in a stop zone now (2112).

If the driver is in a stop zone now, we check a variable to determine if the driver was in a stop zone the last time the module was called (2114). If the driver was not in a stop zone last time, we set a minimum speed variable to the driver's current speed (2116), and set the variable to signal that we were in a stop zone last time (2118). We return from the module without recording a violation.

If the driver was in a stop zone last time, we check to see if the driver's current speed is less than the minimum speed variable (2120). If so, we place the driver's current speed into the minimum speed variable (2118). In either of these cases we return without recording a violation.

If we are not in a stop zone, but were in a stop zone last time (2122), we record that we are not now in a stop zone (2124). We then check the minimum speed variable to see if it is below a threshold (2130). This threshold can be zero to check for a complete stop, or set to a few miles per hour to allow for rolling stops. If the speed was less than or equal to the threshold, we return without recording a violation (2132).

If we have just left the stop zone, and the minimum speed in the stop zone was greater than the threshold, the driver failed to stop at the stop sign, and we record a violation (2134).

### FIG. 22.

Consistent, repeatable, objective, discriminating, and insightful driver evaluation is a significant challenge for driving simulators and even for human reviewers. Likewise, the ability to instruct in a consistent, non-threatening, effective interacting manor is a significant challenge for driving simulators and even for human trainers. With the use of NPD files to provide normative standards with which to build variance records via the NVC process along with the ability to test basic rules-of-the-road compliance and a detailed context or Event based performance template/standard in the form of functional trigger points, it is possible to build the desired virtual examiner or trainer.

As s Scenario is being processed by Predefined Process 2210 Run Scenario in FIG. 22, each trigger in the Predefined Process 2214 NORMAL VDIE Profile for the current Event is examined by a Process 2226 Evaluate Trigger and Process Action. The associated criteria (Rule Of The Road (2222) or NPD data (2224)) for that trigger is checked. If necessary, the Road and Traffic Signal Data (2212) is referenced and it is determined if that trigger is satisfied.

If the trigger is satisfied, the action associated with that trigger is performed. The actions are located in the profiles 2213, 2214, and 2215. Examples of actions are to give a voice instruction to the driver, and/or to reset the event in the scenario. If the action is to Reset the Event at Test 2218 Event Reset? further processing of triggers is stopped and a Process 22316 Reset to Event Start as Specified in Scenario is performed.

After each trigger is examined, we determine if all triggers have been processed at Test 2220 All Triggers Processed? If there are more triggers to be tested, the next trigger is examined. If all triggers have been processed, control is returned to running the scenario at Run Scenario 2210.

A series of VDIE profiles may be used to more accurately assess the ability of a driver. While retraining an individual after a brain insult that affected their driving, it is useful to start with very basic operations and to allow wider than normal tolerance of performance. As the driver's ability increases, the tolerance of performance can be tightened. By monitoring the driver's performance relative to the triggers for variables through a portion of the Events, one of a series of profiles is matched to the driver's ability. It is believed that a VDIE profile that is too easy or too hard for the driver's abilities reduces training effectiveness. By comparing the driver's performance to a series of profiles such as VDIE Profiles 2213, 2214, and 2215 while they drive the initial Events or portion of a training Scenario, starting from the easiest profile, the balance of the Scenario is run with the first profile with significant triggers that have been activated. It may be necessary on some types of Scenarios to run the complete Scenario as a test (without actions activated) to gauge the performance ability on the diverse aspects of driving required by the Scenario.

### FIG. 23

A summary of interaction (interdependence and interoperation) between NPD data, NVC calculations, Rules-of-the-Road, and VDIE profiles is facilitated by a composite screen grabs in FIG. 23. A VDIE profile Event 12 2310 is setup using in part both the Rules (20 mph above, 2 sec, with voice and reset active) and NVC (1.0 STD above, 5 sec, with just voice active) triggers. Additional triggers and operating conditions are also set in the profile. By selecting a Data button 2312, a NVC Real-Time Chart 2330 displays on the operator screen in place of the VDIE dialog 2310. As noted in a text body, some of the functioning at Text 1 2340 is described. The NVC variables displayed at 2330 are from top to bottom, Position, Speed, Throttle, Steering, and Time. As can be seen from the Speed variance continuum, the driver drove the first part of Event 12 at about 3.0 STD above the normal drivers but slowed down at the right end of the trace. The vertical line at the right end of four of the variables is the position cursor indicating the distance (number of Reference Normals passed) or progress the driver has made through the Event. Note, each vertical gradation line represents two standard deviations as in FIG. 18. The trigger thresholds can also be displayed as a combination of a horizontal amplitude line with a horizontal highlight of the amplitude line. The length of the highlight indicates the estimated distance (Reference Normals to be crossed) before the time hold-off expires and the trigger is tripped. The highlight line left end starts at and travels with the position cursor until the threshold is exceeded then it is anchored at that intercept. If the threshold is still exceeded by the distance value (length in time multiplied by the speed) the actions for the variable are triggered. The speed used in the trigger calculation is the driver's actual speed but is first estimated for the highlight display with the NPD normal speed through the region. Also note, the trigger threshold values and highlights are not shown in the figure.

The display of the thresholds that have been exceeded and the area of the amount of the driver's variable above the threshold multiplied by the distance (number of Reference Normals crossed) while exceeding the threshold is also displayed on the NVC charts. This area represents a “variance area” and is summed for each variable for each Event of the full Scenario. As a result, the amount of noncompliance or failure of the driver relative to the triggers in the VDIE profile can be quantified for each Event and Scenario. The driver is incentivized to minimize noncompliance in both the amount of deviation and duration of the deviation to improve their report. Test givers also have a more detailed metric to compare driver performance. Note, the noncompliance areas (variance areas) are not shown in the figure.

The drives that are used to calculate the NPD data are shown as Drives in NPD Calculation 2320. Text 1 2340 explains,

“The “Data” button in the VDIE dialog shows the “Normative Data” dialog. This dialog contains the standard NVC graphs. On the left side is the list of drives which were used to create the NPD data. The user can select one or more drives, and the selected drive(s) will be shown as a red colored line in the DGS world.”

Thus, as the drives are selected in the list 2320, the path of that drive is shown in the virtual world as a red line. Among other utility, this helps identify drives that deviated significantly from other drives Specific drives can be removed from the NPD calculation by selecting the drive and clicking the “Disable” button. Text 2 2350 explains,

“By selecting one of more drives, and pressing the “Disable” button, it is possible to remove drives from the NPD data set. This is shown in the drive list by (XX) before the drive file name. The default NPD file shipped with DGS has one drive removed (number 42). This functionality allows a DGS user to change the NPD data.”

To facilitate the inspection of the “path” of all of the drives, a “flyover tool” supports the inspection of the course with perspective and plan views that can be quickly guided along the road course. As outlying data is observed, by viewing the path lines relative to the roadway similar to FIG. 16, the identity of the drive can be determined and a decision or further review of the drive for use in the NPD file can be made. The further review may include scoring the questionable drive against the body of remaining drives per the following.

Another tool for confirming the drives used to form the NPD data numerically compares each drive to the remaining drives. Each of the drives is scored relative to the remaining set of drives across a spread of variance thresholds and hold-off times. Each drive is rated against an NPD file formed by the balance of the drive set members. For example, in a set of ten normative drives numbered one through ten, the variables of Drive #1 are scored against an NPD file constructed from Drives #2 through #10. Then Drive #2 is scored against an NPD file constructed from Drive #1 and Drives #3 through #10 and so on until Drive #10 is scored against an NPD file constructed from Drives #1 through #9.

For the purpose of comparing candidate drives for the normative drive set, a series of scores are calculated. For each of the variables, the variance area is accumulated as detailed a few paragraphs above. If feet or meters are desired rather than Reference Normals, the distance between normals needs to also be multiplied into the variance area.

Next, threshold values such as 0, 1, 2, 3, 4, and similar are used for the first pass of the score calculation. If the threshold values are plotted on the abscissa or x-axis with the respective variable variance area on the ordinate or y-axis the resulting area under the line formed by the points will be inversely proportional to the driver's path, or speed, etc. relative to the NPD data. The area represents divergence from the normal drive. That is, the smaller the divergence area, the closer the driver drove relative to the average drive of the NPD file. The size of this divergence area is used to rank how “normally” one of the candidate normative drivers drives relative to the rest of the set of drivers. The drivers can be ranked from lowest divergence to highest and elimination of outliers is thus guided by this objective performance measure. Subsequently, subject drivers being assessed or trained can be measured with the same objective measures. The line described by the variance areas of the thresholds represents the variance gradation and will slope down to the right with a negative slope. The difference in the slope of the line between drivers will also indicate more or less divergence with respect to the normal drive. A higher variance gradation (steeper slope) indicates less divergence.

Then the above calculation is repeated but with hold-off times added. That is, the calculation with a hold-off of zero seconds was collected as just explained and now the hold-off time of 1.0 seconds is calculated. Additional hold-off times of 2, 3, 4, and 5 seconds are also calculated. For example, the continuum of the Position NVC Function 1810 represents the NVC (normal variance continuum) during the Events of an entire Scenario. The variance area above zero SD and below the continuum represents the variance to the right of the normal path of the NPD. The variance area below zero SD and above the continuum represents the variance to the left of the normal path. The sum of the right variance areas will represent the total right of path variance. The sum of the left variance areas will represent the total left of path variance. Both values will represent their respective zero second hold-off values for the position variable. Next a one second hold-off is imposed and the resulting areas above and below are again summed. As a result, all of the variance areas that stated and stopped before one second elapsed are removed from the summation. Then the calculation is performed again for each of the additional hold-off times at each of the threshold values. The affect of increasing the hold-off time is to remove the variance areas with durations shorter than the hold-off time from the summation. By displaying the variance gradation thus obtained for the respective hold-off periods, in a waterfall diagram or surface diagram the time-based consistency of the variance is displayed. The more consistent a drive the smoother the variance of variables like position and speed. The smoother the variance of a variable, the more apt it is to be counted in longer hold-off period calculations. This is because the variable didn't dip below the threshold and reset the hold-off timer. Comparing and ranking the consistency of drives can also guide outlier decisions and rate or assess and train drivers in a general sense.

### FIG. 24 Signature Analysis

Objective performance analysis techniques that provide measurement during the exercise of freeform activities while driving and flying will be explained using FIGS. 24, 25 & 26.

For example, using these analysis techniques, relative to norms the path of a driver during the execution of a left-hand turn can be objectively scored. With the techniques many similar freeform driving and flying actions can be objectively scored. A core component of data used by the techniques is the previously described Normal Variance Continuums NVC's or fonda's that are developed by comparing a DUT's methods relative to the methods of a Composite Reference Drive of an NPD file.

For clarity of discussion that follows, the Composite Reference Drive is calculated during the NPD Creation processes of FIG. 15. A composite mean path is produced by connecting the mean path points similarly found at successive Reference Normal's. That is, creation of the .npd file per FIG. 15 calculates and contains in part the mean position, speed, etc. at each Reference Normal. The line from one Reference Normal mean path point (position) to the next Reference Normal mean path point and so on will form the composite mean path navigated by the Reference Driver through the Scenario. We also call this mean path the Composite Reference Path or Reference Path and we call the total body of mean and SD's of variables such as, position, speed, etc. the Composite Reference Drive or Reference Drive.

The analysis process to be described is composed of the steps of:
1) creating the Reference Drive and NPD file by the NPD File Creation Process of FIG. 15,
2) creating the NVC data by the NVC Calculation Process of FIG. 17, and
3) through the use of various analysis techniques quantitatively analyze sections of the path meaning sections of the NVC graphs for basic characteristics or signature trends typifying the DUT's performance relative to the Reference Drive. This third component objectively quantifies and contrasts the DUT's differences in techniques/methods to the performance of the Reference Drive.

The combination of analysis techniques is designed to reduce large amounts of data documenting the path and speed etc. over a desired length of study (section of road) to a lesser more clarifying or typifying set of numbers or parameters that define the DUT's drive relate to a Reference Drive.

Not depicted in FIGS. 24, 25, & 26 but available to the analysis processes is the physical position or speed etc. of the driver's vehicle. The raw data file (.rcr) collected by the DGS containing positions, speeds etc. sixty times a second is also available for analysis purposes. That is, the performance may analysis includes reference to the actual position and/or speed etc. of the driver's vehicle or controls when useful. The FIGURES and discussion focus on the new aspects of relative analysis. Also, FIGS. 24, 25, & 26 are generated from the analysis of a particular DUT's drive through Event 19 of a Tactical Scenario. Every other Event in the scenario can be similarly analyzed as can all Events together or in any combination. Importantly, the techniques also apply to smaller desired length of study road sections. For example, the analysis of Elements such as Element 1450 or 1452 of Event 1424. A useful Element of Event 19 to analyze is the road section shortly before and past the travel lane incursion that is depicted in the central area or driving image of FIG. 26 as will be described in greater detail.

FIGS. 24 & 25 display representations of analysis techniques studying data of the NVC for Event 19 of a drive that is shown in the lower portion of FIG. 26. FIG. 24 is a “Signature” graph of a variable's Variance Area. In this example, the graph shown displays the Variance Areas beyond Standard Deviation threshold values for the speed variable during Event 19 in a drive of a Tactical Scenario. As stated above, under the FIG. 23 description, the area represents divergence from the Reference Drive. The Variance Area is simply the variable's average SD for the distance between RNn and RN(n+1) added to the average SD for the distance between RN(n+1) and RN(n+2) and so on until the RN's have covered the desired length of study of the drive. By way of explanation, if a DUT's drive matched the speeds at each Reference Normal except RNn at which she drove two SD's above the Reference Drive, the Variance Area would equal the sum of the piecewise linear triangular areas from zero SD's at RN(n−1) to two SD's at RNn to zero SD's at RN(n+1) or 2.0 SD*RN's. Thus the Variance Area is calculated by computing the average SD variance between two Reference Normals and summing all such areas.

In the current embodiment, Variance Areas are calculated using an equivalent measure, the square root of the variance or Standard Deviation. Alternately, the distribution's mathematical variance could be used to the same effect.

Variance Areas at Standard Deviation (SD) threshold values such as 0, +/−1, +/−2, +/−3, +/−4, and similar are calculated. With regard to area calculations above threshold values, in the Signature graph, the areas shown to the left and right of zero SD are the areas above the particular SD. For example, the area between two RN's each of value 2.0 is 2.0 units. The full 2.0 units are included in the area count at zero SD on the abscissa but only the 1.0 unit of area above 1.0 SD would be counted at the 1.0 SD abscissa mark. Reporting the tally to just the area above or super to a threshold helps identify error excursions. The area super to 1.0 SD in the displayed Signature of FIG. 24 is about two or three SD RN's.

The Variance Area values at respective thresholds are plotted above the abscissa or x-axis 2416 at the level of the respective variable on the ordinate or y-axis 2418. Linear lines joining adjacent points then form a line graph of the variance area verses SD threshold. The area 2430 below zero SD results from the bounds of such a line as 2420, the vertical at zero SD 2412, and the abscissa or horizontal axis 2416. Similarly, the area 2432 above zero SD results from the bounds by the line 2422, the vertical at zero SD 2412, and the abscissa or horizontal axis 2416. The combination of areas 2430 and 2432 will be inversely proportional to the driver's path, or speed, etc. relative to the NPD data. The greater the area the more the drive diverged from the Reference Drive. The smaller the divergence area, the closer the driver drove relative to that variable of the Reference Drive of the NPD file. The size of this divergence area is used to rank how “similarly” one of the candidate normative drivers drove relative to the rest of the normative set of drivers used to generate the Reference Drive in the NPD. The drivers can be ranked from lowest divergence to highest and the important process of eliminating outliers is thus guided by this objective performance measure. Subsequently, subject drivers (DUT's) being assessed or trained can be measured with the same objective measures.

Further, in FIG. 24 area 2430 represents the negative area or area below zero SD's at increasingly negative SD's. Area 2432 represents the positive area or area above zero SD's at increasingly positive SD's. Both of which are currently calculated from zero at 0.5 SD's increments, however other increments could be chosen. For the speed variable, positive Variance Area areas indicate the DUT driving faster than the Reference Drive while negative Variance Area indicates a slower speed. The drive represented by FIG. 24 shows that the DUT transited most of the RN's of Event 19 at a higher speed than the reference. This Signature also shows the divergence was mostly at low SD values and not because of speeds many SD's from the means of the Reference Drive in the NPD file.

The slope of line 2422 describing the variance areas at the positive SD threshold values represents the variance gradation and will fall down to the right with a negative slope. The steeper the slope, the tighter or closer the variance at each of the RN's to one another. A steeper slope indicates the driver drove a more parallel path or a closer speed to that of the Reference Drive.

If the Driver Under Test (DUT) had driven at the same speed as the calculated mean speed when crossing each Reference Normal of Event 19, the areas 2430 & 2432 would be zero. The likelihood of a DUT matching the speed of the Reference Drive of an NPD File along a length of road is very low. But the closer that speed match, the smaller the area under the curves 2420 and 2422 of FIG. 24.

In the present embodiment, the variance can also be quantified, displayed, and numerically represented by determining the number of Reference Normals that exceed given SD threshold values. The amount of SD variance at the particular Reference Normals is not captured but the fact that a certain number or percentage of all RN's exceeded a particular threshold variance value is quantified. This method is not shown in the FIGURES.

### FIG. 25 Variance of Variance

Another useful technique of quantifying performance measurement is study of the distribution or the variance of a variable along the desired length of study. That is, an analysis of the variance of the variance along a portion of the drive. Again, the variance discussed is represented by the NVC chart shown in the lower portion of FIG. 26. Several normal distributions are depicted in FIG. 25. The distribution of a variable of the drives forming the Reference Drive is depicted by curve 2550. Each Reference Normal encountered along the desired length of study has associated with it the mean and SD resulting from analysis of the entire group of component drives for each variable (i.e. position, speed, etc.) that is tracked. Although for example, the actual physical parameter that a variable tracks may vary from one RN to the next, the distribution can still be characterized with a mean and SD. Considering the speed variable for the moment, at RNn the mean speed and SD may be, 20 mph and 3.5 mph, then at the next RN(n+1) the mean speed and SD may be, 21 mph and 3.7 mph. But a particular variance of for example 1.0 SD at that particular RN is represented by the same point on distribution 2550 as an 1.0 SD on any other Reference Normal RN.

Distribution curve 2552 represents the variance of the DUT's speed variables variance along the desired length of study or Event 19 in this case as taken from the NVC data. Curve 2552 identifies that the DUT drove Event 19 with a mean speed of about 0.4 SD's faster than the Reference Drive. Also per graphical estimation of curve 2552 the Standard Deviation (one sigma deviation) of the DUT's speed variance is approximately 0.6 SD's relative to the distribution 2550.

As stated above, sub-Event or Element analysis can be applied to Road Sections shorter than Events. Elements of Events can be analyzed. For example, an Element containing just the intersection of a left-hand turn could be studied to assess the path taken by a DUT through the turn. The Element of making a left-hand turn contains just the divergences associated with the variables during the turn. For example, if FIG. 24 represented the Signature of a left turn for the Position Variable, the positive area 2432 would represent area to the right or wide of the NPD Reference Path. Depending on the amount of divergence, feedback can then be given to the driver that the “line” of their left turn was wider than normal but 1) with in normal limits, or 2) in a caution zone, or 3) unacceptably wide. The values separating the selection of the messages would depend on subjective decisions but would be guided or triggered form the objective analysis of the NPD/Fonda/Signature system. The values set to trigger the feedback are also tailored to the specific goal of the DGS at the time of the drive along the lines of the VDIE processes associated with FIGS. 19 through 22. For example, initial training of TBI or stroke recovery would likely call for wider margins so as to provide incentive to the patient. As their ability improved the requirements could be tightened.

In a similarly fashion, an important purpose of Event 19 in the Tactical Scenario is to test the DUT's performance as a parked car abruptly pulls into the travel lane. If the analyzed range of the Road Section is reduced to the section from just before the parked car pulled into traffic to some similar distance past where the car was originally parked, a Signature focused on the incursion Element would be produced.

But by the Fonda graph it can be seen that this DUT slowed significantly more than the reference drive during this Element. Interpretation of the positive or negative nature of that slowing will have a significant subjective component but objective comparison to a common reference will serve as a foundation for the judgment.

A third distribution 2554 shown in FIG. 25 represents the variance of the speed variance over the incursion Element of Event 19. The sub-portion of road section selected reduces the desired length of study to an Element of the roadway traversed while a travel lane incursion occurs. In analyzing the reaction of the DUT to the travel lane incursion, it should be noted that all of the drives that composed the Reference Drive were also presented with the same travel lane incursion. If this DUT had maintained a speed through the lane incursion Element similar to that of the Reference Drive, the offset of the mean of curve 2554 would be close to zero SD. But this DUT dropped her speed significantly sharper such that her mean was nearly one SD below the Reference Drive mean response.

From the single viewpoint of assessing collision avoidance with respect to the lane incursion car, the greater the separation between the DUT and the threat the better. From the more comprehensive viewpoint of mitigating the risk of collision in front and in back, this DUT's actions were not ideal. She has increased the potential for a rear end collision. The Reference Drive variable means (averages) through the RN's of the incursion Element represent the composite methods used by experienced drivers or “flow of traffic” knowledge used to avoid all threats. Large negative (or positive) speed divergence from that body of experience may indicate inexperience or less than advantageous technique.

The point being that if the drivers that were used to generate the Reference Drive were experienced safe drivers and they were presented with the same challenge as the DUT, divergence of the DUT's techniques as evidenced by the NVC from the Reference Drive needs to be considered carefully. Meaning that the divergence is not what experienced safe drivers do under the same circumstances. Many components of driving can be tested with these techniques. Among many examples, a DUT's tendencies for hesitation or stopping on freeway on ramps could be analyzed with these techniques.

Experienced drivers often use a combination of speed and position control (steerage) for collision or threat avoidance.

### FIG. 26 NVC Analysis

FIG. 26 is a composite screen grab displaying data analysis windows associated with a replay of the scene from Event 19 that the Driver Under Test was presented when originally driving the Scenario. In the scene, the third of three cars 2630 parked on the right side of the roadway is starting to pull into the driver's travel lane. The associated NVC or fonda 2612 is shown in the lower portion of FIG. 26. Various associated numerical statistics are shown in the NVC Data table 2614 at the top of FIG. 26.

The speed NVC or Fonda 2612 graph depicts the speed of the DUT relative to the speed of the Normative Drive. The graph does not depict the absolute speed of the DUT. The Progress Cursor 2610 identifies the progress through Event 19. A Marker 2620 shown as a small white square is to the right (ahead on the road) of the Progress Cursor 2610 In this particular instance, the Marker 2620 is slightly more than two Standard Deviations slower than the mean speed of the Normative Drive. The low speed in the case was zero mph or stopped. More important in the study of the performance of this Event than the speed at any particular moment is the change in speed relative to how the Normative Drive speed is changing. The vast majority if not all of the Normative Drivers were reducing their speed at the point of the Progress Cursor 2610. As a result, if the DUT is going to maintain the fonda at the same level above zero SD as seen to the left of the Progress Cursor 2610, she is going to have to be reducing speed. In order to produce a negative slop as the DUT in this instance has done, she has to be slowing faster than the Normative Drive is slowing. Because of the accelerated speed reduction, the DUT will develop a greater safety distance to the incursion car. The wisdom and necessity of this deceleration at a higher rate than the Reference Drive was discussed above.

Additionally time-based performance analysis techniques can be guided using activities identified in the NVC study. Neuro-psychological reaction times similar to the reactions times captured in the Operational Tests can be determined using tell-tell actions at RN's to guide search of the time-based information in the .rcr raw data files of the drive. It is known that to the left of Progress Cursor 2610 the vehicle 2630 started to present as an incursion. The time interval between RN's at the speeds (or any other reasonable speed) of Event 19 is relatively long, about 120 milliseconds. Data is captured in the raw files on the order of ten times faster and the increased resolution is useful. The time between the moment incursion started to present and the DUT's reaction as evidenced by lifting the throttle or steering to avoid the threat is the acquisition reaction time. The time that was used to sample data in the raw file for each Reference Normal is recorded with the RN.

### Overview Collecting Hope Parameters—FIG. 27

FIG. 24 is a flowchart overview of the processes of creating a Normative Path/Performance Data or NPD file for a studied fixed course and a process for extracting HOPE Parameters to use when generating a HOPE NPD for a synthesized course. The synthesized course is used to measure performance and then assess and train drivers who choose to drive off the studied fixed course in the virtual or real world. HOPE stands for Humanistic Operating Procedures and Envelopes. The basic idea in extracting/collecting HOPE Parameters and in generating a HOPE NPD file is to study the way a selected group of drivers drive on various types of roads. Then store the driving characteristics and parameters for later use patching together a road course different than the studied road course but with the same ability to measure a driver's performance against the way the selected group of drivers “would have” driven the new route.

The information that is extracted includes both the independent input of the drivers to the steering, throttle, brake, turn signal, etc. and the dependent results of their vehicle's speed, position, orientation, etc. thus including the driver's commands and the results of those commands. To capture the data, frequent assessment points or alternately stated “sample points” are chosen along the route where the variables representing actions of and the results of the actions of the drivers are analyzed and logged. The arithmetic Means and the Standard Deviations of the variables define how the selected drivers collectively navigate the various road segments in the studied fixed course. Then new sample points could be established with the averages or Means and Standard Deviations of the variables for similar or identical road segments can be applied to describe how the selected drivers would drive a different route on similar road sections. In this way, measurement relative to the sampled drivers on paths off the studied fixed course can be accomplished. It is those extracted and reapplied Means and Standard Deviations of a plurality of variables at each of a plurality of sample points along each road segment in the new path which the Driver Under Test drove which are the data stored in the HOPE NPD file. The HOPE NPD file can then be used to measure drivers for assessment and training who have chosen to drive off the studied fixed course where no studied select group of drivers have driven before.

Depending on the goals, different types of drivers may be chosen for the select group used for the HOPE Parameter extraction. Usually, experienced, safe drivers from the general population would be chosen for the select group of drivers. Sometimes drivers with specific abilities may be chosen and sometimes poor of some description may be chosen. For example, it may be useful to use a group of drivers that have lost their licenses do to speeding. There are a wide variety of drivers that could be selected to fit the desired group to compare a DUT's abilities against. Regardless of the type of group, we refer to a driver from the group as a reference driver or as a Normative Driver that when studied, form the Composite Reference Drive or Reference Drive of the NPD file.

Without the HOPE techniques, for analysis based on a Reference Drive to work many experienced and vetted reference drivers (Normative Drivers) need to have driven the study course to characterize the Reference Drive of the npd file. Before new HOPE techniques herein described, when a new assessment course is needed, the whole process must be repeated to generate a Reference Drive for the new course. A group of reference drivers again need to drive the new course and their performance needs to be checked for outliers before the Composite Reference Drive (CRD or RD) and NPD file is made per the process described in FIG. 15 and accompanying description. A more economical and flexible method would be to capture “the way” reference drivers (Normative Drivers) drive a particular section of roadway and use that information anytime that same type of roadway is driven by a Driver Under Test or DUT. “The way” human reference drivers (Normative Drivers) drive includes humanistic traits that are contained in the data of the NPD files. For example, the NPD file documents the Mean path, speed. etc. and the SD envelops for those variables that the human based Reference Drive follows while traveling a straight section of road, or a curved section of road, or while stopping abruptly because of a lane incursion, or through a left-hand turn, or any other maneuver. Documenting the Humanistic Operating Procedures and Envelops parameters of such maneuvers is the process of HOPE characteristics extraction. More specifically for example, determining (extracting) data that on average the CRD (Composite Reference Drive) traverses a straight section of roadway that is regulated (signed) for 35 mph in a residential area at 33 mph with a SD of 2.3 mph is an extracted humanistic characteristic of the drivers that made up the CRD. Also for example, extracting the geometric path followed by the CRD through a left-turn at an intersection is an extraction of humanistic characteristics of the CRD. When a particular type of road section has been driven by the reference drivers (Normative Drivers) the methods and techniques used by the drivers can be extracted.

Extracting Humanistic Operating Procedures and Envelops (HOPE) Characteristics begins with capturing the characteristics of the desired type of drivers. This is the same process to capture data used to create the NPD or Normative Path Data file on a studied fixed course for analysis. In FIG. 27, both creating an NPD for a studied fixed course and extracting HOPE parameters commence at START Extract HOPE Data Terminator 2710. Next, data from a desired set of drives by the reference or Normative Drivers is collected at Data 2712. Data 2712 also represents the process of the Normative Drivers self-reporting their driving record in terms of accidents and tickets they had in the last two years. Any other important study data and or agreements are also collected from the drivers at this step. Any other period for the reporting of accidents and tickets can also be used.

The process of making the actual NPD file for the drives of the Normative Drivers on the studied fixed course is represented by Process 2714. The process summarized in 2714 is detailed in FIG. 15 and the accompanying description. It basically takes the Normative Drive data from each reference driver's drive and calculates and temporarily stores the value of each variable at each sample point or Reference Normal and then calculates the Mean and Standard Deviation of each variable at each Reference Normal building the NPD file at Data File 1550 one Reference Normal at a time until the studied fixed course is completed.

That NPD file for the studied fixed course can be used to train or assess drivers who drive that same studied fixed course in the virtual world on a simulator. That process of testing or assessing the DUT who drives the studied fixed course is detailed in FIG. 17 and associated discussion.

With manual input from step Manual Input 2720 and display of the NPD data in the virtual or real environment, extraction of HOPE Parameters at Process 2722 isolates specific road segments from the studied fixed course and isolates the way the reference drivers (Normative Drivers) drove the particular type of road section. Process 2722 is explained in greater detail in FIG. 31 and associated discussion. The HOPE Parameters are then stored for later use synthesizing similar road sections in NPD files at Store 2724.

### Overview of Universal Analysis—FIG. 28

Analysis or measurement of a DUT's drive compared to a Reference Drive can be accomplished for both studied fixed courses and synthesized courses. FIG. 28 accept DUT drives at Data 2810 and Decision 2812 determines if the drive was on a studied fixed course. If so the DUT's drive begins analysis by the generation of the NVC variables at Predefined Process 2816. Predefined Process 2816 represents the process of comparing the Parameters recorded for the Driver Under Test during his or her actual drive through the virtual or real world to the averages or Means and Standard Deviations at each Reference Normal or sample point and generating an NVC file or Fonda curve for each Parameter including the Parameters such as position, orientation and acceleration calculated by the free body model from the DUTs control inputs. If the DUT drove on the studied fixed course, the NPD file created from the Normative Driver's drives on the studied fixed course is used as the standards against which the DUT's drive is compared. If the DUT chose to drive through the virtual or real world off the studied fixed course, the HOPE NPD file must be synthesized by the Predefined Process of FIG. 32. Therefore, if Decision 2812 is that the NPD file must first be synthesized from the HOPE Parameters Predefined Process 2812 does so. Then Predefined 2816 will generate the NVC data that generates and stores normal variance continuums for each of the variables of the NPD data that compare the DUT's drive to the CRD or Reference Drive of the used NPD file. The only difference for a DUT drive on the studied fixed course and a DUT drive off the studied fixed course at Predefined Process 2816 is which NPD file is created in step 1746 and as a result which Normative Path Data is used in steps 1748 and 1742.

The NVC or Fonda Curves generated at Predefined Process 2816 are then made available or represented to the desired Predefined Analysis techniques such as those defined by FIGS. 24, 25, and 26.

### Graphic Overview Extracting and Using Hope Characteristics—FIG. 29

FIG. 29 is a plan view (top down map) of a portion of several roads in the SmallTown virtual world. With the north arrow oriented up or away from the observer, Beltway 2902 with its three travel lanes in each direction traverses east/west. On the right side of the figure, Broadway 2904 (a two lane road) intersects Beltway 2902 while it traverses north/south. Another two lane road, 8^{th} Street 2906 traverses north/south also intersecting Beltway on the left side of FIG. 29. One additional unnamed road intersects 8^{th} Street 2906 in the SW quadrant of the map.

A line that represents the Mean Composite Reference Drive Path 2930 of a section of a studied fixed course is shown traveling north on 8^{th} Street 2906, turning right or east on Beltway 2902 until changing lanes to the left turn lane and turning left onto and traveling north on Broadway 2904.

A second line that represents the Mean Composite Reference Path 2932 of a section of a HOPE synthesized Reference Drive that is not on a studied fixed course is shown traveling on a reverse road course to that of the first path, Path 2930.

Sections of the roads are marked as “Entry Termination,” “Stady-State.” and “Exit Termination” to identify portion of the road where the CRD will behave differently. For example, the drivers forming the CRD when turning left or right at an intersection may position their vehicles in the lane differently than if they were traveling straight through the intersection.

### Graphic Extraction and Use of Hope Characteristics—FIG. 30

FIG. 30 represents a perspective view of a road section and more fully explains the components of NPD files, NVC files and the HOPE parameter for extraction and synthesis processes. A Steady-State 3010 portion of the road section is identifies a length of the road section marked as Steady-State by the operator of the HOPE Parameter extraction process. The operator also marked an Exit/Entry Transition 3012. The opposite direction or oncoming Curb 3014, travel lane Centerline 3016, and road section Center Divider 3018 are all marked. A sample of the often mentioned sample point or Reference Normal 3020 is shown as a dotted line perpendicular to the travel lane Centerline 3022. Many additional Reference Normals are also shown as dotted lines. In the preferred embodiment the RN's are about 1.5 meters apart. The path of the Composite Reference Drive 3024 is shown meandering across the travel land Centerline 3022. An icon for the position variables Mean and SD is shown on each Reference Normal. The Icons 3026 and 3028 are listed. The construction of the icon is such that the Mean Position 3060 is a small bulleye with Ty Fighter wings at a distance of one SD toward the Curb Side SD 3062 and the Traffic Side SD 3064 as shown in the lower left blowup image of the icon. Cars travel in and roads are engineered by a construction of “tangents” and “curves” wherein the tangent at the end of a curve is the straight line direction of the tangent that connects to the next curve. Curves of varying radii are used as necessary to describe the desired path and many times a curve will connect immediately to another curve of a different radius or even a curve with the radius on the opposite side to reverse the direction of the turn. Usually every time such a connection is made it is made such that the angle of the tangents at the end of each curve are identical.

### Process Extracting Hope Characteristics—FIG. 31

In the preferred embodiment, an origin in Cartesian coordinates of the virtual world is used, and the positions of all components of each road segment are determined relative to this origin. In one embodiment, those Means for each Parameter at each sample point or Reference Normal and their Standard Deviations are then stored in a HOPE NPD file with labels as to identify which type of road segment they pertain and which sample point or Reference Normal in that road segment to which they pertain. This process is repeated for every type of road segment in the studied fixed course. Step 2406 represents this embodiment as well as other embodiments including the preferred embodiment, next described.

NPD data from a studied fixed course with road sections of interest is loaded into Data 3110 and communicated to Process 3114. In addition to NPD data the raw .rcr files for the individual drives that make up the Reference Drive need to be loaded to support some of the higher level functions of the HOPE Parameter extraction process. The function of Process 3114 is to generate a display similar to FIG. 16 or FIG. 30 such that an operator can inspect, select, and make decisions about the parameter extraction processes. This Process 3114 is a 3D graphics system with the ability to render the road and environment databases with a fluid and efficient method to select any desired viewpoint. The road and world (virtual or real) data are supplied to the graphics system by Data Store 3122. The operator views the images on Display 3126. The operator next selects a road section form the studied fixed course to study. For example, a straight two-lane road segment is one type of road segment with a speed limit of 25, a straight two-lane road segment is one type of road segment with a speed limit of 35 is another type of road segment, a straight two-lane road segment is one type of road segment with a speed limit of 45 is another type of road segment and so on. An intersection of two two-lane roads, is another type of road segment. An intersection of two four-lane roads is another type of road segment. Adding different configurations of stop signs and stop lights adds more road segments. A T intersection is another type of road segments with stop signs or stoplights or blinking reds or yellows also adding different road segment types. A curved two-lane road is another type of road segment, and a curved four-lane road in another type of road segment. The number of different types of road segments is finite, but there are an appreciable number of them when different speed limits and curvatures are taken into account. Each road segment also has characteristics such as its width and where its centerline is or where the centerline is for each lane. Weather conditions and time of day also factor into how drivers drive and the factors can be capture and stored in the HOPE Parameter extraction. Once the road section has been selected HOPE Parameter extraction for that road segment can commence. Through Manual Operation 3130 a portion of the road segment is selected such as the Steady-State 3010 section of FIG. 30. Process 3134 extracts the humanistic characteristics of the position variable by fitting a series of tangents and curves to overlay and follow the shape of the Mean 3024 of the CRD for the length of the Steady-State 3010 portion of the road section. Process 3134 will store the above fit relative to a local reference such as the intersection of the Road Segment Termination 3030 and the Road Segment Centerline 3018. When the Centerline of Travel Lane 3022 is also extracted by Process 3146 it will be recorded relative to the CRD Mean 3024 as closely as the accuracy of the Tangent/Curve fit process. The balance of the variable Means for the Steady-State 3010 will then be fit relative to the same local reference although the independent input variables may be fit with polynomials. Process 3138 then fits a polynomial to the right SD relative to the SD offset from the CRD Mean 3024 at each Reference Normal. For example, at Reference Normal 3020, Mean 3024 is shown to the left of Centerline 3022 a distance of approximately 12 inches. The right or curb side one SD is to the right at RN 3020 approximately 14 inches. A line through similar points on successive RN's will form a right one (1.0) Standard Deviation envelop similar to that shown in FIG. 16 labeled 1640. The left envelop is there shown as 1642. The Process 3138 fits the SD's of the balance of the variables. At a Process 3142, Processes 3134 and 3138 are repeated for the Entry and Exit Transitions such as 3012. Process 3146 then stores the basic road structure relative to the reference point such as Centerline 3022 (mentioned above) Curb Travel Lane Edge 3024, Road Section Centerline 3018, Opposing Lane Centerline 3016, Opposing Curb 3014, and similar additional detail. Process 3146 transfers the road section information to a HOPE Store 3150 cataloged with additional factors to guide use of the road section by the automatic HOPE NPD Creation processes. These factors and additional information about the road section are entered by Manual Input 3154. If additional road sections are to be processed, a new road segment is selected at 3118. If not, the HOPE Parameter Store 3150 can be used to synthesise NPD data for the types of road sections it contains.

In an alternative embodiment, each different type of road such as a straight two-lane road has a separate road segment in the HOPE Database 3150 for each different total width and for each different lane width if there are differences.

In another alternative embodiment, each different type of road such as a straight two-lane road has only one road segment type in the HOPE Database 3150 but has characteristic variables such as total width, lane width, position of the centerline if it is not centered, and whether it is in an urban or countryside environment.

In another alternative embodiment, a nominal Reference Normal is created for purposes of synthesis to the HOPE NPD. That nominal Reference Normal is created for each type of road segment. That nominal Reference Normal is created by looking at the Mean and Standard Deviation at each Reference Normal in the road segment in the studied fixed course NPD and then averaging the Means and Standard Deviations of all these Reference Normals in the studied fixed course NPD to arrive at the Reference Normal. That process is repeated for each different Parameter. These nominal Reference Normals are then replicated throughout the length of the similar road section being driven by the DUT “off the reservation”, i.e. in the virtual world and off the studied fixed course.

In another alternative embodiment, the process described above to create the nominal Reference Normal for each Parameter looks only at the Reference Normals in the middle of the road segment such as the Steady-State sections of the road on the studied fixed course and ignores the values of the Parameters at the Reference Normals in the sections of the road segment near its ends in the Entry and Exit Terminations. This refinement is done because the values of the Parameters in the Reference Normals near the ends of the road segment are going to be different from the values at the Reference Normals in the middle of the road segment because the Normative Drivers will be preparing to make a transition to a different road segment such as making a left hand turn and slowing down or braking and beginning to turn the steering wheel. These Parameters at the Reference Normals near the ends or terminations of the road segment on the fixed course are eliminated as “outliers” that will skew the averages.

### Hope NPD Creation Process—FIG. 32

Referring to FIG. 31, there is shown a flowchart for the detailed process of HOPE NPD file creation. The basic idea is to follow step by step a DUT's path through the virtual world or real wold that is not on the studied fixed course, determine what type of road segment the DUT is on every desired sample point or Reference Normal spacing (i.e. 1.5 meters) along his path, calculate the parametric centerline of the road segment, generate Reference Normals, load the averages and Standard Deviations for each Reference Normal from the NPD file established for the same type road segment by the CRD on the studied fixed course,

Note, it is possible to produce a HOPE NPD to analyze a DUT performance that follows the same route as the studied fixed course. In fact, this procedure is used to confirm the operation of the HOPE NPD process. Also, the DUT can choose to drive anywhere in the world for which road section detail and the visual graphics can be obtained that describe how the driving surface is shaped and how the world looks. There are open source and private organizations that supply graphic information system GIS information for the purpose like Google etc. The flowchart of FIGS. 27 through 32 start from the point where the graphics of the virtual world and the characteristics of the various road segments in the part of the virtual world in which the DUT chose to drive have already been obtained.

The general process to make HOPE NPD files is to: 1) determine what type of road section the DUT path is on and then, 2) to lookup the HOPE Parameters for that type of road section in the HOPE Database, and 3) apply those parameters to the construction of the sample points or Reference Normals one after another to build or synthesize the HOPE NPD.

Building or synthesizing a HOPE NPD requires a parametric path through a road system that will serve as the centerline of the travel lane from which HOPE Parameters can be based. It is important to match the centerline of the travel lane from the HOPE Database road section to the synthesized road centerline because that is the reference for the Mean and thus the SD at each RN. Process 3210 and the Decision Processes 3220, 3222, 3224 along with the driven path of the DUT from Data 3214 and parametric path data in the road definition from either the simulated world at Data 3216 or the real world at Data 3218 are looped through and thus incrementally traveled along the DUT path to a point that a road section from the HOPE Database can be fit to the parametric road definitions. This can be done by traveling the entire length of the DUT path and then patching road sections from the HOPE Database to fit the parametric centerline of the road system the DUT was found to have driven on or certain points in the travel of the DUT path clearly demark points at which the prior path is able to be fit with road sections from the HOPE Database. One such demarcation point is a road change at an intersection. When the parametric centerline and HOPE Database road section type is determined, Reference Normals or other sample point system can be successively generated along the parametric centerline. Process 3232 sequentially defines RN's and loads them with the appropriate Mean and SD's for the road section from the definition of that road section in the HOPE Database. At the intersection of roadways such as the intersection of Beltway 2902 and Broadway 2904 in FIG. 29, a parametric path does not exist in the road database 3216. A transition road section then needs to be fit that includes a parametric centerline connecting the centerlines of the beginning and ending road sections. Process 3226 determines the need to for necessary components to connect the road sections. As the RN's are generated and loaded with the Means and SD of all variables, they are stored at Data 3134 in the form of a synthesized HOPE NPD. When the DUT path has been completed the NPD build is complete.

As stated this process could be used to build NPD files for real world road systems. The process would work both for use in a driving simulator with a virtual display of the real world or in a real vehicle driving the real world with GPS and/or inertial and/or optical road navigation and definition equipment. With a real world HOPE NPD generation system, NVC or Fonda analys could assess and train drivers in their cars, on roads in their vicinity.

### Prediction Arrows—Bad Path—FIG. 33

By running the Vehicle Dynamics Model VDM with the same control inputs forward in time it is possible to “predict” the future path of the vehicle. Displaying a few seconds of that path on the screen of the simulator in advance of the vehicle imparts insight into the available vehicle handling. One very noticeable result is the amount of time it takes for the vehicle to alter its path. There is a significant amount of travel along the roadway before the vehicle appears to be responsive. FIG. 33 is a screen grab of a vehicle turning at an intersection through a right-turn. The image is a still screen grab of the dynamic turning operation. A series of “Direction Arrows” 3300 are shown leading the vehicle. The arrows represent the path the vehicle will take in the next three seconds.

Many accidents would be avoided and many would result is less devastation if the driver understood and used the ability of the vehicle more fully to avoid or minimize the impact. The Prediction Arrows help explain the ability of the driver and vehicle.

### Prediction Arrows—Good Path—FIG. 34

FIG. 34 is another still screen grab of a dynamic situation. In addition to the future position line as shown by the Prediction Arrows 3400 a stop line or lateral line could be placed on the roadway to indicate how far the vehicle will travel before it could be stopped. By gathering the appropriate information from the vehicle performance (step steering input to lateral acceleration or braking pedal to deceleration) VDM parameters can be “Extracted” to more accurately model the vehicle performance. Then the Tale-Tell, stop zone, caution zone, side path limits could be displayed on a HUD such as www.navdy.com, or the Sony HMZT3, or the Avegant Glyph, or the Infiniteye, or the Gameforce Mark IV.

Using the same techniques in the real world as in the virtual world the dashboard mounted HUD in many newer cars or as form navdy.com (as shown on their website) would show a “tinted red zone” between the nose of the car and the “stop line” with a Prediction Arrow line depicting the current path the vehicle will follow with the current conditions such as steering and speed.

The VDM would need to be calibrated for most accurate prediction of the stop line. Acceleration or deceleration tests would characterize the stopping ability of the current tire/road/car conditions. For example, after making sure nobody is on your tail, slam on the brakes for two seconds while the g forces register and then use that for the stop distance calculation. Something similar could be done in an empty parking lot for the turning ability calibration. That way turn (side) limits could be added on the sides of the Prediction Arrows.

There is also a need to calibrate the position of the projected distance lines to some actual distance in front of the car. Because the image is typically virtual and approximately six feet beyond the HUD or windshield, movement of the driver in the seat will not be as bad as if the image was on the HUD. One way to calibrate would be to display a grid of Reference Normals in front of the vehicle but sliding under as the car moved forward in lock with the speed of the car. Then when a Reference Normal lined up with some point longitudinally along the road it would stay lined up as the car drove past the point. If the longitudinal point on the road moved under the car faster than the reference normal, the projected image would need to be lowered until the Reference Normals traveled at the same speed as the external geometry.

The Prediction Arrows help everyone learning to drive, or drive defensively, and everyone interested in top performance.

### APPENDICES LIST

### APPENDIX A: Street Drivin′ Specification

### APPENDIX B: General Simulation Driver Guidance System User Manual

### APPENDIX C: Virtual Reality Simulation Sickness Mitigation Without Content Degradation White Paper

APPENDIX D: the Aerial Attack Study, authored by Col. John Boyd, Revised 11 Aug. 1964

What is claimed is:

1. A simulator comprising:
A) any prior art simulator driving a display to show a vehicle moving through a three dimensional scene under control of a driver or pilot operating said simulator;
B) first means for using input from said three dimensional scene and the linear and rotational position, velocity and acceleration of said driver or pilot in said vehicle to calculate the size, shape and obscuration level of a mitigation object; and
C) second means for using the calculation made by said first means to generate three dimensional geometry for said mitigation object in a three dimensional rendering system and displaying said mitigation object in said three dimensional scene.

2. A process for mitigation of simulator sickness in drivers or pilots operating simulators, comprising the steps:
A) starting a scenario in a Driver Guidance System Simulation Terminal Application;
B) determining at the beginning of said scenario from data supplied by said Driver Guidance System Simulation Terminal Application an initial position and orientation in a virtual world for each of one or more displays of a simulator as viewed from a vehicle or plane being controlled by a driver or pilot operating a simulator, wherein said scenario could be either a drive through any path in said virtual world or a flight through any airspace in said virtual world and wherein events happen during said drive or flight to which a driver or pilot operating said simulator must react;
C) generating the virtual image of the roads or airspace which said driver or pilot can see from said initial position for each of said one or more displays;
D) receiving and processing at a Vehicle Dynamics Model inputs from said driver or pilot who manipulates controls to operate said simulator to control said vehicle or plane;
E) calculating in said Vehicle Dynamics Model how the inputs from said driver or pilot would affect the position, velocity and orientation of said vehicle or plane and how the viewpoints displayed on each of said one or more displays is changed;
F) communicating the resulting position and orientation of said viewpoints for each of said one or more displays and their details to a rendering process which functions to render world objects to a frame buffer;
G) said rendering process retrieves 3D object definitions and 3D world definitions as well as location and orientation information for fixed objects and motion objects from a database based upon the current position and orientation of each of said one or more viewpoints in said virtual world;
H) using said information received from said database and the location and orientation of each of said one or more viewpoints to render virtual images of all the objects that may potentially be screened or obscured by a sickness mitigation object for each of said one or more displays to a frame buffer;
I) receiving dynamic definition data for a sickness mitigation object which defines its desired display characteristics;
J) translating, rotating and scaling said sickness mitigation object and rendering said sickness mitigation object to said frame buffer;
K) rendering objects that will not be screened or obscured by a sickness mitigation object to said frame buffer;
L) determining vehicle speed, and increasing transparency of said sickness mitigation object when the vehicle said driver or pilot is controlling is stopped or closed to stopped, and decreasing the transparency of said sickness mitigation object as said vehicle said driver or pilot is controlling accelerates from a stop; and
M) displaying said frame buffer.

3. The process of claim 2 wherein step B determines the initial position and orientation in said virtual world for three forward looking, three rearward looking and two control displays.

4. The process of claim 2 wherein step I to receive dynamic definition data for the sickness mitigation object (SMO) comprises receiving initial conditions of SMO usage and the scenario or dynamics or operator based control of said SMO.

5. The process of claim 2 wherein step J of rendering said sickness mitigation object to said frame buffer comprises rendering to said frame buffer a multicomponent sickness mitigation object comprising a central mitigation overlay, a transition mitigation overlay and an outside mitigation overlay.

6. The process of claim 5 further comprising steps following step K of gathering data regarding the head position and movement of the head of said driver or pilot operating said simulator, and moving the center of the sickness mitigation object, wherein said moving of the center of said sickness mitigation object comprises the steps of moving said multicomponent sickness mitigation object in such a way that the center of the sickness mitigation object is moved to where said driver or pilot is looking such that objects in said display of said virtual world are not obscured or screened.

7. The process of claim 2 wherein said one or more displays are worn as a headset on the head of said driver or pilot, and further comprising rendering the images on said screens in said headset such that when said driver or pilot turns his head to the right, the display that would normally have been displayed on a fixed, non-headset display to the right of the center fixed, non headset display is now displayed on the center screen in front of the driver's or pilot's eyes, and the sickness mitigation object is now rendered such that its center is now on said center headset display over what would have been displayed on a fixed, non headset display to the right of the center display in a fixed, non headset display.

8. The process of claim 2 wherein said one or more displays are worn as a headset on the head of said driver or pilot, and further comprising rendering the images on said screens in said headset such that when said driver or pilot turns his head to the left, the display that would normally have been displayed on a fixed, non-headset display to the left of the center fixed, non headset display is now displayed on the center screen in front of the driver's or pilot's eyes, and the sickness mitigation object is now rendered such that its center is now on said center headset display over what would have been displayed on a fixed, non headset display to the left of the center display in a fixed, non headset display.

9. The process of claim 2 further comprising the step of moving the sickness motion object on said one or more displays so as to track head movements of said driver or pilot.

10. The process of claim 2 wherein said sickness mitigation object is rendered as a semi-transparent half cylinder with a central hole through which the center of the image of the virtual world may be observed without screening or obscuration by the sickness mitigation object.

11. The process of claim 2 wherein said sickness mitigation object is rendered as a parametrically generated sickness mitigation object that allows the edges of a center hole in said sickness mitigation object to be softened and feathered over a range of degrees before reaching full obscuration.

12. The process of claim 2 wherein step J including rendering said sickness motion object to said frame buffer comprise an alpha blending process which mixes the color of overlapping pixel from the sickness motion object and the virtual world image so as effectively reduce the motion saturation of the dynamic 3D image.

13. The process of claim 2 further comprising the step of performing anti-distortion processing and image frame processing on pixels stored in said frame buffer before said frame buffer is displayed in step M.

14. The process of claim 2 further comprising the step of erasing said frame buffer and rebuilding said frame buffer again from scratch periodically.

15. The process of claim 2 wherein a new frame buffer is built every 1/60^{th} of a second.

16. A process for mitigation of simulator sickness in drivers or pilots operating drones, comprising the steps:
A) receiving panoramic video stream image data of the roads or airspace which said drone can see from the drone's position in the real world for each of said one or more displays;
B) receiving dynamic definition data for a sickness mitigation object which defines its desired display characteristics;
C) translating, rotating and scaling said sickness mitigation object and rendering said sickness mitigation object to a frame buffer using an alpha mixing process to mix the color of pixels from said real world image that overlap with a pixel from said sickness mitigation object so as to reduce motion saturation of the displayed image;
D) rendering pixel data that will not be screened or obscured by a sickness mitigation object from the video stream image data arriving from said drone to said frame buffer;
E) determining vehicle speed, and increasing transparency of said sickness mitigation object when the vehicle said driver or pilot is controlling is stopped or closed to stopped, and decreasing the transparency of said sickness mitigation object as said vehicle said driver or pilot is controlling accelerates from a stop; and
F) displaying said frame buffer.

17. A computer programmed to:
A) execute one or more programs to implement vehicle or plane simulation and display pixels depicting a virtual world on one or more displays;
B) reducing the intensity of light emitted from each pixel displayed on said one or more displays by a predetermined amount to reduce simulator sickness.

18. The computer of claim 17 wherein step B comprises controlling said computer to alpha blend each pixel in a frame buffer with the pixels of a sickness mitigation object.

19. The computer of claim 17 wherein step B comprises controlling the computer eliminate most of the light transmitted from each pixel such that the scene being viewed appears as if it is being viewed through a fog.

20. The computer of claim 18 wherein step B comprises controlling the computer to transmit only X % of the light from pixels in a center hole of said sickness mitigation object and transmit only Y % of the light from pixels outside said center hole.

21. The computer of claim 20 wherein step B comprises controlling the computer to transmit only X % of the light from pixels in a center hole of said sickness mitigation object and transmit only Y % of the light from pixels outside said center hole where X and Y are the same.

22. The computer of claim 20 wherein step B comprises controlling the computer to transmit only X % of the light from pixels in a center hole of said sickness mitigation object and transmit only Y % of the light from pixels outside said center hole where X is 10% and Y is 5%.

23. The computer of claim 20 wherein step B comprises controlling the computer to transmit only X % of the light from pixels in a center hole of said sickness mitigation object and transmit only Y % of the light from pixels outside said center hole where X and Y are variables that can be controlled.

24. The computer of claim 20 wherein step B comprises controlling the computer to transmit only X % of the light from pixels in a center hole of said sickness mitigation object and transmit only Y % of the light from pixels outside said center hole where X is 100% transmission of all light from pixels in said center hole and Y is some predetermined number less than 100% transmission.

25. The computer of claim 20 wherein step B comprises controlling the computer to transmit only X % of the light from pixels in a center hole of said sickness mitigation object and transmit only Y % of the light from pixels outside said center hole where X is a predetermined percentage of transmission of all light from pixels in said center hole and Y is another predetermined number less than 100% transmission and changes to less transmission the farther a pixel is from said center hole.

26. The computer of claim 20 wherein step B comprises controlling the computer to transmit only X % of the light from pixels in a center hole of said sickness mitigation object and transmit only Y % of the light from pixels outside said center hole where X is a predetermined percentage of transmission of all light from pixels in said center hole and Y is another predetermined number less than X and changes to more transmission of light as said vehicle or plane being controlled slows down and/or comes to a stop.

27. The computer of claim 20 wherein step B comprises controlling the computer to transmit only X % of the light from pixels in a center hole of said sickness mitigation object and transmit only Y % of the light from pixels outside said center hole where X is 100% transmission of all light from pixels in said center hole and Y is some predetermined number less than 100% transmission, and wherein said computer is further programmed to detect movements of the head of said driver or pilot and recalculate said sickness mitigation object so as to move said center hole to encompass the pixels in the portion of the scene said driver or pilot is looking directly at.

28. The computer of claim 18 wherein step B is performed by controlling said computer to not obscure selected pixels within the perimeter of said sickness mitigation object, said selected pixels depicting moving objects that might pose a danger to the vehicle or plane being controlled by a driver or pilot and said selected pixels also depicting other objects of interest such as traffic signs, traffic signals, but controlling said computer to obscure at least partially all other pixels which are not said selected pixels and which are within the perimeter of said sickness mitigation object.

29. The computer of claim 18 wherein step B is performed by controlling said computer to partially obscure selected pixels within the perimeter of said sickness mitigation object, said selected pixels depicting moving objects that might pose a danger to the vehicle or plane being controlled by a driver or pilot and said selected pixels also depicting other objects of interest such as traffic signs, traffic signals, but controlling said computer to obscure all other pixels which are not said selected pixels and which are within the perimeter of said sickness mitigation object so as to have less transmission of light from these non selected pixels than is transmitted from said selected pixels.

30. A process for mitigating simulator sickness comprising:
A) displaying a plurality of scene pixels depicting a scene from the virtual world or the real world on one or more displays of a simulator or a control station for an unmanned aerial or ground vehicle being controlled by a driver or pilot;
B) reducing the intensity of light transmitted from all or selected ones of said pixels using a sickness mitigation object.

31. The process of claim 30 wherein step B is carried out by combining the pixels of said sickness mitigation object with said scene pixels in a frame buffer.

32. The process of claim 30 wherein step B comprises creating a sickness mitigation object having a central area and a peripheral area outside said central area, and wherein when said pixels from said central area of said sickness mitigation object are mixed with scene pixels that overlap with said central area pixels, X % of the light of each said scene pixel within said central area is transmitted, and wherein when said pixels from said sickness mitigation object which are outside said central area are mixed with overlapping ones of said scene pixels, Y % of the light from each said scene pixels outside said central area is transmitted.

33. The process of claim 32 wherein X and Y are the same percentage and the percentage blocks most of the light transmitted from said scene pixels.

34. The process of claim 32 wherein X is 10% of the light from said scene pixels is transmitted and Y is 5% of the light from said scene pixels is transmitted.

35. The process of claim 32 wherein X and Y are variables that can be controlled so that they can be changed for different drivers or pilots.

36. The process of claim 32 wherein X is 100% of the light from said scene pixels in said central area is transmitted and Y is some predetermined percentage which is less than 100%.

37. The process of claim 32 wherein X is some percentage and Y is some percentage which is less than X and varies such that less light is transmitted from pixels outside said central area with the percentage which is transmitted from said pixels outside said central area being less the further away said pixel is from said central area.

38. The process of claim 32 wherein only X % of the light from pixels in a central area of said sickness mitigation object is transmitted and only Y % of the light from pixels outside said central area is transmitted, and wherein X is a predetermined percentage of transmission of all light from pixels in said central area and Y is another predetermined number less than X and changes to more transmission of light from said scene pixels outside said central area as said vehicle or plane being controlled slows down and/or comes to a stop.

39. The process of claim 32 wherein step B further comprises the steps of detecting head movement of said driver or pilot and moving the position of said central area to correspond to the portion of said scene said driver or pilot is looking at.

40. The process of claim 32 wherein step B is performed so as to not obscure selected pixels within the perimeter of said sickness mitigation object, said selected pixels depicting moving objects that might pose a danger to the vehicle or plane being controlled by a driver or pilot and said selected pixels also depicting other objects of interest such as traffic signs, traffic signals, but at least partially obscuring all other pixels which are not said selected pixels and which are within the perimeter of said sickness mitigation object.

41. The process of claim 32 wherein step B is performed by partially obscuring selected pixels within the perimeter of said sickness mitigation object, said selected pixels depicting moving objects that might pose a danger to the vehicle or plane being controlled by a driver or pilot and said selected pixels also depicting other objects of interest such as traffic signs, traffic signals, but obscuring all other pixels which are not said selected pixels and which are within the perimeter of said sickness mitigation object so as to transmit less light than is transmitted from said selected pixels.
